(19) United States
(12) Patent Application Publication
(10) Pub. No.: US 2023/0161217 A1
(43) Pub. Date: May 25, 2023

(54) LIGHT GUIDE DISPLAY SYSTEM FOR PROVIDING INCREASED PIXEL DENSITY

(71) Applicant: Meta Platforms Technologies, LLC, Menlo Park, CA (US)

(72) Inventors: Xiayu FENG, Kirkland, WA (US); Sihui HE, Sunnyvale, CA (US); Zhexin ZHAO, Redmond, WA (US); Lu LU, Kirkland, WA (US)

(21) Appl. No.: 17/535,502

(22) Filed: Nov. 24, 2021

(51) Int. Cl. G02F 1/29; G02B 27/01

(52) U.S. Cl. CPC G02F 1/292; G02B 27/0172; G02B 2027/014; G02B 2027/0178

(57) ABSTRACT

A device includes a light guide and an in-coupling element coupled with the light guide and configured to couple an input image light into the light guide. The device also includes an out-coupling element coupled with the light guide and configured to couple the input image light out of the light guide as an output image light, and a controller configured to control at least one of the in-coupling element or the out-coupling element during a first time period and a second time period. The out-coupling element outputs a first output image light having a first field of view (“FOV”) during the first time period, and a second output image light having a second FOV during the second time period. The first FOV substantially overlaps with the second FOV, and an axis of symmetry of the first FOV is rotated relative to an axis of symmetry of the second FOV.

### TECHNICAL FIELD

The present disclosure relates generally to optical devices and, more specifically, to a light guide display system for providing an increased pixel density.

### BACKGROUND

An artificial reality system, such as a head-mounted display (“HMD”) or heads-up display (“HUD”) system, generally includes a near-eye display (“NED”) system in the form of a headset or a pair of glasses, and configured to present content to a user via an electronic or optic display within, for example, about 10-20 mm in front of the eyes of a user. The NED system may display virtual objects or combine images of real objects with virtual objects, as in virtual reality (“VR”), augmented reality (“AR”), or mixed reality (“MR”) applications. For example, in an AR system, a user may view both images of virtual objects (e.g., computer-generated images (“CGIs”)) and the surrounding environment by, for example, seeing through transparent display glasses or lenses (also referred to as an optical see-through AR system).

One example of an optical see-through AR system may include a pupil-expansion light guide display system, in which an image light representing a CGI may be coupled into a light guide (e.g., a transparent substrate), propagate within the light guide, and be coupled out of the light guide at different locations to expand an effective pupil. Diffractive optical elements may be coupled with the light guide to couple the image light into or out of the light guide via diffraction, such as surface relief gratings, holographic gratings, metasurface gratings, etc.

### SUMMARY OF THE DISCLOSURE

Consistent with a disclosed embodiment of the present disclosure, a device is provided. The device includes a light guide. The device also includes an in-coupling element coupled with the light guide and configured to couple an input image light into the light guide. The device also includes an out-coupling element coupled with the light guide and configured to couple the input image light out of the light guide as an output image light. The device also includes a controller configured to control at least one of the in-coupling element or the out-coupling element during a first time period and a second time period. The out-coupling element is configured to output a first output image light having a first field of view (“FOV”) during the first time period, and a second output image light having a second FOV during the second time period. The first FOV substantially overlaps with the second FOV, and an axis of symmetry of the first FOV is rotated relative to an axis of symmetry of the second FOV.

Consistent with a disclosed embodiment of the present disclosure, a method is provided. The method includes controlling, by a controller during a first time period, at least one of an in-coupling element or an out-coupling element to couple an input image light into a light guide, and couple the input image light out of the light guide as a first output image light having a first FOV. The method also includes controlling, by the controller during a second time period, at least one of the in-coupling element or the out-coupling element to couple the input image light into the light guide, and couple the input image light out of the light guide as a second output image light having a second FOV. The second FOV substantially overlaps with the first FOV. An axis of symmetry of the first FOV is rotated from an axis of symmetry of the second FOV.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIGS. 1A and 1B schematically illustrate diagrams of a conventional light guide display system implemented in a near-eye display (“NED”);

FIG. 2A schematically illustrates a diagram of a light guide display assembly configured to provide an increased pixel density, according to an embodiment of the present disclosure;

FIG. 2B schematically illustrates a diagram of a light guide display assembly configured to provide an increased pixel density, according to an embodiment of the present disclosure;

FIGS. 2C-2E schematically illustrate diagrams of a light guide display assembly configured to provide an increased pixel density, according to an embodiment of the present disclosure;

FIG. 3A schematically illustrates a diagram of a light guide display assembly configured to provide an increased pixel density, according to an embodiment of the present disclosure;

FIG. 3B schematically illustrates a diagram of a light guide display assembly configured to provide an increased pixel density, according to an embodiment of the present disclosure;

FIGS. 4A and 4B schematically illustrate diagrams of a light guide display assembly configured to provide an increased pixel density, according to an embodiment of the present disclosure;

FIGS. 5A-5C schematically illustrate diagrams of a light guide display assembly configured to provide an increased pixel density, according to an embodiment of the present disclosure;

FIG. 6 is a flowchart illustrating a method for providing an increased output pixel density, according to an embodiment of the present disclosure;

FIG. 7A schematically illustrates a diagram of a near-eye display (“NED”), according to an embodiment of the present disclosure;

FIG. 7B schematically illustrates a cross-sectional view of half of the NED shown in FIG. 7A, according to an embodiment of the present disclosure;

FIGS. 8A and 8B illustrate schematic diagrams of a grating in a diffraction state and a non-diffraction state, respectively, according to an embodiment of the present disclosure;

FIGS. 9A and 9D illustrate schematic diagrams of a grating in a diffraction state, according to an embodiment of the present disclosure;

FIGS. 9B and 9E illustrate schematic diagrams of the grating shown in FIG. 9A in a non-diffraction state, according to an embodiment of the present disclosure;

FIGS. 9C and 9F illustrate schematic diagrams of the grating shown in FIG. 9A in a non-diffraction state, according to an embodiment of the present disclosure;

FIG. 9G illustrates a schematic diagram of the grating shown in FIG. 9A implemented in a light guide display assembly, according to an embodiment of the present disclosure;

FIGS. 10A and 10B illustrate schematic diagrams of a grating in a diffraction state and a non-diffraction state, respectively, according to an embodiment of the present disclosure;

FIGS. 10C and 10D illustrate schematic diagrams of a grating in a diffraction state and a non-diffraction state, respectively, according to an embodiment of the present disclosure;

FIG. 11A schematically illustrates a three-dimensional (“3D”) view of a liquid crystal polarization hologram (“LCPH”) element, according to an embodiment of the present disclosure;

FIGS. 11B-11D schematically illustrate various views of a portion of the LCPH element shown in FIG. 11A, showing in-plane orientations of optically anisotropic molecules in the LCPH element, according to various embodiments of the present disclosure; and

FIGS. 11E-11H schematically illustrate various views of a portion of the LCPH element shown in FIG. 11A, showing out-of-plane orientations of optically anisotropic molecules in the LCPH element, according to various embodiments of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., is non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane.

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as “transmit,” “reflect,” “diffract,” “block” or the like that describes processing of a light means that a major portion, including all, of a light is transmitted, reflected, diffracted, or blocked, etc. The major portion may be a predetermined percentage (greater than 50%) of the entire light, such as 100%, 98%, 90%, 85%, 80%, etc., which may be determined based on specific application needs.

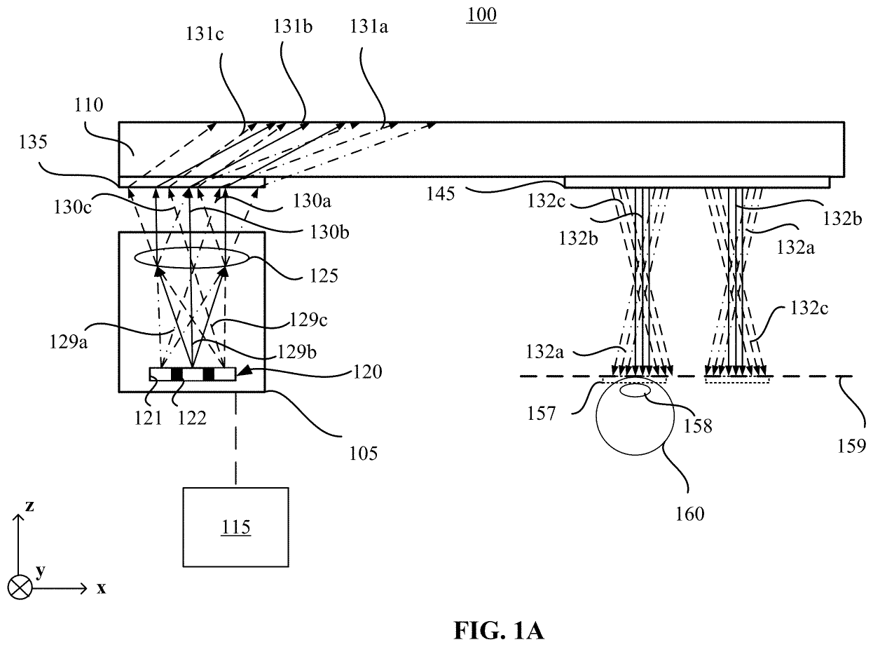

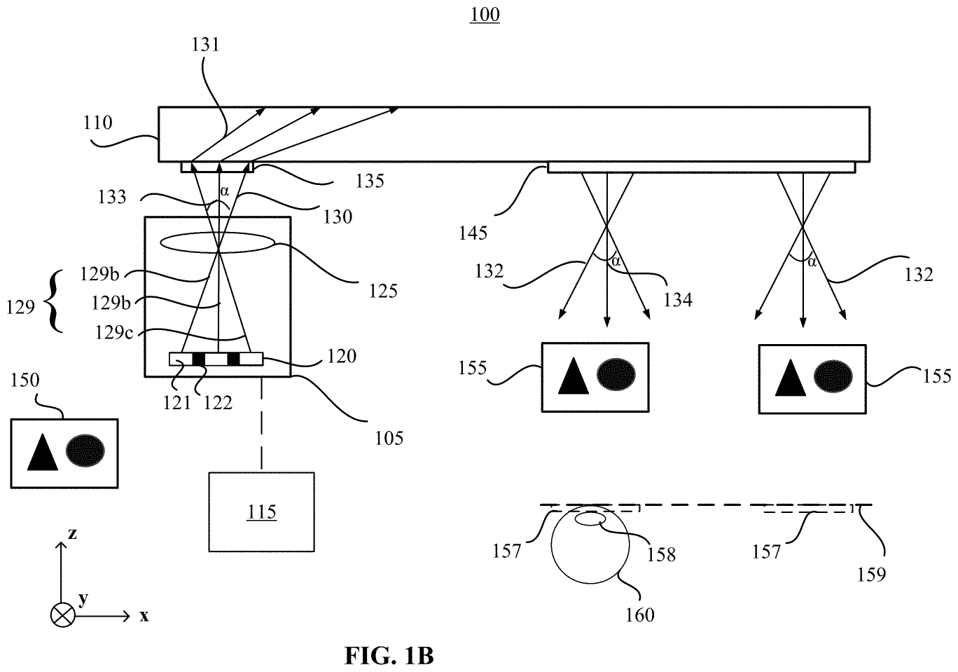

FIGS. 1A and 1B illustrate x-z sectional views of a conventional light guide display system or assembly 100. As shown in FIG. 1A, the system 100 may include a light source assembly 105, a light guide 110, and a controller 115. The system 100 may also include an in-coupling grating 135 and an out-coupling grating 145 coupled to the light guide 110. The light source assembly 105 may include a display panel 120 and a collimating lens 125. The display panel 120 may include a plurality of pixels 121 arranged in an pixel array, in which neighboring pixels 121 may be separated by, e.g., a black matrix 122. The black matrix 122 may be a matrix of light absorbing or blocking materials. For illustrative purposes, FIG. 1A shows that the display panel 120 includes three pixels 121. The respective pixel 121 may output a bundle of divergent rays 129a, 129b, or 129c, and the collimating lens 125 may convert the bundle of divergent rays 129a, 129b, or 129c into a bundle of parallel rays 130a, 130b, or 130c. The respective bundles of parallel rays 130a, 130b, and 130c may have different incidence angles relative to the light guide 110. That is, the collimating lens 125 may transform or convert a linear distribution of the pixels 121 in the display panel 120 into an angular distribution of the pixels 121 at the input side of the light guide 110.

The light guide 110 coupled with the in-coupling grating 135 and the out-coupling grating 145 may replicate the respective bundle of parallel rays 130a, 130b, and 130c at the output side, to expand an effective pupil of the system 100. For example, the in-coupling grating 135 may couple the bundle of parallel rays 130a, 130b, or 130c as a bundle of parallel rays 131a, 131b, or 131c, which may propagate inside the light guide 110 via total internal reflection (“TIR”). The out-coupling grating 145 may couple the bundle of parallel rays 131a, 131b, or 131c output of the light guide 110 as a plurality of bundles of parallel rays 132a, 132b, or 132c, which may propagate toward a plurality of exit pupils 157 positioned in an eye-box region 159 of the system 100.

For a simplified illustration, FIG. 1B shows the light propagation, from the display panel 120 to the exit pupil 257, of a single ray 129a, 129b, or 129c in each bundle output from the display panel 120. Referring to FIGS. 1A and 1B, the bundle of the rays 129a, 129b, and 129c may be collectively referred to as an image light 129 output from the display panel 120. The bundle of rays 130a, 130b, and 130c may be collectively referred to as an input image light 130 of the light guide 110. The bundle of rays 131a, 131b, and 131c propagating inside the light guide 110 via TIR may be collectively referred to as an in-coupled image light 131. The bundles of rays 132a, 132b, and 132c propagating from the out-coupling grating 145 toward the same exit pupil 157 may be collectively referred to as an output image light 132 of the light guide 110.

As shown in FIG. 1B, the display panel 120 may generate the image light 129 representing a virtual image 150 having a predetermined image size associated with a linear size of the display panel 120. The collimating lens 125 may condition the image light 129 and output the input image light 130 having an input FOV 133 (e.g., a) toward the light guide 110. The in-coupling grating 135 may couple the image light 130 into the light guide 110 as the in-coupled image light 131. The out-coupling grating 145 may couple the in-coupled image light 131 incident onto different portions of the out-coupling grating 145 out of the light guide 110 as a plurality of output image lights 132, each of which may have an output FOV 134 that may be substantially the same as the input FOV 133 (e.g., as represented by an angle α). Each output image light 132 may represent or form an image 155 that may be substantially the same as (or may have the same image content as) the virtual image 150 output from the display panel 120.

The plurality of image lights 132 may propagate toward a plurality of exit pupils 157 positioned in the eye-box region 159 of the system 100. The output image lights 132 may one-to-one correspond to the exit pupils 157. The size of a single exit pupil 157 may be larger than and comparable with the size of the eye pupil 158. The exit pupils 157 may be sufficiently spaced apart, such that when one of the exit pupils 157 substantially coincides with the position of the eye pupil 158, the remaining one or more exit pupils 157 may be located beyond the position of the eye pupil 158 (e.g., falling outside of the eye 160). Thus, the eye 160 positioned at one of the exit pupils 157 may receive a single image light 132.

The pixel density at an output side of a light guide display system (referred to as an output pixel density for discussion purposes) is defined as the number of pixels per degree the light guide display system presents to the eye 160. The output pixel density of the light guide display system may be calculated by dividing the number of pixels in a horizontal display line by the horizontal output FOV. For example, when the display panel 120 and the output FOV 134 shown in FIG. 1B are designed for a single eye 160, the output pixel density (at the horizontal pupil expansion direction) of the system 100 may be equal to 3/α (unit: pixel per degree (“PPD”)). When the output FOV 134 of the system 100 is fixed, the output pixel density (PPD) of the system 100 may be limited by the pixel density (e.g., pixel per inch) of the display panel 120. When the panel size of the display panel 120 is fixed, the pixel density (e.g., pixel per inch) of the display panel 120 may be limited by the pixel size or the pixel pitch.

In addition, a pixel density at the input side of the system 100 (referred to as an input pixel density for discussion purposes) may be calculated by dividing the number of pixels in a horizontal display line by the horizontal input FOV. For example, when the display panel 120 and the input FOV 133 shown in FIG. 1B are designed for a single eye 160, the input pixel density of the system 100 may be equal to 3/α (unit: PPD). Thus, in the conventional light guide display system 100, the output pixel density may be substantially equal to the input pixel density.

Nowadays, many of the artificial reality applications require a high output pixel density and a large output FOV, e.g., the retinal resolution is about 60 pixels/degree. There is a tradeoff between the output pixel density and the output FOV. A larger output FOV may result in a lower output pixel density, and a smaller output FOV may result in a higher output pixel density. When the output FOV 134 of the system 100 is fixed, increasing the pixel density of the display panel 120 (pixel per inch) and reducing the pixel size (or pixel pitch) of the display panel 120 may increase the output pixel density of the system 100. However, the form factor, the power consumption, and the cost of the conventional light guide display system 100 may also increase. In addition, there is a limitation on the smallest pixel size in the display panel 120.

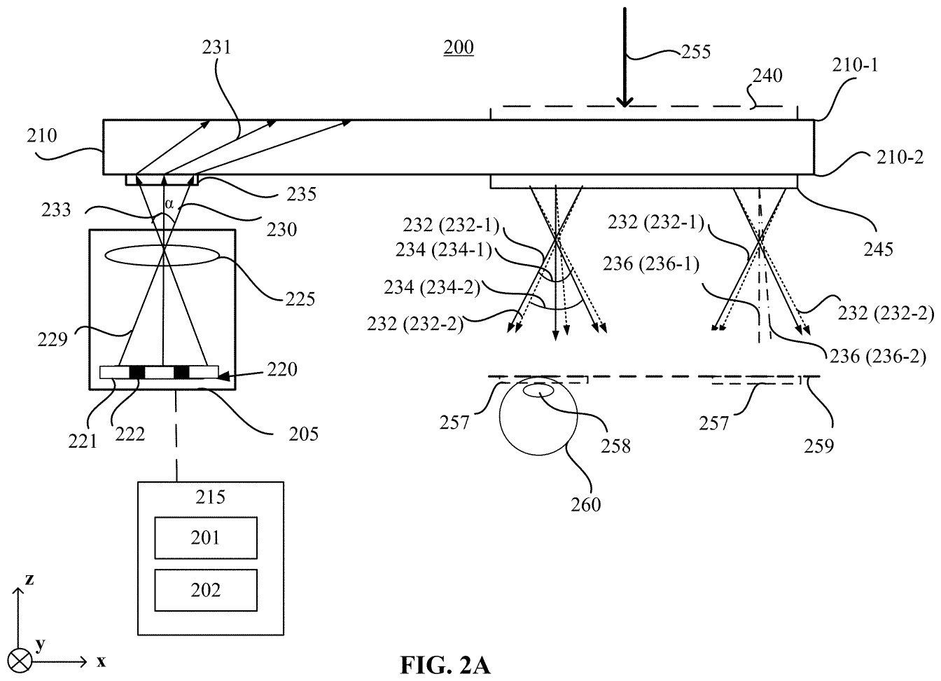

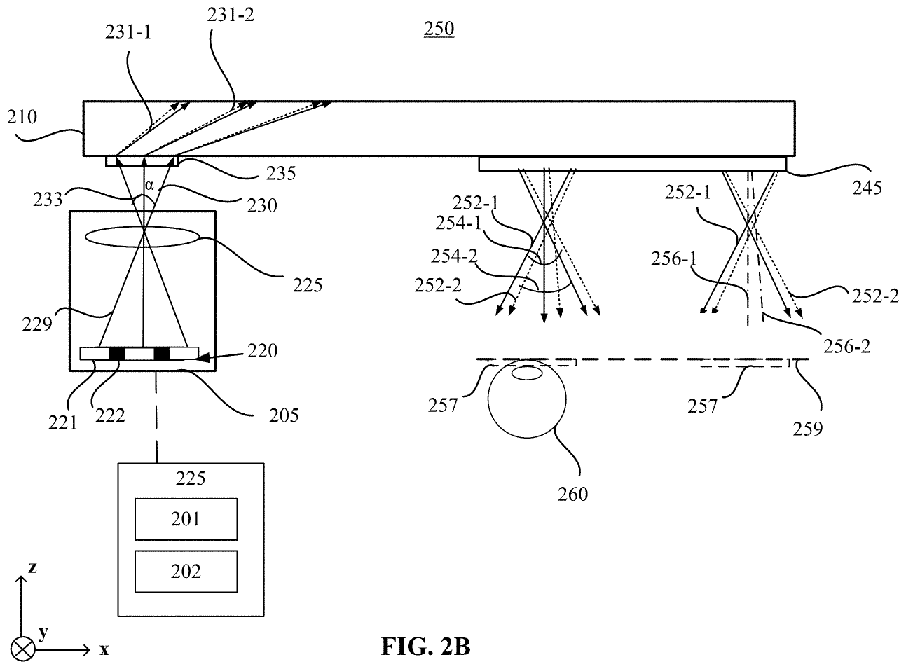

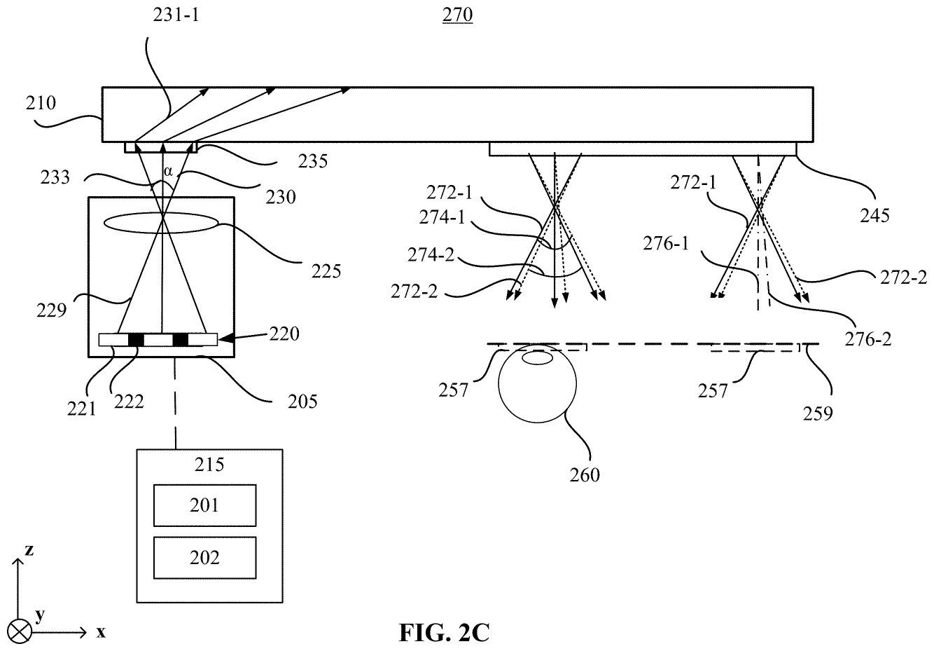

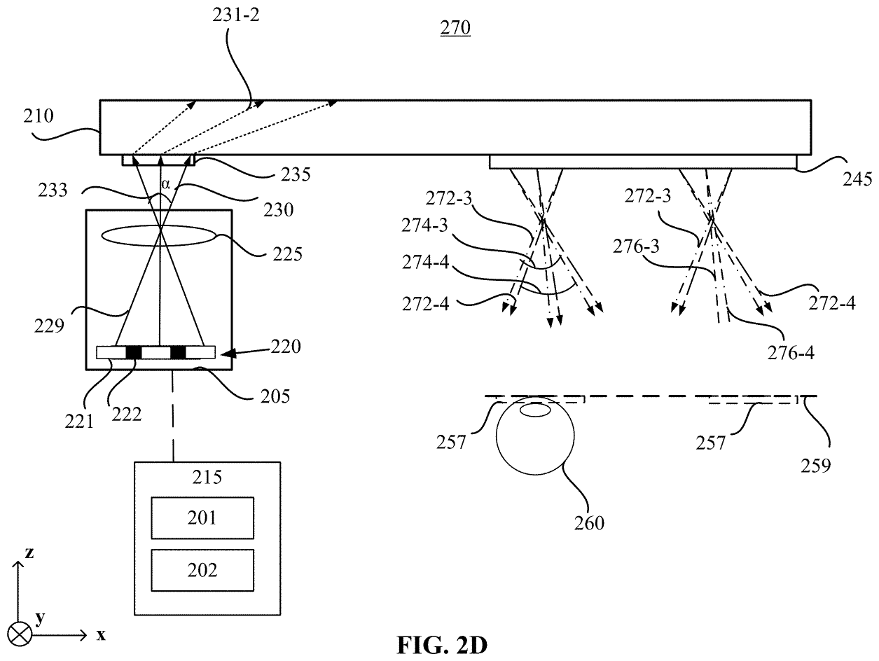

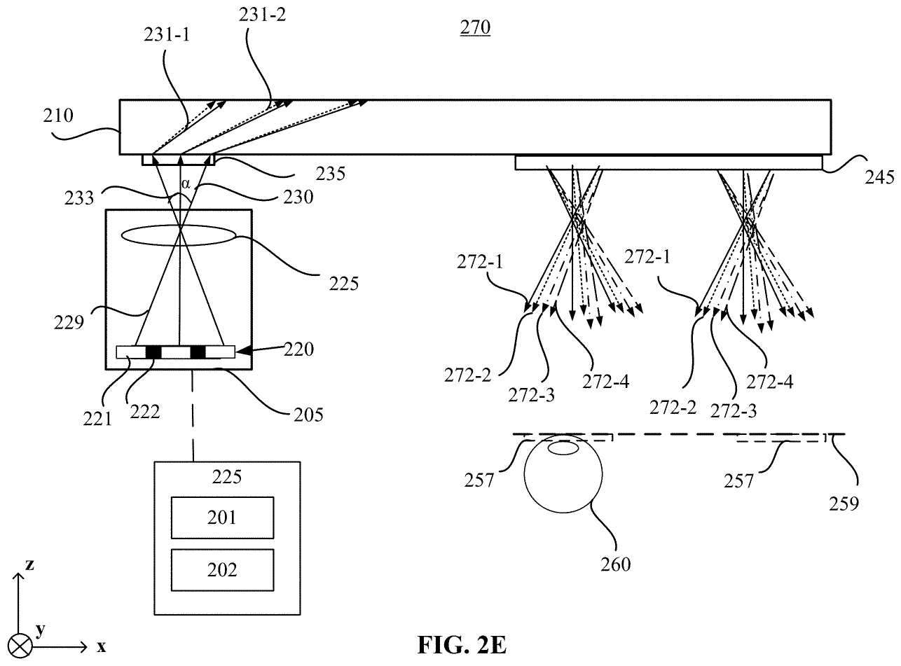

The present disclosure provides a light guide display system configured to provide an increased output pixel density. FIG. 2A illustrates a schematic diagram of a light guide display system or assembly 200 for providing an increased pixel density (pixel per degree), according to an embodiment of the present disclosure. As shown in FIG. 2A, the light guide display system 200 may include a light source assembly 205, a light guide 210, and a controller 215. The light guide 210 may be coupled with an in-coupling element 235 and an out-coupling element 245. The light source assembly 205 may include a display element 220 and a collimating lens 225. The display element 220 may include a display panel that includes a plurality of pixels 221 arranged in an pixel array, in which neighboring pixels 221 may be separated by, e.g., a black matrix 222. For illustrative purposes, FIG. 2A shows that the display element 220 includes three pixels 221.

The light source assembly 205 may output an input image light 230 having an input FOV 233 (e.g., a) toward the light guide 210. The light guide 210 coupled with the in-coupling element 235 and the out-coupling element 245 may direct the input image light 230 to an eye-box region 259 of the light guide display system 200 as a plurality of output image lights 232. Each of the output image lights 232 may have an output FOV 234 (e.g., a) that may be substantially the same as the input FOV 233 (e.g., a). For example, the output image light 232-1 may have a first FOV 234-1, and the output image light 232-2 may have a second FOV 234-2. The FOVs 234-1 and 234-2 may have the same size, substantially overlap each other with a slight shift or rotation. The size of the FOV 234-1 and FOV 234-2 are referred to as the size of the FOV 234. Each output FOV 234 (234-1 and 234-2) may include an axis of symmetry 236 (236-1 and 236-2) that equally divides the output FOV 234 (234-1 and 234-2) in a first half (e.g., α/2) and a second half (e.g., α/2).

The plurality of output image lights 232 may propagate toward a plurality of exit pupils 257 positioned in an eye-box region 259 of the light guide display system 200. The exit pupil 257 may be a location where an eye pupil 258 of an eye 260 of a user is positioned in the eye-box region 259 to receive a virtual image output from the display element 220. In some embodiments, the exit pupils 257 may be arranged in a one-dimensional (“1D”) or a two-dimensional (“2D”) array within the eye-box region 259. The size of a single exit pupil 257 may be larger than and comparable with the size of the eye pupil 258. The exit pupils 257 may be sufficiently spaced apart, such that when one of the exit pupils 257 substantially coincides with the position of the eye pupil 258, the remaining one or more exit pupils 257 may be located beyond the position of the eye pupil 258 (e.g., falling outside of the eye 260). In some embodiments, all of the exit pupils 257 may be simultaneously available at the eye-box region 259. In some embodiments, one or more of the exit pupils 257 (less than all of the exit pupils 257) may be simultaneously available at the eye-box region 259, e.g., depending on the position of the eye pupil 258.

In the embodiment shown in FIG. 2A, the plurality of output image lights 232 may not correspond to the plurality of exit pupils 257 on a one-to-one basis. Instead, at least two of the plurality of output image lights 232 (e.g., 232-1 and 232-2) may propagate toward the same exit pupil 257. The in-coupling element 235 and/or the out-coupling element 245 may be configured, such that for the output image light 232-1 and the output image light 232-2 propagating toward the same exit pupil 257, an axis of symmetry 236-1 of the output FOV 234-1 of the output image light 232-1 may be unparallel with an axis of symmetry 236-2 of the output FOV 234-2 of the output image light 232-2. Instead, the axis of symmetry 236-1 of the output FOV 234-1 may be rotated with respective to the axis of symmetry 236-2 of the output FOV 234-2 in a clockwise or counterclockwise direction. An angle representing the relative rotation between the axis of symmetry 236-1 and the axis of symmetry 236-2 may be smaller than the angular resolution of the eye 260 at the exit pupil 257. Thus, the angular separation between the axis of symmetry 236-1 and the axis of symmetry 236-2 may not be observable by the eye 260.

In some embodiments, an angle representing the relative rotation between the axis of symmetry 236-1 and the axis of symmetry 236-2 (or between the FOV 234-1 and FOV 234-2 of the same FOV size) may be smaller than a first predetermined percentage of the output FOV 234. For example, the first predetermined percentage of the output FOV 234 may be 1%, 2%, 3%, 4%, 5%, 6%, 7%, 8%, 9%, 10%, 11%, 12%, 13%, 14%, 15%, 16%, 17%, 18%, 19%, or 20%, etc. In some embodiments, the relative rotation between the axis of symmetry 236-1 and the axis of symmetry 236-2 may be 0.5°, 1°, 2°, 3°, 4°, 5°, 6°, 7°, 8°, 9°, 10°, etc. In some embodiments, the relative rotation may be less than or equal to 3°, less than or equal to 5°, or less than or equal to 10°, etc. In some embodiments, the relative rotation may be within a range of 1°-10°, 1°-5°, 3°-5°, 0.5°-3°, 5°-10°, or any other range between 0.5° and 10°. In addition, the output FOV 234-1 of the output image light 232-1 and the output FOV 234-2 of the output image light 232-2 may have a substantially wide or large overlapping area (or overlapping FOV portion). The overlapping FOV portion may be greater than a predetermined overlapping percentage of the output FOV 234, and less than the full output FOV 234. For example, the predetermined overlapping percentage between the output FOVs 234-1 and 234-2 may be 80%, 85%, 90%, or 95%, etc., of the FOV 234. For example, in some embodiments, the FOVs 234-1 and 234-2 may overlap with one another with an overlapping portion that is 80%-95% of the FOV 234, 80%-90% of the FOV 234, 80%-85% of the FOV 234, 85%-90% of the FOV 234, 85%-95% of the FOV 234, 90%-95% of the FOV 234, etc.

Compared to the conventional light guided display system 100 shown in FIGS. 1A and 1B, the light guided display system 200 may provide an increased (e.g., doubled) number of image lights 232 with slightly shifted (e.g., tilted) output FOVs 234 propagating through the same exit pupil 257. Thus, the output pixel density of the light guide display system 200 may be increased (e.g., doubled) as compared to the output pixel density of the conventional light guide display system 100 shown in FIGS. 1A and 1B. The output pixel density of the light guide display system 200 may be increased (e.g., doubled) as compared to the input pixel density at the input side of the light guide 210.

The display element 220 may include a display panel, such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a laser scanning display panel, a digital light processing (“DLP”) display panel, or a combination thereof. In some embodiments, the display element 220 may include a self-emissive panel, such as an OLED display panel or a micro-LED display panel. In some embodiments, the display element 220 may include a display panel that is illuminated by an external source, such as an LCD panel, an LCoS display panel, or a DLP display panel. Examples of an external source may include a laser diode, a vertical cavity surface emitting laser, a light emitting diode, or a combination thereof. The display element 220 may output an image light 229 toward the collimating lens 225. The image light 229 may represent a virtual image having a predetermined image size.

The collimating lens 225 may be configured to condition the image light 229 from the display element 220 and output the input image light 230 having the input FOV 233 toward the light guide 210. The collimating lens 225 may transform a linear distribution of pixels in the virtual image having the predetermined image size into an angular distribution of pixels in the image light 230 having the input FOV 233. The input FOV 233 may correspond to an angular region bounded by the leftmost ray and the rightmost ray of the image light 230. In some embodiments, the light source assembly 205 may include one or more addition optical components configured to condition the image light 229 output from the display element 220.

In some embodiments, the in-coupling element 235 may be disposed at a first portion (e.g., an input portion) of the light guide 210. The in-coupling element 235 may couple the image light 230 into a total internal reflection (“TIR”) path inside the light guide 210 as one or more in-coupled image lights 231 (or TIR propagating image lights 231). The one or more in-coupled image lights 231 may have different TIR propagating angles inside the light guide 210. When a light propagates within the light guide through TIR, the angle formed by the TIR path of a light/ray and the normal of the inner surface of the light guide (or the incidence angle of the light/ray incident onto the inner surface of the light guide) may be referred to as a TIR guided angle or a TIR propagation angle. For discussion purposes, FIG. 2A shows the in-coupling element 235 couples the image light 230 into the light guide 210 as a single in-coupled image light 231. The in-coupled image light 231 may propagate inside the light guide 210 through TIR to the out-coupling element 245. For example, the out-coupling element 245 may be disposed at a second portion (e.g., an output portion) of the light guide 210. The first portion and the second portion may be located at different locations of the light guide 210. The out-coupling element 245 may be configured to couple the TIR propagating image light 231 out of the light guide 210 as the plurality of output image lights 232 toward the eye-box region 259. In some embodiments, the out-coupling element 245 may consecutively couple the TIR propagating image light 231, which is incident onto the different positions of the out-coupling element 245, out of the light guide 210 at different positions of the out-coupling element 245. Thus, the out-coupling element 245 may replicate the image light 230 at the output side of the light guide 210, to expand an effective pupil of the light guide display system 200. In some embodiments, the light guide 210 may also receive a light 255 from a real-world environment, and may combine the light 255 with the output image light 232, and deliver the combined light to the eye 260.

In some embodiments, each of the in-coupling element 235 and the out-coupling element 245 may be formed or disposed at (e.g., affixed to) a first surface 210-1 or a second surface 210-2 of the light guide 210. In some embodiments, each of the in-coupling element 235 and the out-coupling element 245 may be integrally formed as a part of the light guide 210, or may be a separate element coupled to the light guide 210. In some embodiments, the in-coupling element 235 and/or the out-coupling element 245 may include one or more diffraction gratings, one or more cascaded reflectors, one or more prismatic surface elements, and/or an array of holographic reflectors, or any combination thereof.

The light guide 210 may include one or more materials configured to facilitate the TIR of the TIR propagating image light 231. The light guide 210 may include, for example, a plastic, a glass, and/or polymers. The light guide 210 may have a relatively small form factor. In some embodiments, the light guide display system 200 may include additional elements configured to redirect, fold, and/or expand the TIR propagating image light 231. For example, as shown in FIG. 2A, one or more redirecting/folding elements 240 may be coupled to the light guide 210 to direct the TIR propagating image light 231 propagating inside the light guide 210 in a predetermined direction. In some embodiments, the redirecting element 240 and the out-coupling element 245 may be disposed at a same surface or at different surfaces of the light guide 210. In some embodiments, the redirecting element 240 may be separately formed and disposed at (e.g., affixed to) the first surface 210-1 or the second surface 210-2, or may be integrally formed as a part of the light guide 210. In some embodiments, the redirecting element 240 may be configured to expand the TIR propagating image light 231 in a first direction (e.g., a y-axis direction in FIG. 2A). The redirecting element 240 may redirect the expanded TIR propagating image light 231 to the out-coupling element 245. The out-coupling element 245 may couple the TIR propagating image light 231 out of the light guide 210, and expand the TIR propagating image light 231 in a second direction (e.g., an x-axis direction in FIG. 2A). Thus, a two-dimensional (“2D”) expansion of the image light 230 may be provided at the output side of the light guide 210. In some embodiments, multiple functions, e.g., out-coupling, redirecting, folding, and/or expanding the image light 230 may be combined into a single element, e.g. the out-coupling element 245, and hence, the redirecting element 240 may be omitted. For example, the out-coupling element 245 itself may provide a 2D expansion of the image light 230 at the output side of the light guide 210.

Although the light guide 210, the in-coupling element 235, and the out-coupling element 245 are shown as having flat surfaces for illustrative purposes, any of the light guides, in-coupling elements, out-coupling elements, and redirecting elements disclosed herein may include one or more curved surfaces or may have curved shapes. The controller 215 may be communicatively coupled with the light source assembly 205, and may control the operations of the light source assembly 205 to generate an input image light. The controller 215 may also control the operation state (e.g., a diffraction state or a non-diffraction state) of the in-coupling element 235, the out-coupling element 245, and/or the redirecting element 240. The controller 215 may include a processor or processing unit 201. The controller 215 may include a storage device 202. The storage device 202 may be a non-transitory computer-readable medium, such as a memory, a hard disk, etc., for storing data, information, and/or computer-executable program instructions or codes.

In some embodiments, the light guided display system 200 may include a plurality of light guides 210 disposed in a stacked configuration (not shown in FIG. 2A). At least one (e.g., each) of the plurality of light guides 210 coupled with one or more diffractive elements (e.g., in-coupling element, out-coupling element, and/or redirecting or folding element) may provide an increased pixel density at the output side. In some embodiments, the plurality of light guides 210 in the stacked configuration may be configured to output a polychromatic image light (e.g., a full-color image light including components of multiple colors).

In some embodiments, the light guided display system 200 may include one or more light source assemblies 205 coupled to the one or more light guides 210. In some embodiments, at least one (e.g., each) of the light source assemblies 205 may be configured to emit a monochromatic image light of a specific wavelength band corresponding to a primary color (e.g., red, green, or blue) and an input FOV. In some embodiments, the light guided display system 200 may include three light guides 210 to deliver a component color image (e.g., a primary color image), e.g., red, green, and blue lights, respectively, in any suitable order, or simultaneously. At least one (e.g., each) of the three light guides 210 may be coupled with or include one or more diffractive elements (e.g., in-coupling element, out-coupling element, and/or redirecting element). In some embodiments, the light guide display system 200 may include two light guides configured to deliver component color images (e.g., primary color images) by in-coupling and subsequently out-coupling, e.g., a combination of red and green lights, and a combination of green and blue lights, respectively, in any suitable order or simultaneously.

For discussion purposes, in the following descriptions, the light guide display system 200 is presumed to include the in-coupling element 235 and the out-coupling element 245 without the redirecting element 240. In some embodiments, at least one of the in-coupling element 235 or the out-coupling element 245 may be a diffractive element that includes one or more diffraction gratings. For discussion purposes, a diffraction grating included in the in-coupling element 235 may be referred to as an in-coupling grating 235, and a diffraction grating included in the out-coupling element 245 may be referred to as an out-coupling grating 245.

In some embodiments, at least one of the in-coupling grating 235 or the out-coupling grating 245 may be an active grating. In some embodiments, the active grating may be controlled or switched, e.g., by the controller 215, between operating in a diffraction state to diffract an incident light, and operating in a non-diffraction state to transmit the incident light with substantially zero or negligible diffraction. In some embodiments, the active grating that operates in the diffraction state may provide a fixed diffraction angle for an incident light with a fixed incidence angle. In some embodiments, the active grating that operates in the diffraction state may provide a tunable diffraction angle for the incident light with a fixed incidence angle. For example, the active grating may operate in different diffraction states when driven by different driving voltages, thereby diffracting the incident light with the fixed incidence angle at different diffraction angles. In some embodiments, when the driving voltage applied to the active grating is changed, the grating period of the active grating may be changed, such that the active grating may diffract the incident light with the fixed incidence angle to different diffraction angles. In some embodiments, when the driving voltage applied to the active grating is changed, a modulation of the refractive index of the active grating may be changed, such that the active grating may diffract the incident light with the fixed incidence angle to different diffraction angles.

The active grating may be polarization sensitive (or polarization selective) or polarization insensitive (or polarization non-selective). The active grating may be a reflective grating or a transmissive grating. The active grating may be fabricated based on any suitable materials. In some embodiments, the active grating fabricated based on active liquid crystals (“LCs”) may include active LC molecules, orientations of which may be changeable by the external field (e.g., external electric field). Examples of active gratings may include, but not be limited to, holographic polymer-dispersed liquid crystal (“H-PDLC”) gratings, surface relief gratings provided (e.g., filled) with active LCs, Pancharatnam-Berry phase (“PBP”) gratings based on active LCs, polarization volume holograms (“PVHs”) based on active LCs, etc.

In the following, exemplary light guide display systems for providing an increased output pixel density will be described. For illustrative purposes, various light guide display systems for one-dimensional (“1D”) pupil expansion and output pixel density increase (e.g., in an x-axis direction) are used as examples to explain the principle of increasing the output pixel density, such as those shown in FIGS. 2A-5C. In some embodiments, two-dimensional (“2D”) pupil expansion and output pixel density increase (e.g., in both x-axis direction and y-axis direction) may be achieved by introducing an additional diffractive optical element (e.g., a folding or redirecting element) that folds the in-coupled image light by 90° toward the out-coupling element. In some embodiments, the out-coupling elements shown in the FIGS. 2A-5C may include the folding function, and the redirecting element may be omitted. Thus, although 1D pupil expansion and output pixel density increase (e.g., in an x-axis direction) are used to explain the principle of the embodiments shown in FIGS. 2A-5C, the light guide display systems included in FIGS. 2A-5C can provide 2D pupil expansion and output pixel density increase.

In some embodiments, when the in-coupled image light 231 is a polarized light, the polarization of the in-coupled image light 231 may change while propagating inside the one or more light guides 210. A retardation film (e.g., a polarization correction film) may be disposed adjacent or on the respective light guide to compensate for the change in the polarization, thereby preserving the polarization of the in-coupled image light 231 when the in-coupled image light 231 propagates inside the one or more light guide 210. For discussion purposes, in FIGS. 2A-5C, when the in-coupled image light (or a TIR propagating light) is a polarized light, the polarization of the in-coupled image light (or the TIR propagating light) is presumed to be unaffected while propagating inside the one or more light guides.

In the embodiment shown in FIG. 2A, the out-coupling grating 245 may be an active grating that provides a tunable diffraction angle for the in-coupled image light 231. For example, the controller 215 may change the driving voltage of the out-coupling grating 245, such that the out-coupling grating 245 operates in different diffraction states to provide different diffraction angles to the in-coupled image light 231. The in-coupling grating 235 may be an active grating or a passive grating. In some embodiments, a display frame of the virtual image output from the display element 220 may be divided into a plurality of (e.g., two) sub-frames (sub-frames being exemplary two time periods). During each of a first sub-frame (an example of a first time period) and a second sub-frame (an example of a second time period), the controller 215 may control the light source assembly 205 to output the input image light 230 with the input FOV 233. The in-coupling grating 235 may be configured to couple the image light 230 into the light guide 210 as the in-coupled image light 231. During the first sub-frame and the second sub-frame, the control 215 may control the driving voltages of the out-coupling grating 245, such that the out-coupling grating 245 operates in different diffraction states to diffract the same in-coupled image light 231 at different diffraction angles. For discussion purposes, FIG. 2A shows that the in-coupled image light 231 includes three rays. A central ray among the three rays is used as an example. During the first sub-frame and the second sub-frame, the out-coupling grating 245 may diffract the same central ray of the in-coupled image light 231 at two different diffraction angles.

For example, during the first sub-frame, the control 215 may control the driving voltage of the out-coupling grating 245 to operate in a first diffraction state to couple, via diffraction, the in-coupled image light 231 out of the light guide 210 as a plurality of first output image lights 232-1 towards the plurality of exit pupils 257. The rays of the first output image lights 232-1 are represented by solid lines. The plurality of first output image lights 232-1 may correspond to the plurality of exit pupils 257 on a one-to-one basis. Each of the first output image lights 232-1 may have the output FOV 234-1 that may be substantially the same as the input FOV 233. The first diffraction state of the out-coupling grating 245 may be configured (e.g., by configuring the grating period or the modulation of the refractive index of the out-coupling grating 245), such that the out-coupling grating 245 may diffract the in-coupled image light 231 as the first output image light 232-1, with the axis of symmetry 236-1 of the output FOV 234-1 perpendicular to the surface of the light guide 210. That is, the axis of symmetry 236-1 of the output FOV 234-1 of the first output image light 232-1 may be parallel with the surface normal of the light guide 210.

During the second sub-frame, the control 215 may control the driving voltage of the out-coupling grating 245 to be a second driving voltage different from the first driving voltage, such that the out-coupling grating 245 operates in a second diffraction state to couple, via diffraction, the in-coupled image light 231 out of the light guide 210 as a plurality of second output image lights 232-2 towards the plurality of exit pupils 257. The rays of the second output image lights 232-2 are represented by dashed lines. The plurality of second output image lights 232-2 may correspond to the plurality of exit pupils 257 on a one-to-one basis. Each of the second output image lights 232-2 may have the output FOV 234-2 that may be substantially the same as the input FOV 233. The second diffraction state of the out-coupling grating 245 may be configured (e.g., by configuring the grating period or the modulation of the refractive index of the out-coupling grating 245), such that the out-coupling grating 245 may diffract the in-coupled image light 231 as the second output image light 232-2, with the axis of symmetry 236-2 of the output FOV 234-2 being unparallel with the surface normal of the light guide 210.

Referring to FIG. 2A, the first and second diffraction states of the out-coupling grating 245 may be configured (e.g., by configuring the grating periods or the modulations of the refractive index of the out-coupling grating 245), such that for the first output image light 232-1 and the second output image light 232-2 propagating toward the same exit pupil 257, the axis of symmetry 236-2 of the output FOV 234-2 of the second output image light 232-2 may be rotated with respective to the axis of symmetry 236-1 of the output FOV 234-1 of the first output image light 232-1 in a clockwise or counterclockwise direction. For discussion purposes, FIG. 2A shows that the axis of symmetry 236-2 of the output FOV 234-2 is rotated with respective to the axis of symmetry 236-1 of the output FOV 234-1 in the counter-clockwise direction.

For the first output image light 232-1 and the second output image light 232-2 propagating toward the same exit pupil 257, an angle representing the relative rotation between the axis of symmetry 236-1 and the axis of symmetry 236-2 may be smaller than the angular resolution of the eye 260 at the exit pupil 257. Thus, the angular separation between the axis of symmetry 236-1 and the axis of symmetry 236-2 may not be observable by the eye 260. In some embodiments, an angle representing the relative rotation between the axis of symmetry 236-1 and the axis of symmetry 236-2 may be smaller than the first predetermined percentage of the output FOV 234. The output FOV 234-1 of the first output image light 232-1 and the output FOV 234-2 of the second output image light 232-2 may have a substantially wide or large overlapping area (or overlapping FOV portion). In some embodiments, an angle representing the overlapping FOV portion may be greater than the second predetermined percentage of the output FOV 234, and smaller than the full output FOV 234.

Compared to the conventional light guided display system 100 shown in FIGS. 1A and 1B, the light guided display system 200 may provide an increased (e.g., doubled) number of image lights 232 with slightly shifted (e.g., titled) output FOVs 234 propagating through the same exit pupil 257. Thus, the output pixel density of the light guide display system 200 may be increased (e.g., doubled) as compared to the output pixel density of the conventional light guide display system 100 shown in FIGS. 1A and 1B. The output pixel density of the light guide display system 200 may be increased (e.g., doubled) as compared to the input pixel density at the input side of the light guide 210.

FIG. 2B illustrates a schematic diagram of a light guide display system or assembly 250 for providing an increased output pixel density, according to an embodiment of the present disclosure. The light guide display system 250 may include elements that are similar to or the same as those included in the light guide display system 200 shown in FIG. 2A. Descriptions of the same or similar elements or features can refer to the above corresponding descriptions, including those rendered in connection with FIG. 2A.

In the embodiment shown in FIG. 2B, the in-coupling grating 235 may be an active grating configured to provide a tunable diffraction angle for the input image light 230. For example, the controller 215 may control the driving voltage of the in-coupling grating 235 to be different, such that the in-coupling grating 235 may operate in different diffraction states to provide different diffraction angles for the same input image light 230. The out-coupling grating 245 may be an active grating or a passive grating. In some embodiments, a display frame of the virtual image output from the display element 220 may be divided into a plurality of (e.g., two) sub-frames (sub-frames being exemplary two time periods). During each of a first sub-frame and a second sub-frame, the controller 215 may control the light source assembly 205 to output the input image light 230 with the input FOV 233. During the first sub-frame and the second sub-frame, the control 215 may control the driving voltages of the in-coupling grating 235 to be different, such that the in-coupling grating 235 operates in different diffraction states to diffract the same input image light 230 at different diffraction angles. For discussion purposes, FIG. 2B shows that the input image light 230 includes three rays. A central ray among the three rays is used as an example. During the first sub-frame and the second sub-frame, the in-coupling grating 235 may diffract the same central ray of the input image light 230 at two different diffraction angles.

For example, during the first sub-frame, the control 215 may control the driving voltage of the in-coupling grating 235 to be a first driving voltage, such that the in-coupling grating 235 operates in a first diffraction state. The in-coupling grating 235 may couple, via diffraction, the input image light 230 into the light guide 210 as a first in-coupled image light 231-1. The rays of the first in-coupled image light 231-1 are represented by solid lines. The in-coupling grating 235 may diffract the central ray of the input image light 230 as a central ray of the first in-coupled image light 231-1 with a first TIR propagating angle inside the light guide 210.

The out-coupling grating 245 may couple, via diffraction, the first in-coupled image light 231-1 out of the light guide 210 as a plurality of first output image lights 252-1 towards the plurality of exit pupils 257. The plurality of first output image lights 252-1 may correspond to the plurality of exit pupils 257 on a one-to-one basis. Each of the first output image lights 252-1 may have an output FOV 254-1 that may be substantially the same as the input FOV 233. The first diffraction state of the in-coupling grating 235 may be configured (e.g., by configuring the grating period or the modulation of the refractive index of the in-coupling grating 235), such that the out-coupling grating 245 may diffract the first in-coupled image light 231-1 as the first output image light 252-1, with an axis of symmetry 256-1 of the output FOV 254-1 perpendicular to the surface of the light guide 210. That is, the axis of symmetry 256-1 of the output FOV 254-1 of the first output image light 252-1 may be parallel with the surface normal of the light guide 210.

During the second sub-frame, the control 215 may control the driving voltage of the in-coupling grating 235 to be a second driving voltage, such that the in-coupling grating 235 operates in a second diffraction state. The in-coupling grating 235 may couple, via diffraction, the input image light 230 into the light guide 210 as a second in-coupled image light 231-2. The rays of the second in-coupled image light 231-2 are represented by dashed lines. The in-coupling grating 235 may diffract the central ray of the input image light 230 as a central ray of the second in-coupled image light 231-2 with a second TIR propagating angle inside the light guide 210. The second TIR propagating angle may be different from the first TIR propagating angle. The out-coupling grating 245 may couple, via diffraction, the second in-coupled image light 231-2 out of the light guide 210 as a plurality of second output image lights 252-2 towards the plurality of exit pupils 257. The plurality of second output image lights 252-2 may correspond to the plurality of exit pupils 257 on a one-to-one basis. Each of the second output image lights 252-2 may have an output FOV 254-2 that may be substantially the same as the input FOV 233. The second diffraction state of the in-coupling grating 235 may be configured (e.g., by configuring the grating period or the modulation of the refractive index of the in-coupling grating 235), such that the out-coupling grating 245 may diffract the second in-coupled image light 231-2 as the second output image light 252-2, with an axis of symmetry 256-2 of the output FOV 254-2 being unparallel with the surface normal of the light guide 210.

Referring to FIG. 2B, the first and second diffraction states of the in-coupling grating 235 may be configured (e.g., by configuring the grating periods or the modulations of the refractive index of the in-coupling grating 235), such that for the first output image light 252-1 and the second output image light 252-2 propagating toward the same exit pupil 257, the axis of symmetry 256-2 of the output FOV 254-2 of the second output image light 252-2 may be rotated with respective to the axis of symmetry 256-1 of the output FOV 254-1 of the first output image light 252-1 in a clockwise or counterclockwise direction. For discussion purposes, FIG. 2B shows that the axis of symmetry 256-2 of the output FOV 254-2 is rotated with respective to the axis of symmetry 256-1 of the output FOV 254-1 in the counter-clockwise direction. In addition, the output image lights 252-1 and 252-2 may be relatively shifted in the x-axis direction.

For the first output image light 252-1 and the second output image light 252-2 propagating toward the same exit pupil 257, an angle representing the relative rotation between the axis of symmetry 256-1 and the axis of symmetry 256-2 may be smaller than the angular resolution of the eye 260 at the exit pupil 257. Thus, the angular separation between the axis of symmetry 256-1 and the axis of symmetry 256-2 may not be observable by the eye 260. In some embodiments, an angle representing the relative rotation between the axis of symmetry 256-1 and the axis of symmetry 256-2 may be smaller than the first predetermined percentage of the output FOV 254-1 or 254-2. The output FOV 254-1 of the first output image light 252-1 and the output FOV 254-2 of the second output image light 252-2 may have a substantially wide or large overlapping area (or overlapping FOV portion). In some embodiments, an angle representing the overlapping FOV portion may be greater than the second predetermined percentage of the output FOV 254-1 or 254-2, and smaller than the full output FOV 254-1 or 254-2.

Compared to the conventional light guided display system 100 shown in FIGS. 1A and 1B, the light guided display system 250 may provide an increased (e.g., doubled) number of image lights 252-1 and 252-2 with slightly shifted (e.g., tilted) output FOVs 254-1 and 254-2 propagating through the same exit pupil 257. Thus, the output pixel density of the light guide display system 250 may be increased (e.g., doubled) as compared to the output pixel density of the conventional light guide display system 100 shown in FIGS. 1A and 1B. The output pixel density of the light guide display system 250 may be increased (e.g., doubled) as compared to the input pixel density at the input side of the light guide 210.

FIGS. 2C-2E illustrate x-z sectional views of a light guide display system or assembly 270 for providing an increased pixel density (pixel per degree), according to an embodiment of the present disclosure. The light guide display system or assembly 270 may include elements that are similar to or the same as those included in the light guide display system 200 shown in FIG. 2A, or the light guide display system 250 shown in FIG. 2B. Descriptions of the same or similar elements or features can refer to the above corresponding descriptions, including those rendered in connection with FIG. 2A or 2B.

In the embodiment shown in FIGS. 2C-2E, the in-coupling grating 235 may be an active grating that provides a tunable diffraction angle for the input image light 230. For example, the controller 215 may control the driving voltages of the in-coupling grating 235, such that the in-coupling grating 235 may operate in different diffraction states to provide different diffraction angles. The out-coupling grating 245 may be an active grating that provides a tunable diffraction angle for the in-coupled image light 231-1 or 231-2. For example, the controller 215 may control the driving voltages of the out-coupling grating 245, such that the out-coupling grating 245 may operate in different diffraction states to provide different diffraction angles. In some embodiments, a display frame of the virtual image output from the display element 220 may be divided into a plurality of (e.g., four) sub-frames (sub-frames being exemplary four time periods). During each of a first sub-frame, a second sub-frame, a third sub-frame, and a fourth sub-frame, the controller 215 may control the light source assembly 205 to output the input image light 230 with the input FOV 233.

FIG. 2C illustrates an x-z sectional views of the light guide display system 270 during a first sub-frame and a second sub-frame. As shown in FIG. 2C, during the first sub-frame and the second sub-frame, the control 215 may control the driving voltage of the in-coupling grating 235 to be a same first driving voltage, such that the in-coupling grating 235 may operate in a same first diffraction state. During the first sub-frame and the second sub-frame, the in-coupling grating 235 may diffract the input image light 230 to the same diffraction angle. The in-coupling grating 235 may couple, via diffraction, the input image light 230 into the light guide 210 as a first in-coupled image light 231-1. For example, during the first sub-frame and the second sub-frame, the in-coupling grating 235 may diffract the central ray of the input image light 230 as a central ray of the first in-coupled image light 231-1 with a first TIR propagating angle inside the light guide 210.

During the first sub-frame and the second sub-frame, the control 215 may control the out-coupling grating 245 to operate in different diffraction states to diffract the first in-coupled image light 231-1 at different diffraction angles. For example, during the first sub-frame, the control 215 may control the driving voltage of the out-coupling grating 245 to be a first driving voltage, such that the out-coupling grating 245 may operate in a first diffraction state. The out-coupling grating 245 may couple, via diffraction, the first in-coupled image light 231-1 out of the light guide 210 as a plurality of first output image lights 272-1 towards the plurality of exit pupils 257. The plurality of first output image lights 272-1 may correspond to the plurality of exit pupils 257 on a one-to-one basis. Each of the first output image lights 272-1 may have an output FOV 274-1 that may be substantially the same as the input FOV 233. The first diffraction state of the in-coupling grating 235 may be configured (e.g., by configuring the grating period or the modulation of the refractive index of the in-coupling grating 235), and the first diffraction state of the out-coupling grating 245 may be configured (e.g., by configuring the grating period or the modulation of the refractive index of the out-coupling grating 245), such that the out-coupling grating 245 may diffract the first in-coupled image light 231-1 as the first output image light 272-1, with an axis of symmetry 276-1 of the output FOV 274-1 being perpendicular to the surface of the light guide 210. That is, the axis of symmetry 276-1 of the output FOV 274-1 of the first output image light 272-1 may be parallel with the surface normal of the light guide 210.

During the second sub-frame, the control 215 may control the driving voltage of the out-coupling grating 245 to be a second driving voltage, such that the out-coupling grating 245 may operate in a second diffraction state. The out-coupling grating 245 may couple, via diffraction, the first in-coupled image light 231-1 out of the light guide 210 as a plurality of second output image lights 272-2 towards the plurality of exit pupils 257. The plurality of second output image lights 272-2 may correspond to the plurality of exit pupils 257 on a one-to-one basis. Each of the second output image lights 272-2 may have an output FOV 274-2 that may be substantially the same as the input FOV 233. The first diffraction state of the in-coupling grating 235 may be configured (e.g., by configuring the grating period or the modulation of the refractive index of the in-coupling grating 235), and the second diffraction state of the out-coupling grating 245 may be configured (e.g., by configuring the grating period or the modulation of the refractive index of the out-coupling grating 245), such that the out-coupling grating 245 may diffract the first in-coupled image light 231-1 as the second output image light 272-2, with an axis of symmetry 276-2 of the output FOV 274-2 being unparallel with the surface normal of the light guide 210.

For the first output image light 272-1 and the second output image light 272-2 propagating toward the same exit pupil 257, the axis of symmetry 276-2 of the output FOV 274-2 of the second output image light 272-2 may be rotated with respective to the axis of symmetry 276-1 of the output FOV 274-1 of the first output image light 272-1 in a clockwise or counterclockwise direction. For discussion purposes, FIG. 2C shows that the axis of symmetry 276-2 of the output FOV 274-2 is rotated with respective to the axis of symmetry 276-1 of the output FOV 274-1 in the counter-clockwise direction.

For the first output image light 272-1 and the second output image light 272-2 propagating toward the same exit pupil 257, an angle representing the relative rotation between the axis of symmetry 276-1 and the axis of symmetry 276-2 may be smaller than the angular resolution of the eye 260 at the exit pupil 257. Thus, the angular separation between the axis of symmetry 276-1 and the axis of symmetry 276-2 may not be observable by the eye 260. In some embodiments, an angle representing the relative rotation between the axis of symmetry 276-1 and the axis of symmetry 276-2 may be smaller than the first predetermined percentage of the output FOV 274-1 or 274-2. The output FOV 274-1 of the first output image light 272-1 and the output FOV 274-2 of the second output image light 272-2 may have a substantially wide or large overlapping area (or overlapping FOV portion). In some embodiments, an angle representing the overlapping FOV portion may be greater than the second predetermined percentage of the output FOV 274-1 or 274-2, and smaller than the full output FOV 274-1 or 274-2.

FIG. 2D illustrates an x-z sectional views of the light guide display system 270 during a third sub-frame and a fourth sub-frame. As shown in FIG. 2D, during the third sub-frame and the fourth sub-frame, the control 215 may control the in-coupling grating 235 to operate in the same diffraction state. For example, during the third sub-frame and the fourth sub-frame, the control 215 may control the driving voltage of the in-coupling grating 235 to be a same second driving voltage different from the first driving voltage, such that the in-coupling grating 235 may operate in a second diffraction state to diffract the input image light 230 to the same diffraction angle. The in-coupling grating 235 may couple, via diffraction, the input image light 230 into the light guide 210 as a second in-coupled image light 231-2. For example, during the third sub-frame and the fourth sub-frame, the in-coupling grating 235 may diffract the central ray of the input image light 230 as a central ray of the second in-coupled image light 231-2 with a second TIR propagating angle inside the light guide 210. The second TIR propagating angle may be different from the first TIR propagating angle.

During the third sub-frame and the fourth sub-frame, the control 215 may control the out-coupling grating 245 to operate in different diffraction states to diffract the second in-coupled image light 231-2 at different diffraction angles. For example, during the third sub-frame, the control 215 may control the driving voltage of the out-coupling grating 245 to be a third driving voltage, such that the out-coupling grating 245 may operate in a third diffraction state. The out-coupling grating 245 may couple, via diffraction, the second in-coupled image light 231-2 out of the light guide 210 as a plurality of third output image lights 272-3 towards the plurality of exit pupils 257. The plurality of third output image lights 272-3 may correspond to the plurality of exit pupils 257 on a one-to-one basis. Each of the third output image lights 272-3 may have an output FOV 274-3 that may be substantially the same as the input FOV 233. The second diffraction state of the in-coupling grating 235 may be configured (e.g., by configuring the grating period or the modulation of the refractive index of the in-coupling grating 235), and the third diffraction state of the out-coupling grating 245 may be configured (e.g., by configuring the grating period or the modulation of the refractive index of the out-coupling grating 245), such that the out-coupling grating 245 may diffract the second in-coupled image light 231-2 as the third output image light 272-3, with an axis of symmetry 276-3 of the output FOV 274-3 being unparallel with the surface normal of the light guide 210.

Referring to FIGS. 2C and 2D, for the first output image light 272-1, for the second output image light 272-2, and the third output image light 272-3 propagating toward the same exit pupil 257, the axis of symmetry 276-3 of the output FOV 274-3 of the third output image light 272-3 may be rotated with respective to each of the axis of symmetry 276-1 of the output FOV 274-1 of the first output image light 272-1 and the axis of symmetry 276-2 of the output FOV 274-2 of the second output image light 272-2 in a clockwise or counterclockwise direction. For discussion purposes, FIGS. 2C and 2D show that the axis of symmetry 276-3 is rotated with respective to each of the axis of symmetry 276-1 (or the surface normal of the light guide 210) and the axis of symmetry 276-2 in the counter-clockwise direction.

For the first output image light 272-1, the second output image light 272-2, and the third output image light 272-3 propagating toward the same exit pupil 257, an angle representing the relative rotation between the axis of symmetry 276-3 and each of the axis of symmetry 276-1 and the axis of symmetry 276-2 may be smaller than the angular resolution of the eye 260 at the exit pupil 257. Thus, the angular separation between the axis of symmetry 276-3 and each of the axis of symmetry 276-1 and the axis of symmetry 276-2 may not be observable by the eye 260.

In some embodiments, an angle representing the relative rotation between the axis of symmetry 276-3 and each of the axis of symmetry 276-1 and the axis of symmetry 276-2 may be smaller than the first predetermined percentage of the output FOV 274-3 (or 274-1, or 274-2). The output FOV 274-3 and the output FOV 274-1 (or 274-2) may have a substantially wide or large overlapping area (or overlapping FOV portion). In some embodiments, an angle representing the overlapping FOV portion may be greater than the second predetermined percentage of the output FOV 274-3 (or 274-1, or 274-2), and smaller than the full output FOV 274-3 (or 274-1, or 274-2).

Referring back to FIG. 2D, during the fourth sub-frame, the control 215 may control the driving voltage of the out-coupling grating 245 to be a fourth driving voltage, such that the out-coupling grating 245 may operate in a fourth diffraction state. The out-coupling grating 245 may couple, via diffraction, the second in-coupled image light 231-2 out of the light guide 210 as a plurality of fourth output image lights 272-4 towards the plurality of exit pupils 257. The plurality of fourth output image lights 272-4 may correspond to the plurality of exit pupils 257 on a one-to-one basis. Each of the fourth output image lights 272-4 may have an output FOV 274-4 that may be substantially the same as the input FOV 233. The second diffraction state of the in-coupling grating 235 may be configured (e.g., by configuring the grating period or the modulation of the refractive index of the in-coupling grating 235), and the fourth diffraction state of the out-coupling grating 245 may be configured (e.g., by configuring the grating period or the modulation of the refractive index of the out-coupling grating 245), such that the out-coupling grating 245 may diffract the second in-coupled image light 231-2 as the fourth output image light 272-4, with an axis of symmetry 276-4 of the output FOV 274-4 being unparallel with the surface normal of the light guide 210.

Referring to FIGS. 2C and 2D, for the first output image light 272-1, for the second output image light 272-2, the third output image light 272-3, and the fourth output image light 272-4 propagating toward the same exit pupil 257, the axis of symmetry 276-4 of the output FOV 274-4 of the fourth output image light 272-4 may be rotated with respective to each of the axis of symmetry 276-1 of the output FOV 274-1 of the first output image light 272-1, the axis of symmetry 276-2 of the output FOV 274-2 of the second output image light 272-2, and the axis of symmetry 276-3 of the output FOV 274-3 of the third output image light 272-3 in a clockwise or counterclockwise direction. For discussion purposes, FIGS. 2C and 2D show that the axis of symmetry 276-4 is rotated with respective to each of the axis of symmetry 276-1 (or the surface normal of the light guide 210), the axis of symmetry 276-2, and the axis of symmetry 276-3 in the counter-clockwise direction.

For the first output image light 272-1, the second output image light 272-2, the third output image light 272-3, and the fourth output image light 272-4 propagating toward the same exit pupil 257, an angle representing the relative rotation between the axis of symmetry 276-4 and each of the axis of symmetry 276-1, the axis of symmetry 276-2, and the axis of symmetry 276-3 may be smaller than the angular resolution of the eye 260 at the exit pupil 257. Thus, the angular separation between the axis of symmetry 276-4 and each of the axis of symmetry 276-1, the axis of symmetry 276-2, and the axis of symmetry 276-3 may not be observable by the eye 260 at the exit pupil 257.

In some embodiments, an angle representing the relative rotation between the axis of symmetry 276-4 and each of the axis of symmetry 276-1, the axis of symmetry 276-2, and the axis of symmetry 276-3 may be smaller than the first predetermined percentage of the output FOV 274-4 (or 274-1, or 274-2, or 274-3). The output FOV 274-4 and the output FOV 274-1 (or 274-2, or 274-3) may have a substantially wide or large overlapping area (or overlapping FOV portion). In some embodiments, an angle representing the overlapping FOV portion may be greater than the second predetermined percentage of the output FOV 274-4 (or 274-1, or 274-2, or 274-3), and smaller than the full output FOV 274-4 (or 274-1, or 274-2, or 274-3).

FIG. 2E illustrates an x-z sectional view of the light guide display system 270 operating during the first to the fourth sub-frames. As shown in FIG. 2E, angles representing the relative rotations between the axis of symmetry 276-4 and each of the axis of symmetry 276-1, the axis of symmetry 276-2, and the axis of symmetry 276-3 may be different. For example, the angle representing the relative rotation between the axis of symmetry 276-4 and the axis of symmetry 276-1 may be the greatest, and the angle representing the relative rotation between the axis of symmetry 276-2 and the axis of symmetry 276-1 may be the smallest. The angle representing the relative rotation between the axis of symmetry 276-3 and the axis of symmetry 276-1 may be greater than the angle representing of the relative rotation between the axis of symmetry 276-2 and the axis of symmetry 276-1, and smaller than the angle representing of the relative rotation between the axis of symmetry 276-4 and the axis of symmetry 276-1.

Compared to the conventional light guided display system 100 shown in FIGS. 1A and 1B, the light guided display system 270 of the present disclosure may provide an increased (e.g., quadrupled) number of image lights 272-1, 272-2, 272-3, and 272-4 with slightly shifted output FOVs 274-1, 274-2, 274-3, and 274-4 propagating through the same exit pupil 257. Thus, the output pixel density of the light guide display system 270 may be increased (e.g., quadrupled) as compared to the output pixel density of the conventional light guide display system 100 shown in FIGS. 1A and 1B. The output pixel density of the light guide display system 270 may be increased (e.g., quadrupled) as compared to the input pixel density at the input side of the light guide 210.

In some embodiments, an active grating configured to operate in a plurality of (e.g., two) different diffraction states (e.g., at different driving voltages) to diffract the same incident light at a plurality of (e.g., two) different diffraction angles may be replaced by a plurality of (e.g., two) active gratings. Each of the plurality of (e.g., two) active gratings may be controlled or switched, e.g., by the controller 215, between operating in a diffraction state to diffract an incident light, and operating in a non-diffraction state to transmit the incident light with substantially zero or negligible diffraction. The plurality of (e.g., two) active gratings that operates in the diffraction state may diffract the same incident light at a plurality of (e.g., two) different diffraction angles.

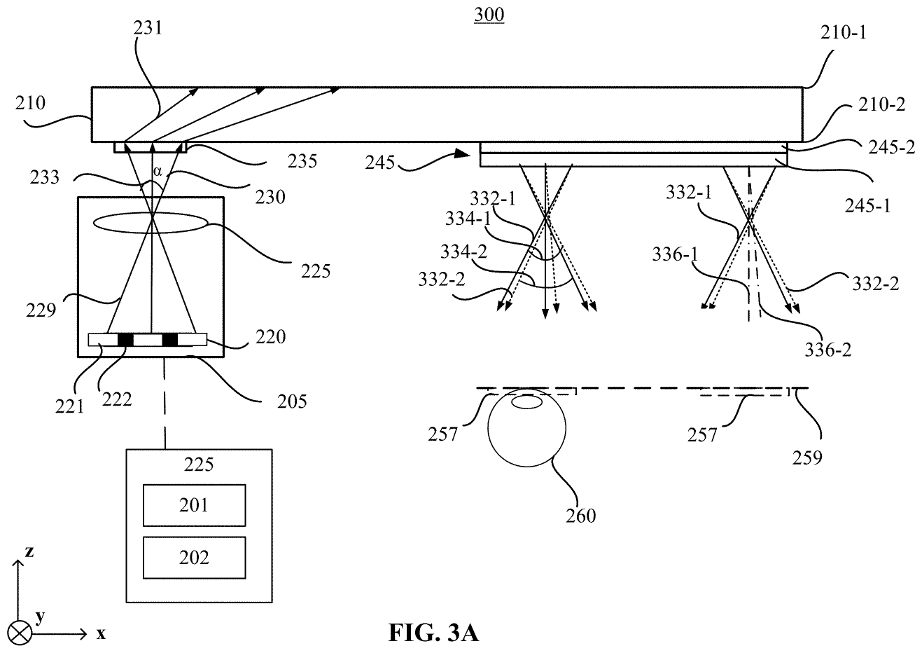

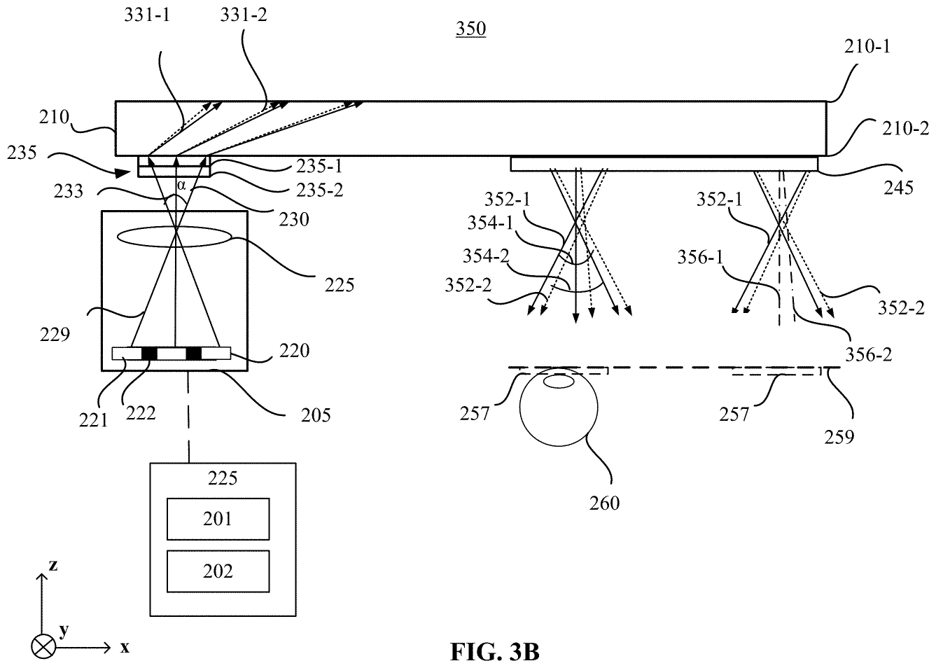

FIG. 3A illustrates a schematic diagram of a light guide display system or assembly 300 for providing an increased pixel density (pixel per degree), according to an embodiment of the present disclosure. The light guide display system 300 may include elements that are similar to or the same as those included in the light guide display system 200 shown in FIG. 2A, the light guide display system 250 shown in FIG. 2B, or the light guide display system 270 shown in FIGS. 2C-2E. Descriptions of the same or similar elements or features can refer to the above corresponding descriptions, including those rendered in connection with FIG. 2A, FIG. 2B, or FIGS. 2C-2E.

As shown in FIG. 3A, the light guide display system 300 may include an out-coupling element and an in-coupling element coupled with the light guide 210. For simplicity and convenience, the out-coupling element is labelled as 245, and the in-coupling element is labelled as 235, same as those shown in FIGS. 2A-2E. It is understood that although the same reference numerals for the in-coupling element and the out-coupling element are used in FIG. 3A and other figures, the in-coupling element and the out-coupling element in each embodiment may include different configurations, functions, shapes, sizes, other physical properties and/or optical properties.

In the embodiment shown in FIG. 3A, the out-coupling element 245 may include a plurality of out-coupling gratings 245-1 and 245-2, each of which may be an active grating that is controlled or switched, e.g., by the controller 215, between operating in a diffraction state to diffract an incident light, and operating in a non-diffraction state to transmit the incident light with substantially zero or negligible diffraction. The plurality of out-coupling gratings 245-1 and 245-2 may be stacked at the same surface of the light guide 210 or at different surfaces of the light guide 210. For discussion purposes, FIG. 3A shows that the first out-coupling grating 245-1 and the second out-coupling grating 245-2 are stacked at the second surface 210-2 of the light guide 210. The in-coupling element 235 may include an in-coupling grating (also referred to as 235).

In some embodiments, a display frame of the virtual image output from the display element 220 may be divided into a plurality of (e.g., two) sub-frames (sub-frames are example time periods). During the respective sub-frame, the controller 215 may control the light source assembly 205 to output the input image light 230 with the input FOV 233. The in-coupling grating 235 may be configured to couple the image light 230 into the light guide 210 as the in-coupled image light 231. During the respective sub-frame, the controller 125 may control one of the plurality of out-coupling gratings 245-1 and 245-2 to operate in the diffraction state, and the remaining one or more of the plurality of out-coupling gratings 245-1 and 245-2 to operate in the non-diffraction state. The first out-coupling grating 245-1 and the second out-coupling grating 245-2 may be configured (e.g., by configuring the grating periods, or modulations of the refractive indices, etc.), such that the first out-coupling grating 245-1 and the second out-coupling grating 245-2 operating in the diffraction state during different sub-frames may diffract the in-coupled image light 231 at different diffraction angles.

As shown in FIG. 3A, during the first sub-frame, the control 215 may control the first out-coupling grating 245-1 to operate in the diffraction state, and control the second out-coupling grating 245-2 to operate in the non-diffraction state. Thus, the second out-coupling grating 245-2 operating in the non-diffraction state may transmit the in-coupled image light 231 toward the first out-coupling grating 245-1, with substantially zero or negligible diffraction. The first out-coupling grating 245-1 may couple, via diffraction, the in-coupled image light 231 out of the light guide 210 as a plurality of first output image lights 332-1 towards the plurality of exit pupils 257. The rays of the first output image lights 332-1 are represented by solid lines. The plurality of first output image lights 332-1 may correspond to the plurality of exit pupils 257 on a one-to-one basis. Each of the first output image lights 332-1 may have a first output FOV 334-1 that may be substantially the same as the input FOV 233.

The diffraction state of the first out-coupling grating 245-1 may be configured (e.g., by configuring the grating period or the modulation of the refractive index of the first out-coupling grating 245-1), such that the first out-coupling grating 245-1 may diffract the in-coupled image light 231 as the first output image light 332-1, with the axis of symmetry 336-1 of the output FOV 334-1 perpendicular to the surface of the light guide 210. That is, the axis of symmetry 336-1 of the output FOV 334-1 of the first output image light 332-1 may be parallel with the surface normal of the light guide 210.

During the second sub-frame, the control 215 may control the first out-coupling grating 245-1 to operate in the non-diffraction state, and control the second out-coupling grating 245-2 to operate in the diffraction state. Thus, the out-coupling grating 245 may couple, via diffraction, the in-coupled image light 231 out of the light guide 210 as a plurality of second output image lights 332-2 toward the first out-coupling grating 245-1. The first out-coupling grating 245-1 operating in the non-diffraction state may transmit the plurality of second output image lights 332-2 towards the plurality of exit pupils 257, with substantially zero or negligible diffraction. The rays of the second output image lights 332-2 are represented by dashed lines. The plurality of second output image lights 332-2 may correspond to the plurality of exit pupils 257 on a one-to-one basis. Each of the second output image lights 332-2 may have a second output FOV 334-2 that may be substantially the same as the input FOV 233.

The diffraction state of the second out-coupling grating 245-2 may be configured (e.g., by configuring the grating period or the modulation of the refractive index of the second out-coupling grating 245-2), such that the second out-coupling grating 245-2 may diffract the in-coupled image light 231 as the second output image light 332-2, with the axis of symmetry 336-2 of the output FOV 334-2 being unparallel with the surface normal of the light guide 210.

Referring to FIG. 3A, the diffraction states of the first and second out-coupling grating 245-1 and 245-2 may be configured (e.g., by configuring the grating periods or the modulations of the refractive index of the first and second out-coupling grating 245-1 and 245-2), such that for the first output image light 332-1 and the second output image light 332-2 propagating toward the same exit pupil 257, the axis of symmetry 336-2 of the output FOV 334-2 of the second output image light 332-2 may be rotated with respective to the axis of symmetry 336-1 of the output FOV 334-1 of the first output image light 332-1 in a clockwise or counterclockwise direction. For discussion purposes, FIG. 3A shows that the axis of symmetry 336-2 of the output FOV 334-2 is rotated with respective to the axis of symmetry 336-1 of the output FOV 334-1 in the counter-clockwise direction.

For the first output image light 332-1 and the second output image light 332-2 propagating toward the same exit pupil 257, an angle representing the relative rotation between the axis of symmetry 336-1 and the axis of symmetry 336-2 may be smaller than the angular resolution of the eye 260 at the exit pupil 257. Thus, the angular separation between the axis of symmetry 336-1 and the axis of symmetry 336-2 may not be observable by the eye 160. In some embodiments, an angle representing the relative rotation between the axis of symmetry 336-1 and the axis of symmetry 336-2 may be smaller than the first predetermined percentage of the output FOV 334-1 or 334-2. The output FOV 334-1 of the first output image light 332-1 and the output FOV 334-2 of the second output image light 332-2 may have a substantially wide or large overlapping area (or overlapping FOV portion). In some embodiments, an angle representing the overlapping FOV portion may be greater than the second predetermined percentage of the output FOV 334-1 or 334-2, and smaller than the full output FOV 334-1 or 334-2.

Compared to the conventional light guided display system 100 shown in FIGS. 1A and 1B, the light guided display system 300 may provide an increased (e.g., doubled) number of image lights 332-1 and 332-2 with slightly shifted (e.g., tilted) output FOVs 334-1 and 334-2 propagating through the same exit pupil 257. Thus, output pixel density of the light guide display system 300 may be increased (e.g., doubled) as compared to the output pixel density of the conventional light guide display system 100 shown in FIGS. 1A and 1B. The output pixel density of the light guide display system 300 may be increased (e.g., doubled) as compared to the input pixel density at the input side of the light guide 210.

FIG. 3B illustrates a schematic diagram of a light guide display system or assembly 350 for providing an increased pixel density (pixel per degree), according to an embodiment of the present disclosure. The light guide display system 350 may include elements that are similar to or the same as those included in the light guide display system 200 shown in FIG. 2A, the light guide display system 250 shown in FIG. 2B, the light guide display system 270 shown in FIGS. 2C-2E, or the light guide display system 300 shown in FIG. 3A. Descriptions of the same or similar elements or features can refer to the above corresponding descriptions, including those rendered in connection with FIG. 2A, FIG. 2B, FIGS. 2C-2E, or FIG. 3A.

As shown in FIG. 3B, the light guide display system 300 may include an out-coupling element and an in-coupling element coupled with the light guide 210. For simplicity and convenience, the out-coupling element is labelled as 245, and the in-coupling element is labelled as 235, same as those shown in FIGS. 2A-2E and FIG. 3A. It is understood that although the same reference numerals for the in-coupling element and the out-coupling element are used in FIG. 3B and other figures, the in-coupling element and the out-coupling element in each embodiment may include different configurations, functions, shapes, sizes, other physical properties and/or optical properties.

In the embodiment shown in FIG. 3B, the in-coupling element 235 may include a plurality of in-coupling gratings, such as a first in-coupling grating 235-1 and a second in-coupling grating 235-2. Each of the first in-coupling grating 235-1 and the second in-coupling grating 235-2 may be an active grating that is controlled or switched by the controller 215 between operating in a diffraction state to diffract an incident light, and operating in a non-diffraction state to transmit the incident light with substantially zero or negligible diffraction. The in-coupling gratings 235-1 and 235-2 may be disposed in a stacked configuration at the same surface of the light guide 210 or at different surfaces of the light guide 210. For discussion purposes, FIG. 3B shows that the first in-coupling grating 235-1 and the second in-coupling grating 235-2 are stacked at the second surface 210-2 of the light guide 210.

In some embodiments, a display frame of the virtual image output from the display element 220 may be divided into a plurality of (e.g., two) sub-frames. During the respective sub-frame, the controller 215 may control the light source assembly 205 to output the input image light 230 with the input FOV 233. The controller 125 may also control one of the in-coupling gratings 235-1 and 235-2 to operate in the diffraction state, and the remaining of the in-coupling gratings 235-1 and 235-2 to operate in the non-diffraction state. When operating in the diffraction state, the first in-coupling grating 235-1 and the second in-coupling grating 235-2 may be configured (e.g., by configuring the grating periods, or modulations of the refractive indices, etc.,), such that the first in-coupling grating 235-1 and the second in-coupling grating 235-2 operating in the diffraction state may diffract the input image light 230 at different diffraction angles during different sub-subframes.

As shown in FIG. 3B, during the first sub-frame, the control 215 may control the first in-coupling grating 235-1 to operate in the diffraction state, and the second in-coupling grating 235-2 to operate in the non-diffraction state. Thus, the second in-coupling grating 235-2 operating in the non-diffraction state may transmit the input image light 230 toward the first out-coupling grating 245-1, with substantially zero or negligible diffraction. The first in-coupling grating 235-1 operating in the diffraction state may couple, via diffraction, the input image light 230 into the light guide 210 as a first in-coupled image light 331-1. The rays of the first in-coupled image light 331-1 are represented by solid lines. For example, the first in-coupling grating 235-1 may diffract the central ray of the input image light 230 as a central ray of the first in-coupled image light 331-1 with a first TIR propagating angle inside the light guide 210.

The out-coupling grating 245 may couple, via diffraction, the first in-coupled image light 331-1 out of the light guide 210 as a plurality of first output image lights 352-1 towards the plurality of exit pupils 257. The first output image lights 352-1 are represented by solid lines. The first output image lights 352-1 may correspond to the plurality of exit pupils 257 on a one-to-one basis. Each of the first output image lights 352-1 may have a first output FOV 354-1 that may be substantially the same as the input FOV 233.

The diffraction state of the first in-coupling grating 235-1 may be configured (e.g., by configuring the grating period or the modulation of the refractive index of the first in-coupling grating 235-1), such that the out-coupling grating 245 may diffract the first in-coupled image light 331-1 as the first output image light 352-1, with an axis of symmetry 356-1 of the output FOV 354-1 being perpendicular to the surface of the light guide 210. That is, the axis of symmetry 356-1 of the output FOV 354-1 of the first output image light 352-1 may be parallel with the surface normal of the light guide 210.

During the second sub-frame, the control 215 may control the first in-coupling grating 235-1 to operate in the non-diffraction state, and the second in-coupling grating 235-2 to operate in the diffraction state. Thus, the second in-coupling grating 235-2 may couple, via diffraction, the input image light 230 into the light guide 210 as a second in-coupled image light 331-2. The first in-coupling grating 235-1 operating in the non-diffraction state may transmit the second in-coupled image light 331-2, with substantially zero or negligible diffraction. The rays of the second in-coupled image light 331-2 are represented by dashed lines. The second in-coupling grating 235-2 may diffract the central ray of the input image light 230 as a central ray of the second in-coupled image light 331-2 with a second TIR propagating angle inside the light guide 210. The second TIR propagating angle may be different from the first TIR propagating angle.

The out-coupling grating 245 may couple, via diffraction, the second in-coupled image light 331-2 out of the light guide 210 as a plurality of second output image lights 352-2 towards the plurality of exit pupils 257. The second output image lights 352-2 are represented by dashed lines. The plurality of second output image lights 352-2 may one-to-one correspond to the plurality of exit pupils 257. Each of the second output image lights 352-2 may have a second output FOV 354-2 that is substantially the same as the input FOV 233.

The diffraction state of the second in-coupling grating 235-2 may be configured (e.g., by configuring the grating period or the modulation of the refractive index of the second in-coupling grating 235-2), such that the out-coupling grating 245 may diffract the second in-coupled image light 331-2 as the second output image light 352-2, with an axis of symmetry 356-2 of the output FOV 354-2 being unparallel with the surface normal of the light guide 210.

Referring to FIG. 3B, the diffraction states of the first and second in-coupling grating 235-1 and 235-2 may be configured such that for the first output image light 352-1 and the second output image light 352-2, an angle representing the relative rotation between the axis of symmetry 356-1 and the axis of symmetry 356-2 may be smaller than the angular resolution of the eye 260 at the exit pupil 257. Thus, the angular separation between the axis of symmetry 356-1 and the axis of symmetry 356-2 may not be observable by the eye 260. In some embodiments, an angle representing the relative rotation between the axis of symmetry 356-1 and the axis of symmetry 356-2 may be smaller than the first predetermined percentage of the output FOV 354-1 or 354-2. The output FOV 354-1 of the first output image light 352-1 and the output FOV 354-2 of the second output image light 352-2 may have a substantially wide or large overlapping area (or overlapping FOV portion). In some embodiments, an angle representing the overlapping FOV portion may be greater than the second predetermined percentage of the output FOV 354-1 or 354-2, and smaller than the full output FOV 354-1 or 354-2.

Compared to the conventional light guided display system 100 shown in FIGS. 1A and 1B, the light guided display system 350 may provide an increased (e.g., doubled) number of image lights 352-1 and 352-2 with slightly shifted output FOVs 354-1 and 354-2 propagating through the same exit pupil 257. Thus, the output pixel density of the light guide display system 350 may be increased (e.g., doubled) as compared to the output pixel density of the conventional light guide display system 100 shown in FIGS. 1A and 1B. The output pixel density of the light guide display system 350 may be increased (e.g., doubled) as compared to the input pixel density at the input side of the light guide 210.

In some embodiments, although not shown, a light guide display system may include a plurality of in-coupling gratings and a plurality of out-coupling gratings. For example, in an embodiment, the out-coupling gratings 245-1 and 245-2 in the light guide display system 300 shown in FIG. 3A and the in-coupling gratings 235-1 and 235-2 in the light guide display system 350 shown in FIG. 3B may be included in a single light guide display system. The display frame of the virtual image output from the display element 220 may be divided into four sub-frames. During the respective sub-frame, the controller 125 may control one of the out-coupling gratings 245-1 and 245-2 and one of the in-coupling gratings 235-1 and 235-2 to operate in the diffraction state, and configure the remaining in-coupling and out-coupling gratings to operate in the non-diffraction state.

Compared to the conventional light guided display system 100 shown in FIGS. 1A and 1B, a light guided display system of the present disclosure may provide an increased (e.g., quadrupled) number of image lights with slightly shifted output FOVs propagating through the same exit pupil 257. Thus, the output pixel density of the disclosed light guide display system may be increased (e.g., quadrupled) as compared to the output pixel density of the conventional light guide display system 100 shown in FIGS. 1A and 1B. The output pixel density of the disclosed light guide display system may be increased (e.g., quadrupled) as compared to the input pixel density at the input side of the light guide 210.

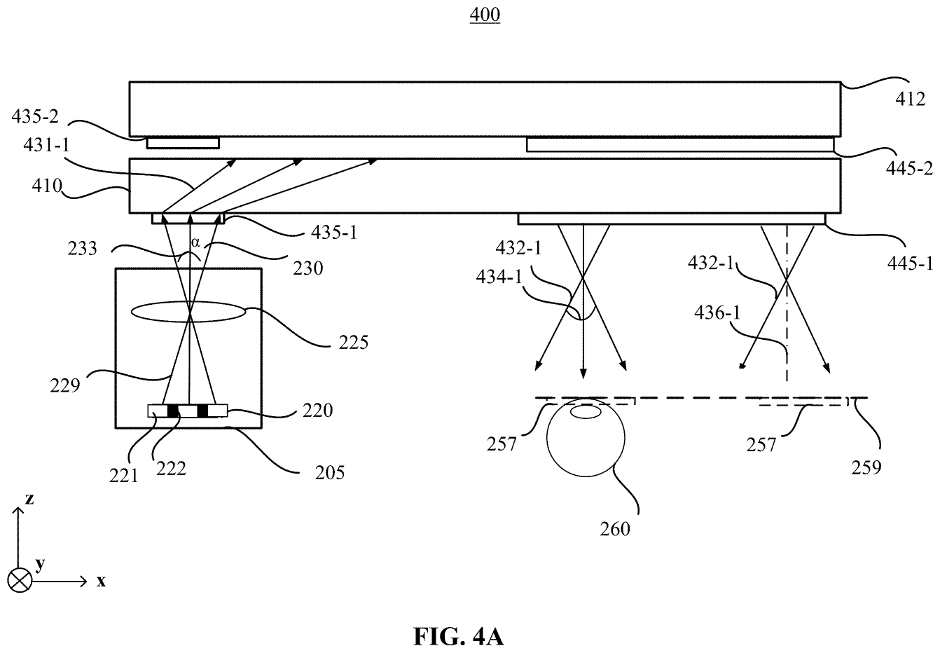

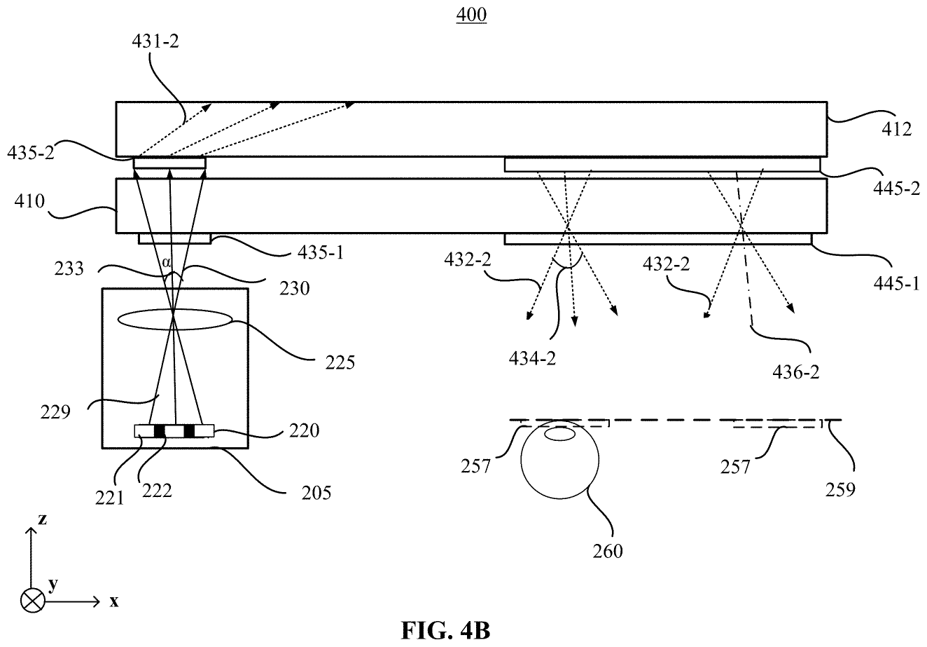

FIGS. 4A and 4B illustrate schematic diagrams of a light guide display system or assembly 400 for providing an increased pixel density (pixel per degree), according to an embodiment of the present disclosure. The light guide display system 400 may include elements that are similar to or the same as those included in the light guide display system 200 shown in FIG. 2A, the light guide display system 250 shown in FIG. 2B, the light guide display system 270 shown in FIGS. 2C-2E, the light guide display system 300 shown in FIG. 3A, or the light guide display system 350 shown in FIG. 3B. Descriptions of the same or similar elements or features can refer to the above corresponding descriptions, including those rendered in connection with FIG. 2A, FIG. 2B, FIGS. 2C-2E, FIG. 3A, or FIG. 3B.

As shown in FIG. 4A, the light guide display system 400 may include a plurality of light guides 410 and 412 stacked together, each of which may be coupled with an in-coupling element and an out-coupling element. For illustrative purposes, two light guides 410 and 412 are shown in FIG. 4A. Other suitable number of light guides may be included, such as three, four, five, six, etc. In some embodiments, for a wave guiding to take place in the light guides, the light guides 410 and 412 may be separated by air gaps. In some embodiments, the air gaps between the neighboring light guides 410 and 412 may be at least partially filled with a material (e.g., a liquid glue) having a refractive index lower than that of the light guides 410 and 412. The light guide 410 or 412 may be coupled with an in-coupling element 435-1 or 435-2 and an out-coupling element 445-1 or 445-2.

The in-coupling element 435-1 or 435-2 may include one or more in-coupling gratings, and the out-coupling element 445-1 or 445-2 may include one or more out-coupling gratings. For discussion purposes, FIG. 4A shows that the in-coupling element 435-1 or 435-2 may include an in-coupling grating (also referred to as 435-1 or 435-2 for discussion purposes), and the out-coupling element 445-1 or 445-2 may include an out-coupling grating (also referred to as 445-1 or 445-2 for discussion purposes). At least one (e.g., each) of the in-coupling grating 435-1, the in-coupling grating 435-2, the out-coupling grating 445-1, and the out-coupling grating 445-2 may be an active grating, which may be controlled or switched by the controller 215 between operating in a diffraction state to diffract an incident light, and operating in a non-diffraction state to transmit the incident light with substantially zero or negligible diffraction.

In some embodiments, at least one of the pair of the in-coupling gratings 435-1 and 435-2 or the pair of the out-coupling gratings 445-1 and 445-2 may be configured to diffract an incident light with a fixed incidence angle at different diffraction angles. For example, the in-coupling gratings 435-1 and 435-2 may be configured with different grating periods, and/or different modulations of refractive index, etc., thereby diffracting an incident light with a fixed incidence angle to different diffraction angles. The out-coupling gratings 445-1 and 445-2 may be configured with different grating periods, and/or different modulations of refractive index, etc., thereby diffracting an incident light with a fixed incidence angle to different diffraction angles.

For discussion purposes, in the embodiment shown in FIG. 4A, all of the in-coupling gratings 435-1, 435-2, the out-coupling gratings 445-1, 445-2 may be active gratings. For discussion purposes, the in-coupling gratings 435-1 and 435-2 operating in the diffraction state may be configured to diffract an incident light with a fixed incidence angle at the same diffraction angle. For example, the in-coupling gratings 435-1 and 435-2 may be configured with the same grating period, and/or the same modulation of the refractive index, etc. For discussion purposes, the out-coupling gratings 445-1 and 445-2 operating in the diffraction state may be configured to diffract an incident light with a fixed incidence angle at different diffraction angles. For example, the out-coupling gratings 445-1 and 445-2 may be configured with different grating periods, and/or different modulations of the refractive index, etc.

In some embodiments, a display frame of the virtual image output from the display element 220 may be divided into a plurality of (e.g., two) sub-frames (sub-frames are example time periods). FIG. 4A illustrates an x-z sectional view of the light guide display system 400 during a first sub-frame. As shown in FIG. 4A, during the first sub-frame, the controller 215 may control the light source assembly 205 to output the input image light 230 with the input FOV 233. The control 215 may control the in-coupling grating 435-1 and the out-coupling gratings 445-1 coupled with the light guide 410 to operate in the diffraction state, and control the in-coupling grating 435-2 and the out-coupling gratings 445-2 coupled with the light guide 412 to operate in the non-diffraction state. Thus, the in-coupling grating 435-1 may couple, via diffraction, the input image light 230 into the light guide 410 as a first in-coupled image light 431-1 with a first TIR propagating angle. The rays of the first in-coupled image light 431-1 are represented by solid lines. For example, the in-coupling grating 435-1 may diffract the central ray of the input image light 230 as a central ray of the first in-coupled image light 431-1 with a first TIR propagating angle inside the light guide 410.

The out-coupling grating 445-1 may couple, via diffraction, the first in-coupled image light 431-1 out of the light guide 410 as a plurality of first output image lights 432-1 towards the plurality of exit pupils 257. The rays of the first output image lights 432-1 are represented by solid lines. The plurality of first output image lights 432-1 may one-to-one correspond to the plurality of exit pupils 257. Each of the first output image lights 432-1 may have a first output FOV 434-1 that is substantially the same as the input FOV 233.

The diffraction state of the out-coupling grating 445-1 may be configured (e.g., the grating period or the modulation of the refractive index of the out-coupling grating 445-1 may be configured), such that the out-coupling grating 445-1 may diffract the first in-coupled image light 431-1 as the first output image light 452-1, with an axis of symmetry 456-1 of the output FOV 454-1 perpendicular to the surface of the light guide 210. That is, the axis of symmetry 456-1 of the output FOV 454-1 of the first output image light 452-1 may be parallel with the surface normal of the light guide 410.

FIG. 4B illustrates an x-z sectional view of the light guide display system 400 during a second sub-frame. As shown in FIG. 4B, during the second sub-frame, the controller 215 may control the light source assembly 205 to output the input image light 230 with the input FOV 233. The control 215 may control the in-coupling grating 435-1 and the out-coupling gratings 445-1 coupled with the light guide 410 to operate in the non-diffraction state. The controller 215 may control the in-coupling grating 435-2 and the out-coupling gratings 445-2 coupled with the light guide 412 to operate in the diffraction state. Thus, the in-coupling grating 435-1 operating in the non-diffraction state may transmit the input image light 230 toward the light guide 410 and the light guide 412, with substantially zero or negligible diffraction. The in-coupling grating 435-2 operating in the diffraction state may couple, via diffraction, the input image light 230 into the light guide 412 as a second in-coupled image light 431-2. The rays of the second in-coupled image light 431-2 are represented by dashed lines. The in-coupling grating 435-2 may diffract the central ray of the input image light 430 as a central ray of the second in-coupled image light 431-2 with a second TIR propagating angle inside the light guide 412. As the in-coupling gratings 435-1 and 435-2 operating in the diffraction state are configured to diffract the incident light with the same incidence angle at the same diffraction angle, the second TIR propagating angle of the central ray of the second in-coupled image light 431-2 in the light guide 412 during the second sub-frame may be the same as the first TIR propagating angle of the central ray of the first in-coupled image light 431-1 in the light guide 410 during the first sub-frame.

The out-coupling grating 445-2 operating in the diffraction state may couple, via diffraction, the second in-coupled image light 431-2 out of the light guide 412 as a plurality of second output image lights 432-2 toward the light guide 310 and the out-coupling grating 445-1. The rays of the second output image lights 432-2 are represented by dashed lines. The out-coupling grating 445-1 operating in the non-diffraction state may transmit the second output image lights 432-2 towards the plurality of exit pupils 257, with substantially zero or negligible diffraction. The second output image lights 432-2 may correspond to the plurality of exit pupils 257 on a one-to-one basis. Each of the second output image lights 432-2 may have a second output FOV 434-2 that may be substantially the same as the input FOV 233.

The diffraction state of the out-coupling grating 445-2 may be configured (e.g., by configuring the grating period or the modulation of the refractive index of the out-coupling grating 445-2), such that the out-coupling grating 445-2 may diffract the second in-coupled image light 431-2 as the second output image light 452-2, with an axis of symmetry 456-2 of the output FOV 454-2 being unparallel with the surface normal of the light guide 410.

Referring to FIGS. 4A and 4B, the out-coupling gratings 445-1 and 445-2 may be configured (e.g., by configuring the grating periods or the modulations of the refractive index of the out-coupling gratings 445-1 and 445-2), such that for the first output image light 432-1 and the second output image light 432-2 propagating toward the same exit pupil 257, the axis of symmetry 436-2 of the output FOV 434-2 of the second output image light 432-2 may be rotated with respective to the axis of symmetry 436-1 of the output FOV 434-1 of the first output image light 432-1 in a clockwise or counterclockwise direction. For discussion purposes, FIGS. 4A and 4B show that the axis of symmetry 436-2 of the output FOV 434-2 is rotated with respective to the axis of symmetry 436-1 of the output FOV 434-1 in the counter-clockwise direction.

For the first output image light 432-1 and the second output image light 432-2 propagating toward the same exit pupil 257, an angle representing the relative rotation between the axis of symmetry 436-1 and the axis of symmetry 436-2 may be smaller than the angular resolution of the eye 260 at the exit pupil 257. Thus, the angular separation between the axis of symmetry 436-1 and the axis of symmetry 436-2 may not be observable by the eye 260. In some embodiments, an angle representing the relative rotation between the axis of symmetry 436-1 and the axis of symmetry 436-2 may be smaller than the first predetermined percentage of the output FOV 434-1 or 434-2. The output FOV 434-1 of the first output image light 432-1 and the output FOV 434-2 of the second output image light 432-2 may have a substantially wide or large overlapping area (or overlapping FOV portion). In some embodiments, an angle representing the overlapping FOV portion may be greater than the second predetermined percentage of the output FOV 434-1 or 434-2, and smaller than the full output FOV 434-1 or 434-2.

Compared to the conventional light guided display system 100 shown in FIGS. 1A and 1B, the light guided display system 400 may provide an increased (e.g., doubled) number of image lights 432-1 and 432-2 with slightly shifted output FOVs 434-1 and 434-2 propagating through the same exit pupil 257. Thus, the output pixel density of the light guide display system 400 may be increased (e.g., doubled) as compared to the output pixel density of the conventional light guide display system 100 shown in FIGS. 1A and 1B. The output pixel density of the light guide display system 400 may be increased (e.g., doubled) as compared to the input pixel density at the input side of the light guide 410 or 412. The

In some embodiments, although not shown, the in-coupling gratings 435-1 and 435-2 operating in the diffraction state may be configured to diffract the incident light with a same incident angle at different diffraction angles. The out-coupling gratings 445-1 and 445-2 operating in the diffraction state may be configured to diffract the incident light with a same incident angle at the same diffraction angle. Thus, the first TIR propagating angle of the central ray of the first in-coupled image light 432-1 in the light guide 410 during the first sub-frame may be different from the second TIR propagating angle of the central ray of the second in-coupled image light 432-2 in the light guide 412 during the second sub-frame. Thus, for the first output image light 432-1 and the second output image light 432-2 propagating toward the same exit pupil, the axis of symmetry 436-2 of the second output FOV 434-2 of the second output image light 432-2 may also be rotated with respective to the axis of symmetry 436-1 of the first output FOV 434-1 of the first output image light 432-1 in a clockwise or counter-clockwise direction. The angle representing the relative rotation between the axis of symmetry 436-1 and the axis of symmetry 436-2 may be smaller than the angular resolution of the eye 260 at the exit pupil 257. Thus, the light guide display system may provide an increased (e.g., doubled) pixel density (pixel per degree) at the output side, as compared to the conventional light guide display system 100 shown in FIGS. 1A and 1B.

In some embodiments, although not shown, the in-coupling gratings 435-1 and 435-2 operating in the diffraction state may be configured to diffract the incident light with a same incident angle at different diffraction angles. The out-coupling gratings 445-1 and 445-2 operating in the diffraction state may be configured to diffract the incident light with a same incident angle at different diffraction angles. The display frame of the virtual image output from the display element 220 may be divided into four sub-frames. Compared to the conventional light guided display system 100 shown in FIGS. 1A and 1B, a light guided display system of the present disclosure may provide an increased (e.g., quadrupled) number of image lights with slightly shifted output FOVs propagating through the same exit pupil 257. Thus, the output pixel density of the disclosed light guide display system may be increased (e.g., quadrupled) as compared to the output pixel density of the conventional light guide display system 100 shown in FIGS. 1A and 1B.

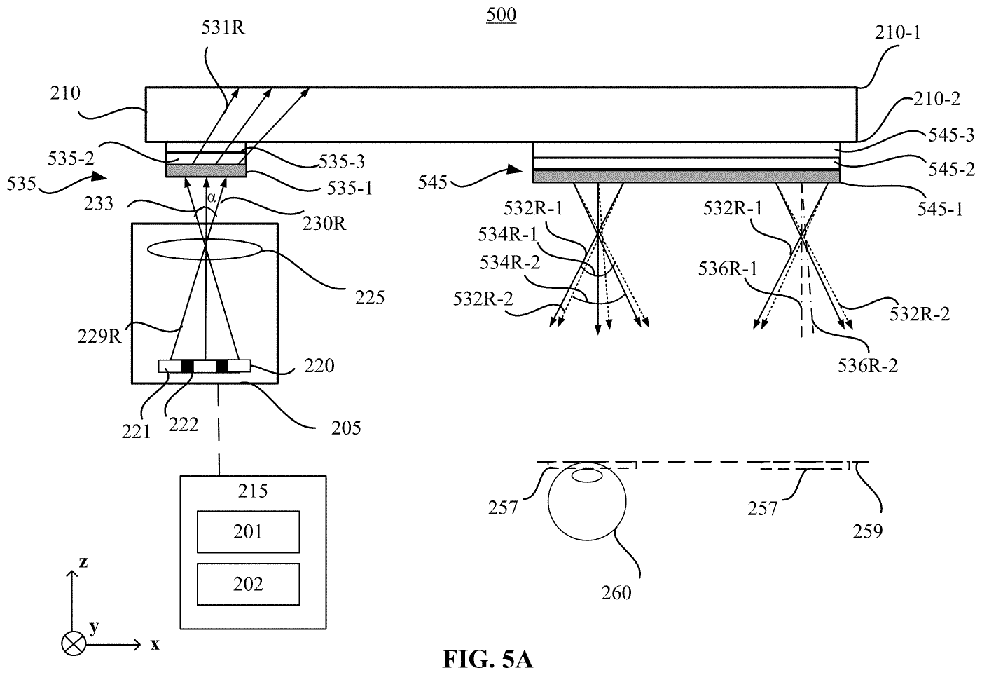

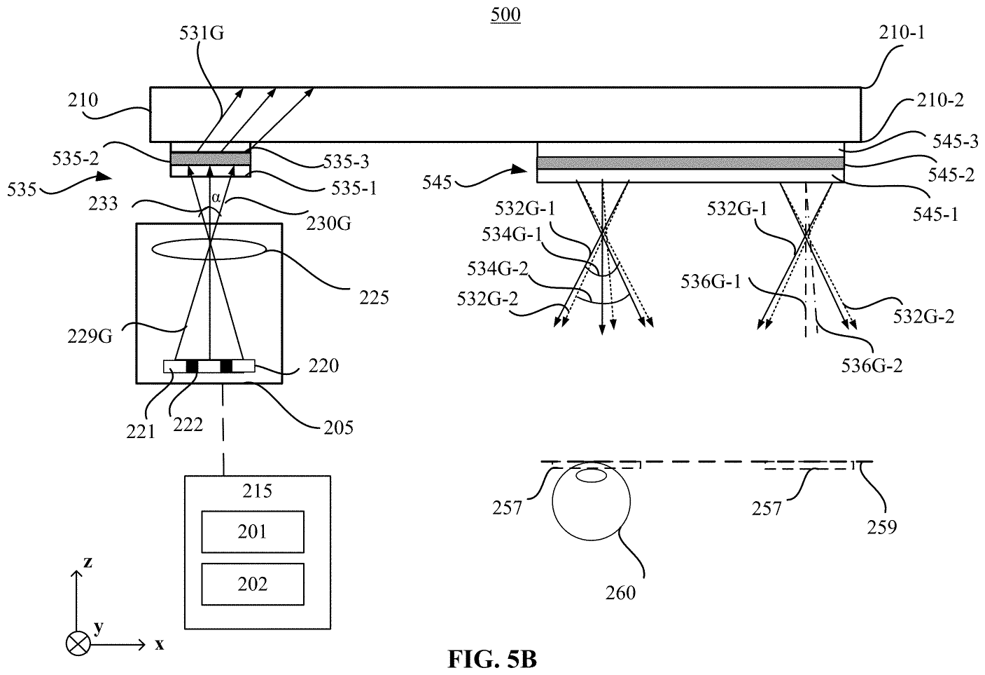

FIGS. 5A-5C illustrate schematic diagrams of a light guide display system or assembly 500 for providing an increased pixel density (pixel per degree), according to an embodiment of the present disclosure. The light guide display system 500 may be configured to deliver single-color images of different colors in a time-multiplexing manner. The light guide display system 500 may be configured to deliver a polychromatic image (e.g., a full-color image) with an increased pixel density to the eye-box region 259. The light guide display system 500 may include elements that are similar to or the same as those included in the light guide display system 200 shown in FIG. 2A, the light guide display system 250 shown in FIG. 2B, the light guide display system 270 shown in FIGS. 2C-2E, the light guide display system 300 shown in FIG. 3A, the light guide display system 350 shown in FIG. 3B, or the light guide display system 400 shown in FIGS. 4A and 4B. Descriptions of the same or similar elements or features can refer to the above corresponding descriptions, including those rendered in connection with FIG. 2A, FIG. 2B, FIGS. 2C-2E, FIG. 3A, FIG. 3B, or FIGS. 4A and 4B.

As shown in FIG. 5A, the light guide display system 500 may include the light guide 210 coupled with an in-coupling element 535 and an out-coupling element 545. The in-coupling element 535 may include three in-coupling gratings 535-1, 535-2, and 535-3, which may be disposed in a stacked configuration at the same surface or different surfaces of the light guide 210. The out-coupling element 545 may include three out-coupling gratings 545-1, 545-2, and 545-3, which may be disposed in a stacked configuration at the same surface or different surfaces of the light guide 210. For discussion purposes, FIG. 5A show that the in-coupling gratings 535-1, 535-2, and 535-3 are stacked at the second surface 210-2 of the light guide 210, and the out-coupling gratings 545-1, 545-2, and 545-3 are stacked at the second surface 210-2 of the light guide 210.

The in-coupling gratings 535-1, 535-2, and 535-3 and the out-coupling gratings 545-1, 545-2, and 545-3 may be configured for different operation wavelength ranges. That is, the in-coupling gratings 535-1, 535-2, and 535-3 and the out-coupling gratings 545-1, 545-2, and 545-3 may diffract lights having wavelengths within different wavelength ranges. In some embodiments, the in-coupling gratings 535-1, 535-2, and 535-3 and the out-coupling gratings 545-1, 545-2, and 545-3 may be PVH gratings configured for different operation wavelength ranges. For example, the in-coupling grating 535-1 and the out-coupling grating 545-1 may be configured for a wavelength range corresponding to a first primary color (e.g., red). The in-coupling grating 535-2 and the out-coupling grating 545-2 may be configured for a wavelength range corresponding to a second primary color (e.g., green). The in-coupling grating 535-3 and the out-coupling grating 545-3 may be configured for a wavelength range corresponding to a third primary color (e.g., blue). Each of the in-coupling gratings 535-1, 535-2, and 535-3 and out-the coupling gratings 545-1, 545-2, and 545-3 may diffract an incident light of a corresponding wavelength range, and transmit an incident light outside of the corresponding wavelength range with negligible or zero diffraction.

At least one of the group of the in-coupling gratings 535-1, 535-2, and 535-3 or the group of the out-coupling gratings 545-1, 545-2, and 545-3 may be a group having all (three) active gratings. In some embodiments, the active grating may be controlled by the controller 215 to operate in different diffraction states by providing different driving voltages to the active grating. The active grating operating in different diffraction states may diffract the incident light associated with a fixed incidence angle at different diffraction angles. For discussion purposes, the out-coupling gratings 545-1, 545-2, and 545-3 are presumed to be active gratings, and the in-coupling gratings 535-1, 545-2, and 535-3 are presumed to be passive gratings, although the in-coupling gratings 535-1, 545-2, and 535-3 may also be active gratings in some embodiments. Each of the out-coupling gratings 545-1, 545-2, and 545-3 may provide a tunable diffraction angle to an incident light of the respective primary color. The diffraction angles provided by the out-coupling gratings 545-1, 545-2, and 545-3 may be tuned by changing the applied driving voltage.

In some embodiments, a display frame of a polychromatic image generated by the light source assembly 205 may include six sub-frames. The polychromatic image may be a virtual image. The polychromatic image may be separated into a plurality of single-color images. The controller 215 may control the display element 220 to display single-color images of different primary colors (e.g., red (“R”), green (“G”), and blue (“B”)) in a time-multiplexing manner (e.g., in consecutive sub-frames).

FIG. 5A illustrates an x-z sectional view of the light guide display system 500 that operates during a first sub-frame and a second sub-frame of the display frame of a polychromatic image generated by the light source assembly 205. As shown in FIG. 5A, during the first sub-frame and the second sub-frame, the controller 215 may control the display element 220 to display a single-color image of red color. For example, the display element 220 may output an image light 229R representing the single-color image of red color, and the collimating lens 225 may convert the image light 229R to an input image light 230R with the input FOV 233 (e.g., a). The in-coupling grating 535-1 may be configured to couple the input image light 230R into the light guide 210 as an in-coupled image light 531R inside the light guide 210. The rays of the in-coupled image light 531R are represented by solid lines. For example, the in-coupling grating 535-1 may diffract the central ray of the input image light 230R as a central ray of the in-coupled image light 531R with a first TIR propagating angle inside the light guide 210.

During the first sub-frame and the second sub-frame, the control 215 may control the out-coupling grating 545-1 to operate in two diffraction states to diffract the same in-coupled image light 531R at different diffraction angles. For example, during the first sub-frame, the control 215 may control the out-coupling grating 545-1 to operate in a first diffraction state (e.g., at a first driving voltage) to couple, via diffraction, the in-coupled image light 531R out of the light guide 210 as a plurality of output image lights 532R-1 towards the plurality of exit pupils 257. The rays of the output image lights 532R-1 are represented by solid lines. The plurality of output image lights 532R-1 may correspond to the plurality of exit pupils 257 on a one-to-one basis. Each of the output image lights 532R-1 may have an output FOV 534R-1 that may be substantially the same as the input FOV 233.

The first diffraction state of the out-coupling grating 545-1 may be configured (e.g., by configuring the grating period or the modulation of the refractive index of the out-coupling grating 545-1), such that the out-coupling grating 545-1 may diffract the in-coupled image light 531R as the first output image light 532R-1, with the axis of symmetry 536R-1 of the output FOV 534R-1 perpendicular to the surface of the light guide 210. That is, the axis of symmetry 536R-1 of the output FOV 534R-1 of the first output image light 532R-1 may be parallel with the surface normal of the light guide 210.

During the second sub-frame, the control 215 may control the out-coupling grating 545-1 to operate in a second diffraction state by controlling the driving voltage applied to the out-coupling grating 545-1 to be a second driving voltage. The out-coupling grating 545-1 may couple, via diffraction, the in-coupled image light 531R out of the light guide 210 as a plurality of output image lights 532R-2 towards the plurality of exit pupils 257. The rays of the output image lights 532R-2 are represented by dashed lines. The plurality of output image lights 532R-2 may correspond to the plurality of exit pupils 257 on a one-to-one basis. Each of the output image lights 532R-2 may have the output FOV 534R-2 that may be substantially the same as the input FOV 233. The second diffraction state of the out-coupling grating 545-1 may be configured (e.g., by configuring the grating period or the modulation of the refractive index of the out-coupling grating 545-1), such that the out-coupling grating 545-1 may diffract the in-coupled image light 531R as the second output image light 532R-2, with the axis of symmetry 536R-2 of the output FOV 534R-2 being unparallel with the surface normal of the light guide 210.

Referring to FIG. 5A, the first and second diffraction states of the out-coupling grating 545-1 may be configured (e.g., by configuring the grating periods or the modulations of the refractive index of the out-coupling grating 545-1), such that for the output image light 532R-2 and the output image light 532R-1 propagating toward the same exit pupil 257, the axis of symmetry 536R-2 of the output FOV 534R-2 of the output image light 532R-2 may be rotated with respective to the axis of symmetry 536R-1 of the output FOV 534R-1 of the output image light 532R-1 in a clockwise or counter-clockwise direction. For discussion purposes, FIG. 5A shows that the axis of symmetry 536R-2 is rotated with respective to the axis of symmetry 536R-1 in the counter-clockwise direction. An angle representing the relative rotation between the axis of symmetry 536R-1 and the axis of symmetry 536R-2 may be smaller than the angular resolution of the eye 260 at the exit pupil 257.

FIG. 5B illustrates an x-z sectional view of the light guide display system 500 that operates during a third sub-frame and a fourth sub-frame of the display frame of a polychromatic image generated by the light source assembly 205. As shown in FIG. 5B, during the third sub-frame and the fourth sub-frame, the controller 215 may control the display element 220 to display a single-color image of green color. The display element 220 may output an image light 229G representing the single-color image of green color, and the collimating lens 225 may convert the image light 229G into an input image light 230G with the input FOV 233. The in-coupling grating 535-2 may be configured to couple the input image light 230G into the light guide 210 as an in-coupled image light 531G. For example, the in-coupling grating 535-2 may diffract the central ray of the input image light 230G as a central ray of the in-coupled image light 531G with a second TIR propagating angle inside the light guide 210. In the disclosed embodiments, the in-coupling gratings 535-1 and 535-2 may be configured, such that the second TIR propagating angle of the in-coupled image light 531G may be the same as the first TIR propagating angle of the in-coupled image light 531R shown in FIG. 5A.

During the third sub-frame and the fourth sub-frame, the control 215 may control the out-coupling grating 545-2 to operate in two diffraction states to diffract the same in-coupled image light 531G at different diffraction angles. For example, during the third sub-frame, the control 215 may control the out-coupling grating 545-2 to operate a third diffraction state (e.g., at a third driving voltage) to couple, via diffraction, the in-coupled image light 531G out of the light guide 210 as a plurality of output image lights 532G-1 towards the plurality of exit pupils 257. The rays of the output image lights 532G-1 are represented by solid lines. In the disclosed embodiments, the out-coupling gratings 545-1 and 545-2 may be configured, such that the respective output image lights 532G-1 may substantially overlap with the respective output image lights 532R-1 shown in FIG. 5A. During the fourth sub-frame, the control 215 may control the out-coupling grating 545-2 to operate in a fourth diffraction state (e.g., at a fourth driving voltage) to couple, via diffraction, the in-coupled image light 531G out of the light guide 210 as a plurality of output image lights 532G-2 towards the plurality of exit pupils 257. The rays of the output image lights 532G-2 are represented by dashed lines. In the disclosed embodiments, the out-coupling gratings 545-1 and 545-2 may be controlled, such that respective output image lights 532G-2 may substantially overlap with the respective output image lights 532R-2 shown in FIG. 5A.

FIB. 5C illustrates an x-z sectional view of the light guide display system 500 that operates during a fifth sub-frame and a sixth sub-frame of the display frame of a polychromatic image generated by the light source assembly 205. As shown in FIB. 5C, during the fifth sub-frame and the sixth sub-frame, the controller 215 may control the display element 220 to display a single-color image of blue color. The display element 220 may output an image light 229B representing the single-color image of blue color, and the collimating lens 225 may convert the image light 229B to an input image light 230B with the input FOV 233. The in-coupling grating 535-3 may be configured to couple the input image light 230B into the light guide 210 as an in-coupled image light 531B inside the light guide 210. For example, the in-coupling grating 535-3 may diffract the central ray of the input image light 230G as a central ray of the in-coupled image light 531G with a third TIR propagating angle inside the light guide 210. In the disclosed embodiments, the in-coupling gratings 535-1 and 535-3 may be configured, such that the third TIR propagating angle of the in-coupled image light 531B may be the same as the first TIR propagating angle of the in-coupled image light 531R shown in FIG. 5A.

During the fifth sub-frame and the sixth sub-frame, the control 215 may control the out-coupling grating 545-3 to operate in two diffraction states to provide different diffraction angles to the same in-coupled image light 531B. For example, during the fifth sub-frame, the control 215 may control the driving voltage of the out-coupling grating 545-3 to be a fifth driving voltage, such that the out-coupling grating 545-3 may operate in a fifth diffraction state to couple, via diffraction, the in-coupled image light 531B out of the light guide 210 as a plurality of output image lights 532B-1 towards the plurality of exit pupils 257. The rays of the output image lights 532B-1 are represented by solid lines. In the disclosed embodiments, the out-coupling gratings 545-1 and 545-3 may be configured, such that the respective output image lights 532B-1 may substantially overlap with the respective output image lights 532R-1 shown in FIG. 5A.

During the sixth sub-frame, the control 215 may control the driving voltage of the out-coupling grating 545-3 to be a sixth driving voltage, such that the out-coupling grating 545-3 may operate in a sixth diffraction state to couple, via diffraction, the in-coupled image light 531B out of the light guide 210 as a plurality of output image lights 532B-2 towards the plurality of exit pupils 257. The rays of the output image lights 532B-2 are represented by dashed lines. In the disclosed embodiments, the out-coupling gratings 545-1 and 545-3 may be configured, such that the respective output image lights 532B-2 may substantially overlap with the respective output image lights 532R-2 shown in FIG. 5A.

Referring to FIGS. 5A-5C, during the entire display frame from the first sub-frame to the sixth sub-frame, the light guide display system 500 may provide a sequential transmission of image lights of different colors (e.g., blue, green, red) and an increased pixel density. A final image may be perceived by the eye 260 as a polychromatic image with an increased (e.g., doubled) pixel density. In some embodiments, the operation wavelength spectra of the in-coupling gratings 535-1, 535-2, and 535-3 may be configured to be substantially non-overlapping with one another, and the operation wavelength spectra of the out-coupling gratings 545-1, 545-2, and 545-3 may be configured to be substantially non-overlapping with one another. Thus, the crosstalk between the in-coupling gratings 535-1, 535-2, and 535-3, and the crosstalk between the out-coupling gratings 545-1, 545-2, and 545-3 may be reduced. That is, in some embodiments, the in-coupling gratings 535-1, 535-2, and 535-3 and the out-coupling gratings 545-1, 545-2, and 545-3 may each have a predetermined wavelength selectivity, e.g., each grating may diffract an incident light within a predetermined wavelength band or range and transmit input lights outside of the predetermined wavelength band with substantially zero or negligible diffraction. For example, each of the in-coupling gratings 535-1, 535-2, and 535-3 and the out-coupling gratings 545-1, 545-2, and 545-3 may be fabricated to operate in a Bragg regime to have a predetermined wavelength selectivity.

FIGS. 2A-5C illustrate the principle for providing an increased output pixel density. For example, the output pixel density at the output side of the light guide display system may be at least two times of the input pixel density at the input side of the light guide display system. The principle is described using doubling the output pixel density as an example. The same principle may be applied to tripling, quadrupling, etc., the output pixel density of the light guide display system.

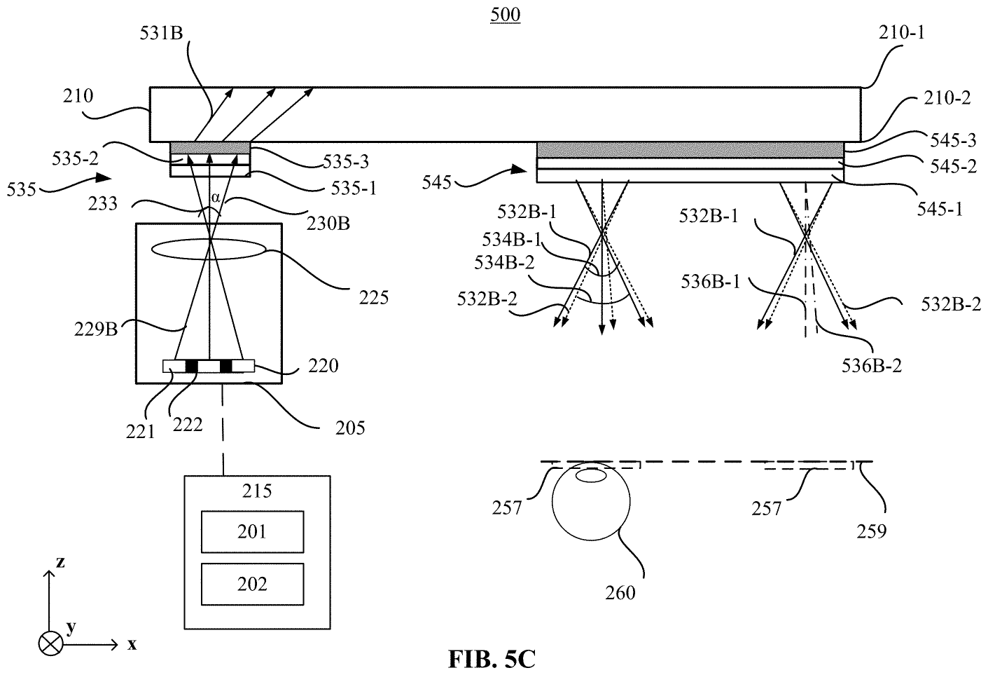

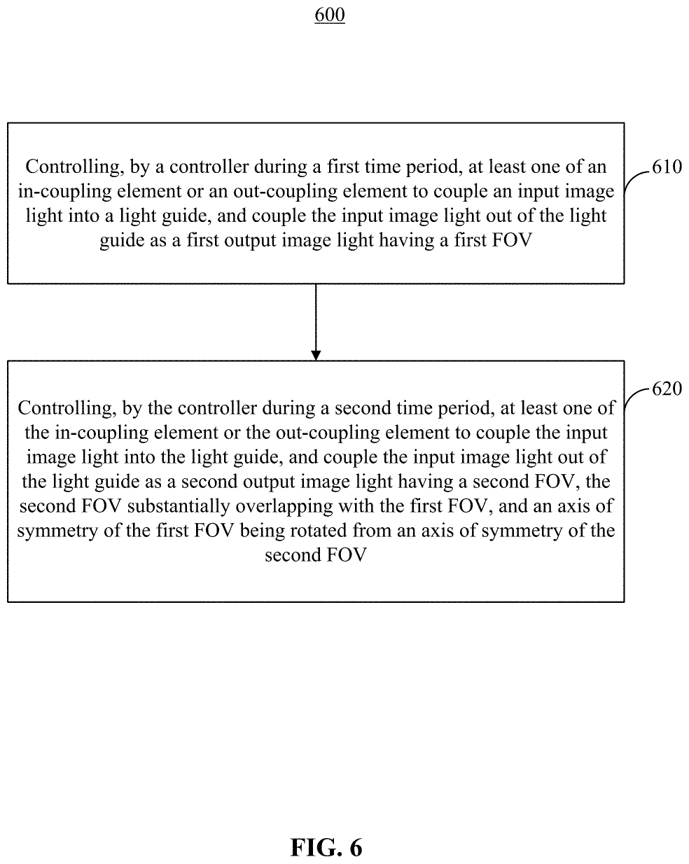

FIG. 6 is a flowchart illustrating a method 600 for providing an increased pixel density, according to an embodiment of the present disclosure. The method 600 may be performed by the controller 215, along with other devices and/or optical elements included in the light guide display systems disclosed herein. The method 600 may include controlling, by a controller during a first time period, at least one of an in-coupling element or an out-coupling element to couple an input image light into a light guide, and couple the input image light out of the light guide as a first output image light having a first FOV (step 610). The method 600 may also include controlling, by the controller during a second time period, at least one of the in-coupling element or the out-coupling element to couple the input image light into the light guide, and couple the input image light out of the light guide as a second output image light having a second FOV, the second FOV substantially overlapping with the first FOV, and an axis of symmetry of the first FOV being rotated from an axis of symmetry of the second FOV (step 620).

The method 600 may include other steps or processes described above that are not shown in FIG. 6. For example, the method 600 may include generating, by a light source assembly, an input image light representing a virtual image during each of the first time period and the second time period. In some embodiments, the first time period and the second time period may be a first sub-frame and a second sub-frame of a display frame of the virtual image. The input image light may have an input FOV, and the first FOV and the second FOV may have a same size as the input FOV. In some embodiments, during the first sub-frame of the display frame of the virtual image, the controller 215 may control at least one of the in-coupling element or the out-coupling element, to couple a first input image light into the light guide and couple the first input image light out of the light guide as a first output image light. During a second sub-frame of the frame of the image, the controller 215 may control at least one of the in-coupling element or the out-coupling element, to couple a second input image light into the light guide and couple the second input image light out of the light guide as a second output image light. The first input image light and the second input image light may have the same input FOV.

The first output image light and the second output image light may propagate toward the same exit pupil. The first output image light may have a first FOV, and the second image light may have a second FOV. The first FOV and the second FOV may have the same FOV size. The first FOV and the second FOV may substantially overlap one another, with a slight shift in their respective axes of symmetry. In other words, the second output image light may be considered as a duplicate of the first output image light, and may be slightly rotated for an angle relative to the first output image light. When the sub-frames are sufficiently short, and the relative rotation between the first output image light and the second output image light is smaller than the angular resolution of the eye at the exit pupil, the user may perceive both the first output image light and the second output image light as a single image light with an increased pixel density (or resolution) and an increased brightness.

In some embodiments, the in-coupling element may include an in-coupling grating. The controller may control the in-coupling grating to operate in a first diffraction state during the first time period, and to operate in a second diffraction state during the second time period. The first diffraction state may be different from the second diffraction state, such that the in-coupling grating may provide different diffraction angles to a same input image light incident thereonto.

In some embodiments, the out-coupling element may include an out-coupling grating. The controller may control the out-coupling grating to operate in a first diffraction state during the first time period, and to operate in a second diffraction state during the second time period. The first diffraction state may be different from the second diffraction state, such that the out-coupling grating may provide different diffraction angles to a same image light incident thereonto.

In some embodiments, the in-coupling element may include an in-coupling grating, and the out-coupling element may include an out-coupling grating. In some embodiments, during the first time period, the controller may control both of the in-coupling grating and the out-coupling grating to operate in their respective first diffraction states, and during the second time period, the controller may control both of the in-coupling grating and the out-coupling grating to operate in their respective second diffraction states.

In some embodiments, the in-coupling element may include a first in-coupling grating and a second in-coupling grating stacked together. During the first time period, the controller may control the first in-coupling grating to operate in a diffraction state and the second in-coupling grating to operate in a non-diffraction state. During the second time period, the controller may control the first in-coupling grating to operate in the non-diffraction state, and the second in-coupling grating to operate in the diffraction state. The first in-coupling grating operating in the diffraction state and the second in-coupling grating operating in the diffraction state may provide different diffraction angles to image lights with a same incidence angle.

In some embodiments, the out-coupling element may include a first out-coupling grating and a second out-coupling grating stacked together. During the first time period, the controller may control the first out-coupling grating to operate in the diffraction state and the second out-coupling grating to operate in the non-diffraction state. During the second time period, the controller may control the first out-coupling grating to operate in the non-diffraction state and the second out-coupling grating to operate in the diffraction state. The first out-coupling grating operating in the diffraction state and the second out-coupling grating operating in the diffraction state may provide different diffraction angles to image lights with a same incidence angle.

In some embodiments, the in-coupling element may include a first in-coupling grating and a second in-coupling grating stacked together, and the out-coupling element may include a first out-coupling grating and a second out-coupling grating stacked together. During the respective time period of a first time period, a second time period, a third time period, and a fourth time period, the controller may control different combinations of the in-coupling gratings and the out-coupling gratings to operate in the diffraction state, and control the remaining in-coupling gratings and out-coupling gratings to operate in the non-diffraction state. For example, during each time period, the controller may control one of the first and second in-coupling gratings and one of the first and second out-coupling gratings to operate in the diffraction state, and control the other one of the first and second in-coupling gratings and the other one of the first and second out-coupling gratings to operate in the non-diffraction state. The first in-coupling grating operating in the diffraction state and the second in-coupling grating operating in the diffraction state may provide different diffraction angles to image lights with a same incidence angle. The first out-coupling grating operating in the diffraction state and the second out-coupling grating operating in the diffraction state may provide different diffraction angles to image lights with a same incidence angle.

The disclosed optical systems (e.g., light guide display systems) and method for providing an increased output pixel density may be implemented in various systems, e.g., a near-eye display (“NED”), a head-up display (“HUD”), a head-mounted display (“HMD”), smart phones, laptops, or televisions, etc. In addition, the light guide display systems shown in the figures are for illustrative purposes to explain the mechanism for providing an increased output pixel density (pixel per degree) that may be two times, three times, or four times, etc., of an input pixel density (pixel per degree). The mechanism for an increased output pixel density may be applicable to any suitable display systems other than the disclosed light guide display systems. The gratings are for illustrative purposes. Any suitable light deflecting elements (e.g., non-switchable light deflecting elements, indirectly switchable light deflecting elements, and/or directly switchable light deflecting elements) may be used and configured to provide the increased output pixel density, following the same or similar design principles described herein with respect to the gratings.

A non-switchable light deflecting element may be a passive light deflecting element. In some embodiments, the passive light deflecting element may be polarization non-selective (or polarization independent). An indirectly switchable light deflecting element may be a passive light deflecting element that is polarization selective. The indirectly switchable light deflecting element may be switchable between different operating states when the polarization of the input light is switched by a polarization switch coupled with the passive light deflecting element. A directly switchable light deflecting element may be switchable between different operating states when a driving voltage applied to the directly switchable light deflecting element is controlled to be different voltages.

For example, the light deflecting element may include a polarization selective grating or a holographic element that includes sub-wavelength structures, liquid crystals, a photo-refractive holographic material, or a combination thereof. In some embodiments, the polarization non-selective light deflecting element may also be implemented and configured to provide an increased output pixel density. In some embodiments, the light deflecting elements may include diffraction gratings, cascaded reflectors, prismatic surface elements, an array of holographic reflectors, or a combination thereof. The controller may be configured to configure a light deflecting element to operate at a light deflection state to deflect an input light to change a propagating direction of the input light, or operate at a light non-deflection state in which the light deflecting element may not change the propagating direction of the input light.

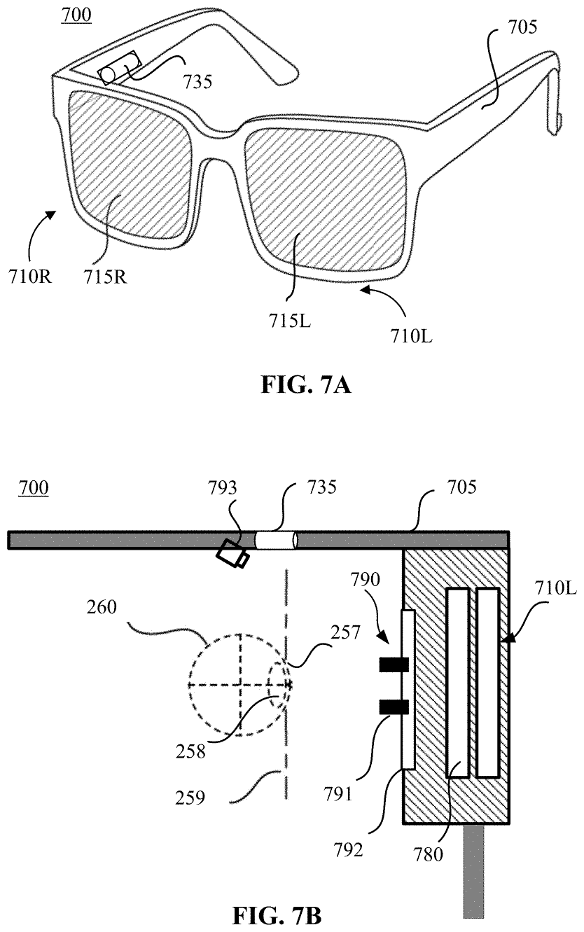

FIG. 7A illustrates a schematic diagram of a near-eye display (“NED”) 700 according to an embodiment of the present disclosure. FIG. 7B is a cross-sectional view of half of the NED 700 shown in FIG. 7A according to an embodiment of the present disclosure. For purposes of illustration, FIG. 7B shows the cross-sectional view associated with a left-eye display system 710L. The NED 700 may include a controller (not shown), which may be similar to the controller 215. The NED 700 may include a frame 705 configured to mount to a user's head. The frame 705 is merely an example structure to which various components of the NED 700 may be mounted. Other suitable type of fixtures may be used in place of or in combination with the frame 705. The NED 700 may include right-eye and left-eye display systems 710R and 710L mounted to the frame 705. The NED 700 may function as a VR device, an AR device, an MR device, or any combination thereof. In some embodiments, when the NED 700 functions as an AR or an MR device, the right-eye and left-eye display systems 710R and 710L may be entirely or partially transparent from the perspective of the user, which may provide the user with a view of a surrounding real-world environment. In some embodiments, when the NED 700 functions as a VR device, the right-eye and left-eye display systems 710R and 710L may be opaque to block the light from the real-world environment, such that the user may be immersed in the VR imagery based on computer-generated images.

The left-eye and right-eye display systems 710L and 710R may include image display components configured to project computer-generated virtual images into left and right display windows 715L and 715R in a field of view (“FOV”). The left-eye and right-eye display systems 710L and 710R may be any suitable display systems. In some embodiments, the left-eye and right-eye display systems 710L and 710R may include one or more optical systems (e.g., light guide display systems) disclosed herein, such as the light guide display system 200 shown in FIG. 2A, the light guide display system 250 shown in FIG. 2B, the light guide display system 270 shown in FIGS. 2C-2E, the light guide display system 300 shown in FIG. 3A, the light guide display system 350 shown in FIG. 3B, the light guide display system 400 shown in FIGS. 4A and 4B, or the light guide display system 500 shown in FIGS. 5A-5C. For illustrative purposes, FIG. 7A shows that the left-eye display systems 710L may include a light source assembly (e.g., a projector) 735 coupled to the frame 705 and configured to generate an image light representing a virtual image.

As shown in FIG. 7B, the left-eye display systems 710L may also include a viewing optical system 780 and an object tracking system 790 (e.g., eye tracking system and/or face tracking system). The viewing optical system 780 may be configured to guide the image light output from the left-eye display system 710L to the exit pupil 727. The exit pupil 257 may be a location where an eye pupil 258 of the eye 260 of the user is positioned in the eye-box region 259 of the left-eye display system 710L. For example, the viewing optical system 780 may include one or more optical elements configured to, e.g., correct aberrations in an image light output from the left-eye display systems 710L, magnify an image light output from the left-eye display systems 710L, or perform another type of optical adjustment of an image light output from the left-eye display systems 710L. Examples of the one or more optical elements may include an aperture, a Fresnel lens, a convex lens, a concave lens, a filter, any other suitable optical element that affects an image light, or a combination thereof.

The object tracking system 790 may include an IR light source 791 configured to illuminate the eye 260 and/or the face, a deflecting element 792 (such as a grating), and an optical sensor 793 (such as a camera). The deflecting element 792 may deflect (e.g., diffract) the IR light reflected by the eye 260 toward the optical sensor 793. The optical sensor 793 may generate a tracking signal relating to the eye 260. The tracking signal may be an image of the eye 260. A controller (not shown), such as the controller 215, may control various optical elements, such as an active in-coupling element, an active out-coupling element, an active dimming element, etc., based on eye-tracking information obtained from analysis of the image of the eye 260.

In some embodiments, the NED 700 may include an adaptive or active dimming element configured to dynamically adjust the transmittance of lights reflected by real-world objects, thereby switching the NED 700 between a VR device and an AR device or between a VR device and an MR device. In some embodiments, along with switching between the AR/MR device and the VR device, the adaptive dimming element may be used in the AR and/MR device to mitigate differences in brightness of lights reflected by real-world objects and virtual image lights.

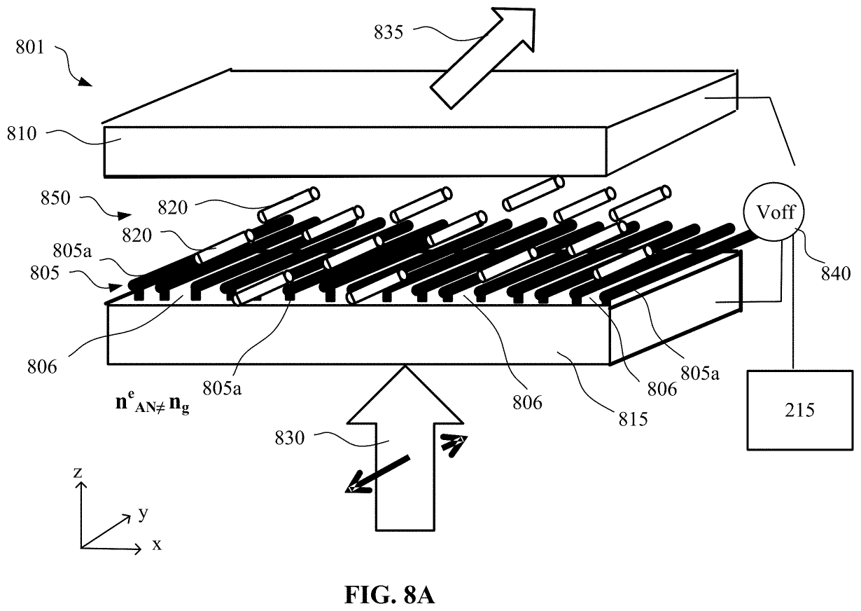

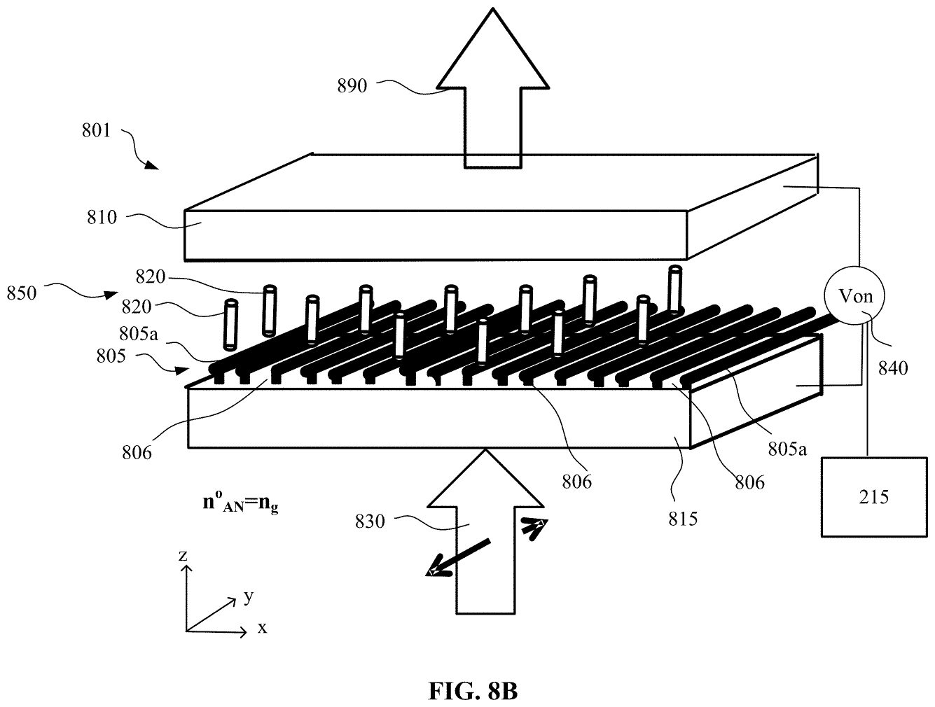

FIGS. 8A-11H illustrate exemplary active diffractive optical elements (e.g., active gratings), which may be implemented in various light guide display systems disclosed herein, for example, as gratings described above and shown in other figures for providing an increased output pixel density. The active diffractive optical element (e.g., active grating) may be implemented as an in-coupling element, an out-coupling element, or a redirecting element.

FIGS. 8A and 8B illustrate a schematic diagram of an active grating 801 at a diffraction state and a non-diffraction state, respectively, according to an embodiment of the disclosure. The active grating 801 may be implemented into a light guide display system disclosed herein as an in-coupling grating, an out-coupling grating, or a redirecting grating. A power source 840 may be electrically coupled with the active grating 801 via electrodes (not shown) disposed at the active grating 801. The power source 840 may provide an electric field to the active grating 801 through the electrodes. The controller 215 may be electrically coupled (e.g., through a wired or wireless connection) with the power source 840, and may control the output voltage and/or current of the power source 840. The active grating 801 may be switchable between a diffraction state and a non-diffraction state, when the controller 215 controls the power source 840 to generate a suitable electric field in the active grating 801. As described above, an active grating may be polarization selective or polarization nonselective. For illustrative purposes, the active grating 801 is shown as a polarization selective grating.

As shown in FIGS. 8A and 8B, the active grating 801 may include an upper substrate 810 and a lower substrate 815 arranged opposing (e.g., facing) one another. In some embodiments, when the active grating 801 is implemented into a light guide display system disclosed herein, the active grating 801 may be disposed at a surface of the light guide (e.g., 210, 410, etc.). In some embodiments, one of the upper substrate 810 and the lower substrate 815 may be the light guide or a part of the light guide. In some embodiments, at least one (e.g., each) of the upper substrate 810 or the lower substrate 815 may be provided with a transparent electrode at a surface (e.g., an inner surface) of the substrate for supplying an electric field to the active grating 801, such as an indium tin oxide (“ITO”) electrode. The power source 840 may be coupled with the transparent electrodes to supply a voltage for providing the electric field to the active grating 801.

In some embodiments, the active grating 801 may include a surface relief grating (“SRG”) 805 disposed at (e.g., bonded to or formed on) a surface of the lower substrate 815 facing the upper substrate 810. The SRG 805 may include a plurality of microstructures 805a, with sizes in micron levels or nano levels, which define or form a plurality of grooves 806. The microstructures 805a are schematically illustrated as solid black longitudinal structures, and the grooves 806 are shown as white portions between the solid black portions. The number of the grooves 806 may be determined by the grating period and the size of the SRG 805. The grooves 806 may be at least partially provided (e.g., filled) with a birefringent material 850. Optically anisotropic molecules 820 of the birefringent material 850 may have an elongated shape (represented by white rods in FIGS. 8A and 8B). The optically anisotropic molecules 820 may be aligned within the grooves 806 in any suitable alignment manner, such as homeotropic alignment, or homogeneous alignment, etc. The birefringent material 850 may have a first principal refractive index (e.g., n^{e}_{AN}) along a groove direction (e.g., y-axis direction, length direction, or longitudinal direction) of the grooves 806. The birefringent material 850 may have a second principal refractive index (e.g., n^{o}_{AN}) along an in-plane direction (e.g., x-axis direction, width direction, or lateral direction) perpendicular to the groove direction of the SRG 805.

When the grooves 806 have a substantially rectangular prism shape, or a longitudinal shape, the groove direction may be a groove length direction. In some embodiments, the grooves 806 may have other shapes. Accordingly, the groove direction may be other suitable directions. The birefringent material 850 may be an active, optically anisotropic material, such as active liquid crystals (“LCs”) with LC directors reorientable by an external field, e.g., the electric field provided by the power source 840. The optically anisotropic molecules 820 of the birefringent material 850 may also be referred to as LC molecules 820. The active LCs may have a positive or negative dielectric anisotropy.

The SRG 805 may be fabricated based on an organic material, such as amorphous or liquid crystalline polymers, or cross-linkable monomers including those having LC properties (reactive mesogens (“RMs”)). In some embodiments, the SRG 805 may be fabricated based on an inorganic material, such as metals or oxides used for manufacturing metasurfaces. The materials of the SRG 805 may be isotropic or anisotropic. In some embodiments, the SRG 805 may provide an alignment for the birefringent material 850. That is, the SRG 805 may function as an alignment layer to align the birefringent material 850. In some embodiments, the optically anisotropic molecules 820 may be aligned within the grooves 806 by a suitable alignment method, such as by a mechanical force (e.g., a stretch), a light (e.g., through photoalignment), an electric field, a magnetic field, or a combination thereof.

For illustrative purposes, FIGS. 8A and 8B show that the SRG 805 may be a binary non-slanted grating with a periodic rectangular profile. That is, the cross-sectional profile of the grooves 806 of the SRG 805 may have a periodic rectangular shape. In some embodiments, the SRG 805 may be a binary slanted grating, in which the microstructures 805a are slanted at a slant angle relative to a surface of the substrate 815, on which the microstructures 805a are disposed. In some embodiments, the slant angle of the SRG 805 may continuously vary in a predetermined direction, such as the x-axis direction in FIG. 8A. In some embodiments, the cross-sectional profile of the grooves 806 of the SRG 805 may be non-rectangular, for example, sinusoidal, triangular, parallelogrammic (e.g., when the microstructures 805a are slanted), or saw-tooth shaped.

In some embodiments, the alignment of the birefringent material 850 may be provided by one or more alignment structures (e.g., alignment layers) other than by the SRG 805. An alignment structure may be disposed at the substrate 810 and/or 815 (e.g., two alignment layers may be disposed at the respective opposing surfaces of the substrates 810 and 815). In some embodiments, the alignment structures provided at both of the substrates 810 and 815 may provide parallel planar alignments or hybrid alignments. For example, the alignment structure disposed at one of the substates 810 and 815 may be configured to provide a planar alignment, and the alignment structure disposed at the other one of the substates 810 and 815 may be configured to provide a homeotropic alignment. In some embodiments, the alignment of the birefringent material 850 may be provided by both the SRG 805 and one or more alignment structures (e.g., alignment layers) disposed at the substrate 810 and/or 815.

In some embodiments, as shown in FIG. 8A, the birefringent material 850 may include active LCs having a positive anisotropy, such as nematic liquid crystals (“NLCs”). The LC molecules 820 of the birefringent material 850 may be homogeneously aligned within the grooves 806 in the groove direction (e.g., y-axis direction). The second principal refractive index (e.g., n^{o}_{AN}) may substantially match with a refractive index n_{g} of the SRG 805, and the first principal refractive index (e.g., n^{e}_{AN}) may not match with the refractive index n_{g} of the SRG 805. The active grating 801 may be linear polarization dependent.

For example, referring to FIG. 8A, when a linearly polarized input light 830 polarized in the groove direction (e.g., y-axis direction) is incident onto the active grating 801, due to the refractive index difference between n^{e}_{AN} and n_{g}, the input light 830 may experience a periodic modulation of the refractive index in the active grating 801. As a result, the active grating 801 may diffract the input light 830 as a light 835. Due to the substantial match between the refractive indices n^{o}_{AN} and n_{g}, the active grating 801 may function as a substantially optically uniform plate for a linearly polarized input light polarized in the in-plane direction (e.g., x-axis direction) perpendicular to the groove direction (e.g., y-axis direction). That is, the active grating 801 may not diffract the input light linearly polarized in the in-plane direction perpendicular to the groove direction. Rather, the active grating 801 may transmit the input light polarized in the in-plane direction with substantially zero or negligible diffraction.

In some embodiments, the active grating 801 may be an active grating, which may be directly switchable between a diffraction state (or an activated state) and a non-diffraction state (or a deactivated state) by an external field, e.g., an external electric field provided by the power source 840. For example, the active grating 801 may include electrodes (not shown) disposed at the upper and lower substrate 810 and 815, and the power source 840 may be electrically coupled with the electrodes to provide the electric field to the active grating 801. The controller 215 may control an output (e.g., a voltage and/or current) of the power source 840. For discussion purposes, the voltage is used as an example output of the power source 840. By controlling the voltage output by the power source 840, the controller 215 may control the switching of the active grating 801 between the diffraction state and the non-diffraction state. For example, the controller 215 may control the voltage supplied by the power source 840 to switch the active grating 801 between the diffraction state and the non-diffraction state. When the active grating 801 operates in the diffraction state, the controller 215 may adjust the voltage supplied by the power source 840 to the electrodes to adjust the diffraction efficiency.

In some embodiments, the controller 215 may control the voltage supplied by the power source 840 to be lower than or equal to a threshold voltage, thereby configuring the active grating 801 to operate in the diffraction state (or activated state). In some embodiments, the threshold voltage may be determined by physical parameters of the active grating 801. When the voltage is lower than or equal to the threshold voltage, the electric field generated by the supplied voltage may be insufficient to reorient the LC molecules 820. When the controller 215 controls the supplied voltage to be higher than the threshold voltage (and sufficiently high) to reorient the LC molecules 820 to substantially follow (e.g., be parallel with) the direction of the electric field, the active grating 801 may operate in the non-diffraction state (or deactivated state).

As shown in FIG. 8A, when the controller 215 controls the power source 840 to supply a voltage that is lower than or equal to the threshold voltage (e.g., when the power source 840 supplies a substantially zero voltage), for the linearly polarized input light 830 polarized in the groove direction (e.g., y-axis direction) of the SRG 805, due to the difference between the refractive indices n^{e}_{AN} and n_{g}, the light 830 may experience a periodic modulation of the refractive index in the active grating 801 while propagating therethrough. As a result, the active grating 801 may diffract the light 830 as the light 835. That is, the controller 215 may control the power source 840 to supply a voltage that is lower than or equal to the threshold voltage, thereby configuring the active grating 801 to operate in the diffraction state to diffract the linearly polarized input light 830. In some embodiments, when the active grating 801 operates in the diffraction state, the diffraction angle of the light 835 may be tunable (or adjustable). For example, the controller 215 may tune (or adjust) a magnitude of the supplied voltage to tune the modulation of the refractive index in the active grating 801, thereby tuning the diffraction angle of the light 835.

As shown in FIG. 8B, when a voltage is supplied to the active grating 801, an electric field (which may extend in the z-axis direction) may be generated between the parallel substrates 810 and 815. When the voltage is higher than the threshold voltage and is gradually increased, the LC molecules 820 (of LCs having the positive dielectric anisotropy) may gradually become reoriented by the electric field to align in parallel with the electric field direction. As the voltage changes, for the linearly polarized input light 830 polarized in the groove direction (e.g., y-axis direction), the modulation of the refractive index nm (i.e., the difference between n^{e}_{AN} and n_{g}) provided by the active grating 801 to the light 830 may change accordingly, which in turn may change the diffraction efficiency.

When the voltage is sufficiently high, as shown in FIG. 8B, directors of the LC molecules 820 (of LCs having the positive dielectric anisotropy) may be reoriented to be parallel with the electric field direction (e.g., z-axis direction). Due to the substantial match between the refractive indices n^{o}_{AN} and n_{g}, the active grating 801 may function as a substantially optically uniform plate for the input light 830 polarized in the groove direction. The active grating 801 may operate in a non-diffraction state to transmit the light 830 therethrough as a light 890 with substantially zero or negligible diffraction.

In the embodiment shown in FIGS. 8A and 8B, the active grating 801 is configured to operate in the diffraction state when the voltage supplied by the power source 840 is lower than or equal to the threshold voltage, and operate in the non-diffraction state when the voltage is sufficiently higher than the threshold voltage. In other embodiments, by configuring the initial orientations of the LC molecules 820 differently, the active grating 801 may be configured to operate in the diffraction state when the voltage is sufficiently higher than the threshold voltage, and operate in the non-diffraction state when the voltage is lower than or equal to the threshold voltage.

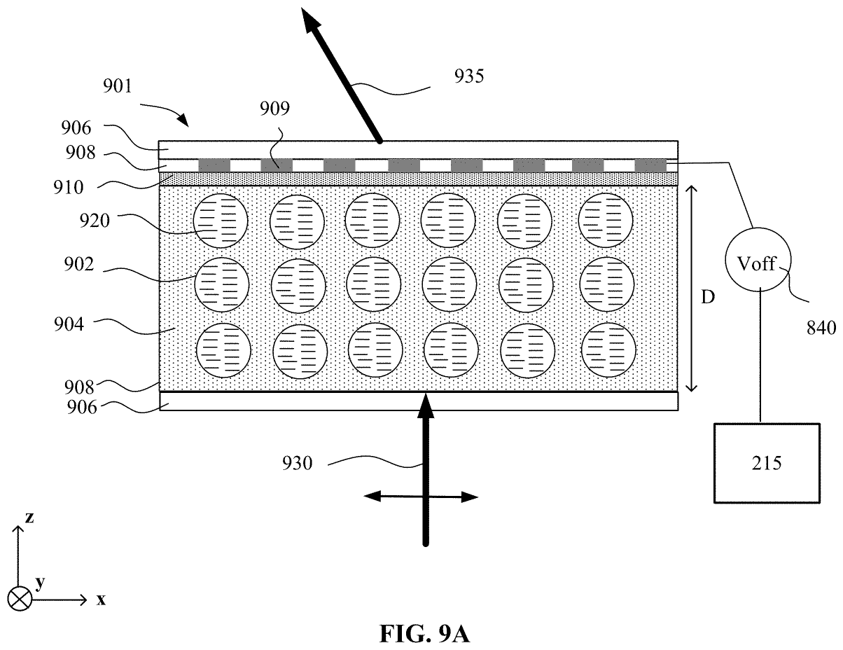

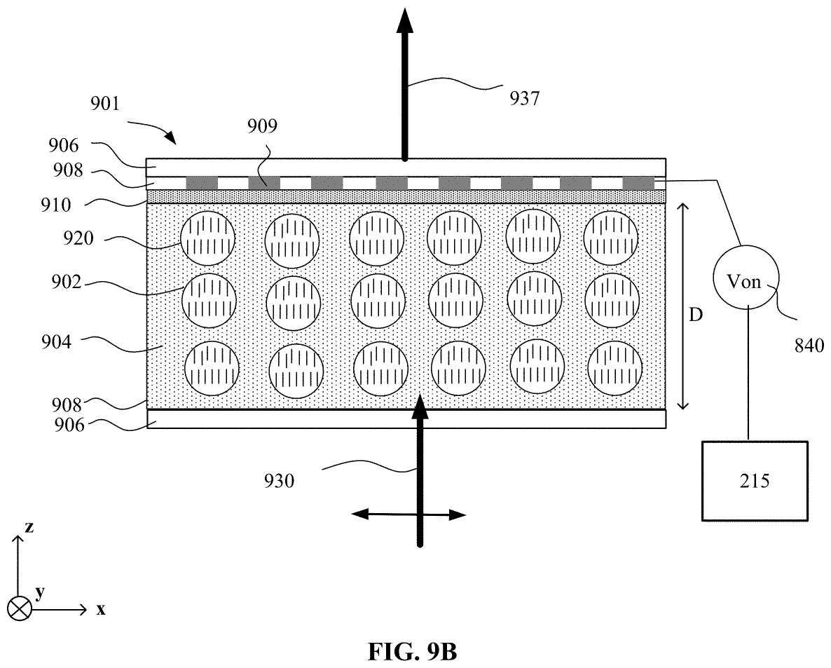

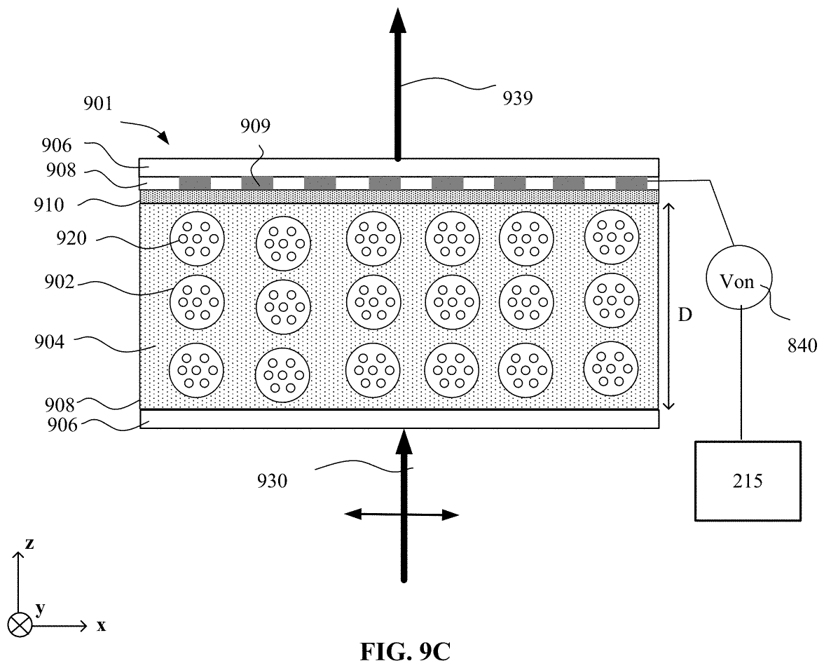

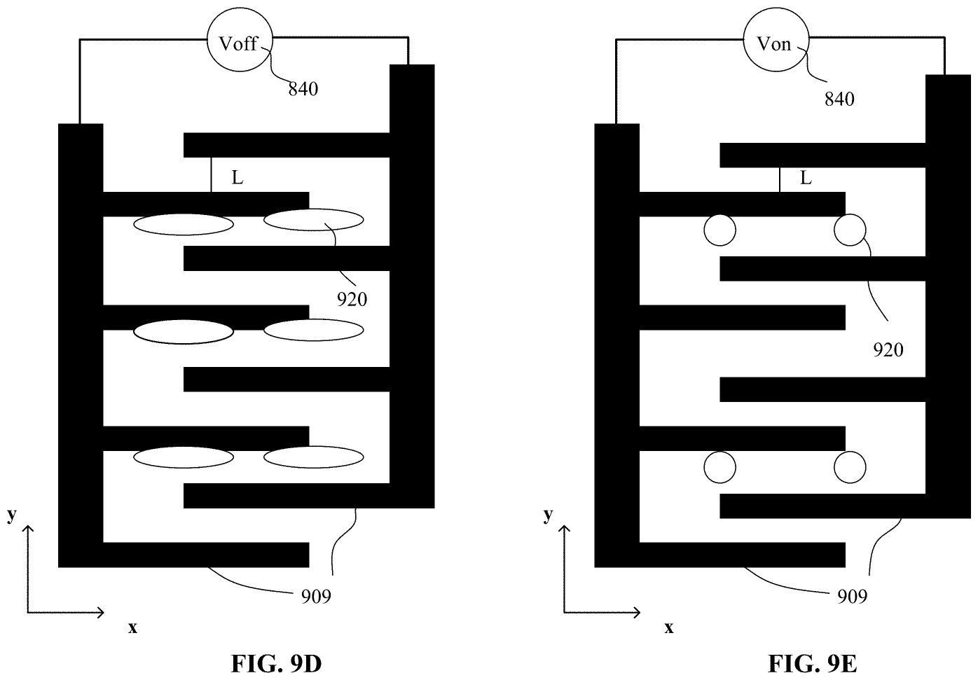

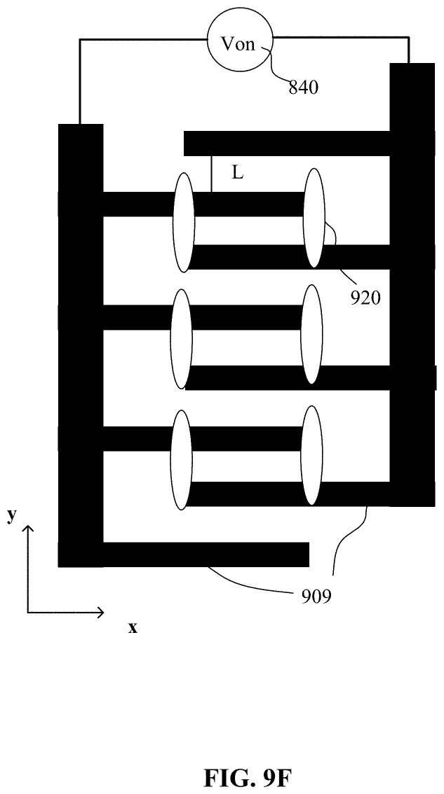

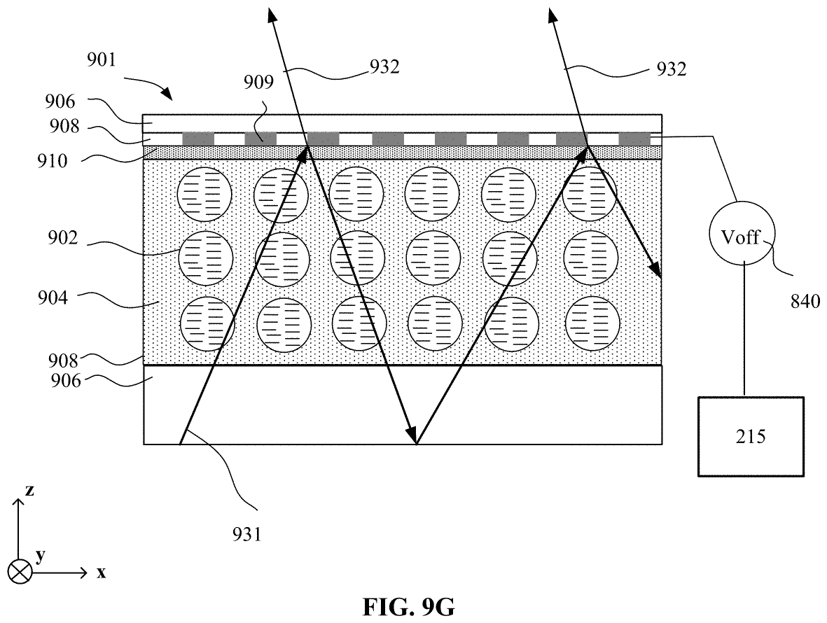

FIGS. 9A-9F illustrate schematic diagrams of an active grating 901, according to an embodiment of the disclosure. The active grating 901 may be implemented into a light guide display system disclosed herein as an in-coupling grating, an out-coupling grating, or a redirecting grating. As shown in FIG. 9A, the power source 840 may be electrically coupled with the active grating 901 to provide an electric field to the active grating 901. The controller 215 may be electrically coupled (e.g., through wired or wireless connection) with the power source 840, and may control the output of a voltage and/or current from the power source 840. The active grating 901 may be switchable between a diffraction state and a non-diffraction state, when the controller 215 controls the power source 840 to generate a suitable electric field. For illustrative purposes, the active grating 901 is shown as an active, polarization selective grating.

FIGS. 9A and 9D illustrate schematic diagrams of the active grating 901 in the diffraction state, according to an embodiment of the present disclosure. FIG. 9A illustrates an x-z sectional view of the active grating 901 in the diffraction state, and FIG. 9D illustrates an x-y sectional view of the active grating 901 in the diffraction state. As shown in FIGS. 9A and 9D, the active grating 901 may be an H-PDLC grating 901, which may be fabricated by polymerizing an isotropic photosensitive liquid mixture of monomers and LCs under a laser interference irradiation. The H-PDLC grating 901 may include layers of LC droplets 902 embedded in a polymer matrix 904 disposed between two substrates 906. One of the two substrate 906 may be provided with a transparent conductive electrode layer 908, such as an ITO electrode layer. In some embodiments, the electrode layer 908 may include interdigitated electrodes 909. In addition, at least one (e.g., each) of the substrates 906 may be provided with an alignment layer (not shown), which may be configured to homogeneously (or horizontally) align LC molecules 920 in a predetermined alignment direction, e.g., an x-axis direction in FIG. 9A.

The substrate 906 provided with the electrode layer 908 may also be provided with a low refractive index layer 910. In some embodiments, the low refractive index layer 910 may be configured to have a refractive index that is less than a refractive index nₚ of the material of the polymer matrix 904. For example, the refractive index nₚ of the material of the polymer matrix 904 may be about 1.3, and the refractive index of the low refractive index layer 910 may be less than 1.3 and close to the refractive index of air. For discussion purposes, FIG. 9A shows that the upper substate 906 is provided with the electrode layer 908 and the low refractive index layer 910. The low refractive index layer 910 may be disposed between the electrode layer 908 and the alignment layer of the upper substate 906. The lower substate 906 may not be provided with an electrode layer 908.

Referring to FIG. 9A, an ordinary refractive index nₒ of the LCs within the LC droplets 902 may be sufficiently close to the refractive index nₚ of the material of the polymer matrix 904, and an extraordinary refractive index nₑ of the LCs within the LC droplets 902 may be substantially different from the refractive index nₚ of the material of the polymer matrix 904. Due to the refractive index difference between the extraordinary refractive index nₑ of the LCs and the refractive index nₚ of the material of the polymer matrix 904, the spatial modulation of the LCs may produce a modulation in the average refractive index, resulting in an optical phase grating. When an input light 930 that is linearly polarized in the predetermined alignment direction (e.g., an x-axis direction) is incident onto the active grating 901 from the lower substate 906, due to the refractive index difference between nₑ and nₚ, the input light 930 may experience a periodic modulation of the refractive index in the active grating 901. As a result, the active grating 901 may diffract the input light 930 as a light 935. For illustrative purposes, FIG. 9A shows that the active grating 901 forwardly diffracts the input light 930 as the light 935. In some embodiments, although not shown, the active grating 901 may backwardly diffract the input light 930 as the light 935.

The LC droplets 902 are usually small (dimensions in sub-wavelength ranges) so that scattering due to refractive index mismatch of the LC and polymer may be minimized, and phase modulation may play a primary role. In other words, H-PDLC may belong to a class of nano-PDLC. The haze of the H-PDLC grating 901 caused by the scattering of the LC droplets 902 may be substantially small.

For an input light linearly polarized in a direction (e.g., a y-axis direction) perpendicular to the predetermined alignment direction (e.g., an x-axis direction) of the H-PDLC grating 901, due to the substantial match between the refractive indices nₒ and n_{g}, the H-PDLC grating 901 may function as a substantially optically uniform plate. That is, the H-PDLC grating 901 may not diffract, but may transmit the input light linearly polarized in the direction (e.g., a y-axis direction) perpendicular to the predetermined alignment direction (e.g., an x-axis direction).

The controller 215 may control an output (e.g., a voltage and/or current) of the power source 840. For example, by controlling the voltage output by the power source 840, the controller 215 may control the switching of the H-PDLC grating 901 between the diffraction state and the non-diffraction state. When the H-PDLC grating 901 operates in the diffraction state, the controller 215 may adjust the voltage supplied by the power source 840 to adjust the diffraction angle. In some embodiments, the controller 215 may configure the active grating 901 to operate in the diffraction state by controlling a voltage supplied by the power source 840 to be lower than or equal to a threshold voltage. When the voltage is lower than or equal to the threshold voltage, the electric field generated by the supplied voltage may be insufficient to reorient the LC molecules 920 in the LC droplets 902. In some embodiments, the controller 215 may configure the H-PDLC grating 901 to operate in the non-diffraction state by controlling the supplied voltage to be higher than the threshold voltage (and sufficiently high) to reorient the LC molecules 920 to be parallel with the direction of the electric field.

FIGS. 9B and 9E illustrate schematic diagrams of the active grating 901 in the non-diffraction state, according to an embodiment of the present disclosure. FIG. 9B illustrates an x-z sectional view of the active grating 901 in the non-diffraction state, and FIG. 9E illustrates an x-y sectional view of the active grating 901 in the non-diffraction state. As shown in FIGS. 9B and 9E, when a voltage is supplied to the H-PDLC grating 901, an electric field (e.g., along a z-axis direction) may be generated between the interdigitated electrodes 909. When the voltage is higher than the threshold voltage and is gradually increased, the LC molecules 920 (of LCs having the positive dielectric anisotropy) may gradually become reoriented by the electric field to align in parallel with the electric field direction. Depending on the gap L between the two neighboring interdigitated electrodes and the thickness D of the active grating 901, the generated electric field may be an in plane electric field that is within a plane (e.g., within the x-y plane) perpendicular to a thickness direction of the active grating 901 or a vertical electric field that is in a thickness direction (e.g., the z-axis direction) of the active grating 901.

In the embodiment shown in FIGS. 9B and 9E, the gap L between the two neighboring interdigitated electrodes and the thickness D of the active grating 901 may be configured, such that the generated electric field may be a vertical electric field that is in a thickness direction (e.g., the z-axis direction) of the active grating 901. When the voltage is sufficiently high, as shown in FIGS. 9B and 9E, directors of the LC molecules 920 (of LCs having the positive dielectric anisotropy) may be reoriented to be parallel with the electric field direction (e.g., the z-axis direction). Due to the substantial match between the refractive indices nₒ and n_{g}, the H-PDLC grating 901 may function as a substantially optically uniform plate for the input light 930. As shown in FIG. 9B, the H-PDLC grating 901 may operate in a non-diffraction state for the light 930 polarized in the predetermined alignment direction (e.g., the x-axis direction), and may transmit the light 930 therethrough as a light 937 with substantially zero or negligible diffraction.

FIGS. 9C and 9F illustrate schematic diagrams of the active grating 901 in the non-diffraction state, according to an embodiment of the present disclosure. FIG. 9C illustrates an x-z sectional view of the active grating 901 in the non-diffraction state, and FIG. 9F illustrates an x-y sectional view of the active grating 901 in the non-diffraction state. In the embodiment shown in FIGS. 9C and 9F, the gap L between the two neighboring interdigitated electrodes and the thickness D of the active grating 901 may be configured, such that the generated electric field may be an in-plane electric field that is within a plane (e.g., the x-y plane) perpendicular to a thickness direction of the active grating 901. When the voltage is sufficiently high, as shown in FIGS. 9C and 9F, directors of the LC molecules 920 (of LCs having the positive dielectric anisotropy) may be reoriented to be parallel with the electric field direction (e.g., the y-axis direction). Due to the substantial match between the refractive indices nₒ and n_{g}, the H-PDLC grating 901 may function as a substantially optically uniform plate for the input light 930. As shown in FIG. 9C, the H-PDLC grating 901 may operate in a non-diffraction state for the light 930 polarized in the predetermined alignment direction (e.g., the x-axis direction), and may transmit the light 930 therethrough as a light 939 with substantially zero or negligible diffraction.

FIGS. 9A-9C show that the H-PDLC grating 901 includes layers (e.g., three layers) of LC droplets 902 embedded in the polymer matrix 904, and the LC droplets 902 in the same layer may be separated from one another. In some embodiments, although not shown, the LC droplets 902 in the same layer may not be separated from one another. Instead, the LC droplets 902 may be in contact with one another to form a continuous LC layer. Two neighboring LC layers may be separated by the polymer matrix 904. In other words, the active grating 901 may include LC layers and polymer layers alternately arranged. Thus, the scattering of the LC droplets 902 may be reduced and, accordingly, the haze of the H-PDLC grating 901 caused by the scattering of the LC droplets 902 may be reduced.

In the embodiment shown in FIGS. 9A-9E, the H-PDLC grating 901 is configured to operate in the diffraction state when the voltage supplied by the power source 840 is lower than or equal to the threshold voltage, and to operate in the non-diffraction state when the voltage is sufficiently higher than the threshold voltage. In other embodiments, by configuring the initial orientations of the LC molecules 920 differently (e.g., homeotropically aligning LCs having a negative dielectric anisotropy), the H-PDLC grating 901 may be configured to operate in the diffraction state when the voltage supplied by the power source 840 is sufficiently higher than the threshold voltage, and to operate in the non-diffraction state when the voltage supplied by the power source 840 is lower than or equal to the threshold voltage.

In some embodiments, when the active grating 901 is implemented in a light guide display system disclosed herein as an in-coupling grating, an out-coupling grating, or a redirecting grating, the lower substrate 906 may be a light guide or a part of the light guide in a light guide display system disclosed herein. That is, the polymer matrix 904 embedded with the LC droplets 902 may be disposed between the upper substate 906 (that is provided with the electrode layer 908 and the low refractive index layer 910), and the light guide of the light guide display system. FIG. 9G illustrates an x-z sectional view of the active grating 901 implemented in a light guide display system disclosed herein, such as the light guide display system 200 shown in FIG. 2A, the light guide display system 250 shown in FIG. 2B, the light guide display system 270 shown in FIGS. 2C-2E, the light guide display system 300 shown in FIG. 3A, the light guide display system 350 shown in FIG. 3B, the light guide display system 400 shown in FIGS. 4A and 4B, or the light guide display system 500 shown in FIGS. 5A-5C

For discussion purposes, FIG. 9G shows that the active grating 901 functions as an out-coupling grating in the light guide display system disclosed herein. An input image light output from a light source assembly may be coupled, via an in-coupling element, into the lower substrate 906 (or the light guide 906) as an in-coupled image light (or a TIR propagating image light) 931. The in-coupled image light 931 may propagate toward the active grating 901 (or the out-coupling grating 901) via TIR. When the in-coupled image light 931 interacts with the polymer matrix 904 embedded with the LC droplets 902, the polymer matrix 904 embedded with the LC droplets 902 may diffract a first portion of the in-coupled image light 931 as an output image light 932 out of the active grating 901. A second portion of the in-coupled image light 931 may propagate toward the upper substrate 906 provided with the low refractive index layer 910 and the electrode layer 908. As the refractive index of the low refractive index layer 910 is configured to be less than the average refractive index of the polymer matrix 904 embedded with the LC droplets 902, the second portion of the in-coupled image light 931 may be totally internally reflected at the interface between the polymer matrix 904 embedded with the LC droplets 902 and the low refractive index layer 910 toward the light guide 906. Thus, the second portion of the in-coupled image light 931 may not be incident onto the electrode layer (e.g., ITO electrode layer) 908, and may not be absorbed by the electrode layer 908. Thus, when the in-coupled image light 931 propagating inside the light guide 906 is gradually coupled out of the light guide 906 as the output image lights 932, the absorption of the in-coupled image light 931 caused by the electrode layer (e.g., ITO electrode layer) 908 may be reduced. For illustrative purposes, FIG. 9G shows that the active grating 901 forwardly diffracts the in-coupled image light 931 as the output image light 932. In some embodiments, although not shown, the active grating 901 may backwardly diffract the in-coupled image light 931 as the output image light 932.

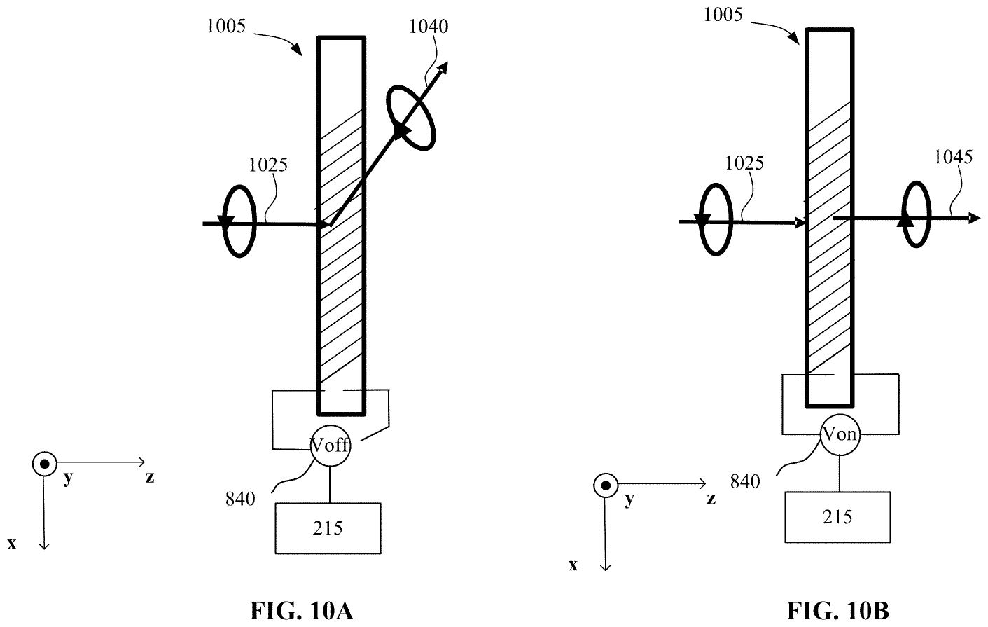

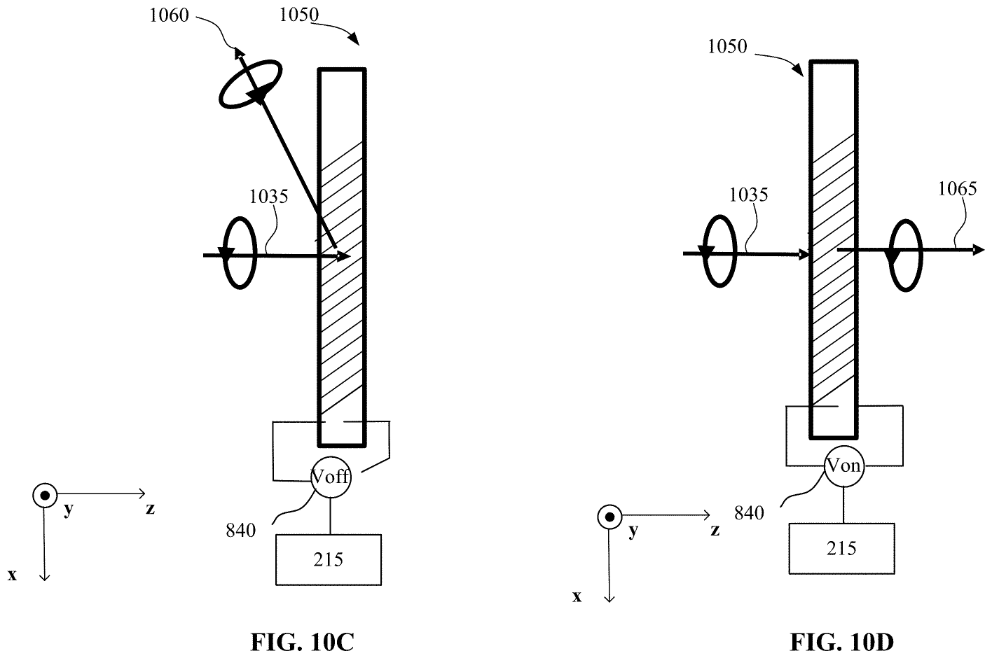

FIGS. 10A-10D illustrate schematic diagrams of liquid crystal polarization hologram (“LCPH”) gratings, according to various embodiments of the present disclosure. Liquid crystal polarization holograms (“LCPHs”) refer to the intersection of liquid crystal devices and polarization holograms. LCPH elements have features such as flatness, compactness, high efficiency, high aperture ratio, absence of on-axis aberrations, flexible design, simple fabrication, and low cost, etc. Thus, LCPH elements can be implemented in various applications such as portable or wearable optical devices or systems. Among LCPH elements, liquid crystal (“LC”) based Pancharatnam-Berry phase (“PBP”) elements and polarization volume hologram (“PVH”) elements have been extensively studied. A PBP element may modulate a circularly polarized light based on a phase profile provided through a geometric phase. A PVH element may modulate a circularly polarized light based on Bragg diffraction.

An LCPH grating (e.g., a PBP grating, a PVH grating, etc.) may be formed by a thin layer of one or more birefringent materials with intrinsic or induced (e.g., photo-induced) optical anisotropy (referred to as an optically anisotropic layer or a birefringent medium layer). A desirable predetermined grating phase profile may be directly encoded into local orientations of the optic axis of the birefringent medium layer. An LCPH grating described herein may be fabricated based on various methods, such as holographic interference, laser direct writing, ink-jet printing, and various other forms of lithography. Thus, a “hologram” described herein is not limited to creation by holographic interference, or “holography.”

An LCPH grating may be switchable between a diffraction state and a non-diffraction state. In some embodiments, an LCPH grating operating in the diffraction state may provide a tunable diffraction angle to an incident light. An LCPH grating may be transmissive or reflective. An LCPH grating may be polarization selective or polarization non-selective. An LCPH grating may be implemented into a light guide display system disclosed herein as an in-coupling grating, an out-coupling grating, or a redirecting grating.

FIGS. 10A and 10B illustrate schematic diagrams a transmissive-type LCPH grating 1005 in a diffraction state and a non-diffraction state, respectively, according to an embodiment of the present disclosure. For discussion purposes, the LCPH grating 1005 is polarization selective. As shown in FIGS. 10A and 10B, the power source 840 may be electrically coupled with the LCPH grating 1005 to provide an electric field to the LCPH grating 1005. The controller 215 may be electrically coupled (e.g., through wired or wireless connection) with the power source 840, to control an output (e.g., a voltage and/or current) of the power source 840. For example, by controlling the voltage output by the power source 840, the controller 215 may control the switching of the LCPH grating 1005 between the diffraction state and the non-diffraction state.

In some embodiments, the controller 215 may control the LCPH grating 1005 to operate in the diffraction state by controlling a voltage supplied by the power source 840 to be lower than or equal to a threshold voltage. When the voltage is lower than or equal to the threshold voltage, the electric field generated by the supplied voltage may be insufficient to reorient the LC molecules in the LCPH grating 1005. As shown in FIG. 10A, the LCPH grating 1005 that operates in the diffraction state may substantially forwardly diffract an incident light 1035 with a predetermined polarization (e.g., a circularly polarized light with a predetermined handedness) as a light of a predetermined order, such as, a +1^{st} order diffracted light 1040. In some embodiments, the polarization of the diffracted light 1040 may be opposite or orthogonal to the polarization of the incident light 1035. For example, the diffracted light 1040 may be a circularly polarized light with handedness that is opposite or orthogonal to the predetermined handedness. In some embodiments, when the LCPH grating 1005 operates in the diffraction state, the controller 215 may adjust the voltage supplied by the power source 840 to adjust the diffraction angle of the diffracted light 1040. For example, as the voltage supplied by the power source 840 increases, the grating period of the LCPH grating 1005 may increase, and the diffraction angle of the diffracted light 1040 may decrease.

In some embodiments, the controller 215 may control the LCPH grating 1005 to operate in the non-diffraction state by controlling the supplied voltage to be higher than the threshold voltage (and sufficiently high) to reorient the LC molecules LCPH grating 1005 to be parallel with the direction of the electric field. As shown in FIG. 10B, the LCPH grating 1005 operating in the non-diffraction state may substantially transmit the incident light 1035 as a light 1045, with negligible or zero diffraction. In some embodiments, transmission of the incident light 1035 as the transmitted light 1045 may be polarization independent. In some embodiments, the LCPH grating 1005 may transmit the incident light 1035 without affecting the polarization thereof. For example, the incident light 1035 and the transmitted light 1045 may have the same polarization. For example, the incident light 1035 and the transmitted light 1045 may be circular polarized lights with the same handedness. In some embodiments, the LCPH grating 1005 may change the polarization of the incident light 1035, while transmitting the incident light 1035. For example, the incident light 1035 and the transmitted light 1045 may be circular polarized lights with opposite handednesses.

FIGS. 10C and 10D illustrate schematic diagrams a reflective-type LCPH grating 1050 in a diffraction state and a non-diffraction state, respectively, according to an embodiment of the present disclosure. For discussion purposes, the LCPH grating 1050 is presumed to be polarization selective. As shown in FIGS. 10C and 10D, the power source 840 may be electrically coupled with the LCPH grating 1050 to provide an electric field to the LCPH grating 1050. The controller 215 may be electrically coupled (e.g., through wired or wireless connection) with the power source 840, to control an output (e.g., a voltage and/or current) of the power source 840. For example, by controlling the voltage output by the power source 840, the controller 215 may control the switching of the LCPH grating 1050 between the diffraction state and the non-diffraction state.

In some embodiments, the controller 215 may configure the LCPH grating 1050 to operate in the diffraction state by controlling a voltage supplied by the power source 840 to be lower than or equal to a threshold voltage. When the voltage is lower than or equal to the threshold voltage, the electric field generated by the supplied voltage may be insufficient to reorient the LC molecules in the LCPH grating 1050. As shown in FIG. 10C, the LCPH grating 1050 operating in the diffraction state may substantially backwardly diffract an incident light 1035 with a predetermined polarization (e.g., a circularly polarized light with a predetermined handedness) as a light of a predetermined order, such as, a +1^{st} order diffracted light 1060. In some embodiments, the diffracted light 1060 and the incident light 1035 may have the same polarization. For example, the diffracted light 1060 and the incident light 1035 may be circular polarized lights with the same handedness. In some embodiments, when the LCPH grating 1050 operates in the diffraction state, the controller 215 may adjust the voltage supplied by the power source 840 to adjust the diffraction angle of the diffracted light 1060. For example, as the voltage supplied by the power source 840 increases, the grating period of the LCPH grating 1050 may increase, and the diffraction angle of the diffracted light 1060 may decrease.

In some embodiments, the controller 215 may control the LCPH grating 1050 to operate in the non-diffraction state by controlling the supplied voltage to be higher than the threshold voltage (and sufficiently high) to reorient the LC molecules LCPH grating 1050 to be parallel with the direction of the electric field. As shown in FIG. 10D, the LCPH grating 1050 operating in the non-diffraction state may substantially transmit the incident light 1035 as a light 1065, with negligible or zero diffraction. In some embodiments, the LCPH grating 1050 operating in the non-diffraction state may substantially transmit the incident light 1035 as the transmitted light 1065. The transmission of the incident light 1035 as the light 1065 may be independent of the polarization of the incident light 1035. In some embodiments, the LCPH grating 1050 may transmit the incident light 1035 without affecting the polarization thereof. For example, the incident light 1035 and the transmitted light 1065 may be circular polarized lights with the same handedness. In some embodiments, the LCPH grating 1050 may change the polarization of the incident light 1035, while transmitting the incident light 1035. In some embodiments, the incident light 1035 and the transmitted light 1065 may have opposite or orthogonal polarizations. For example, the incident light 1035 and the transmitted light 1065 may be circular polarized lights with opposite handednesses.

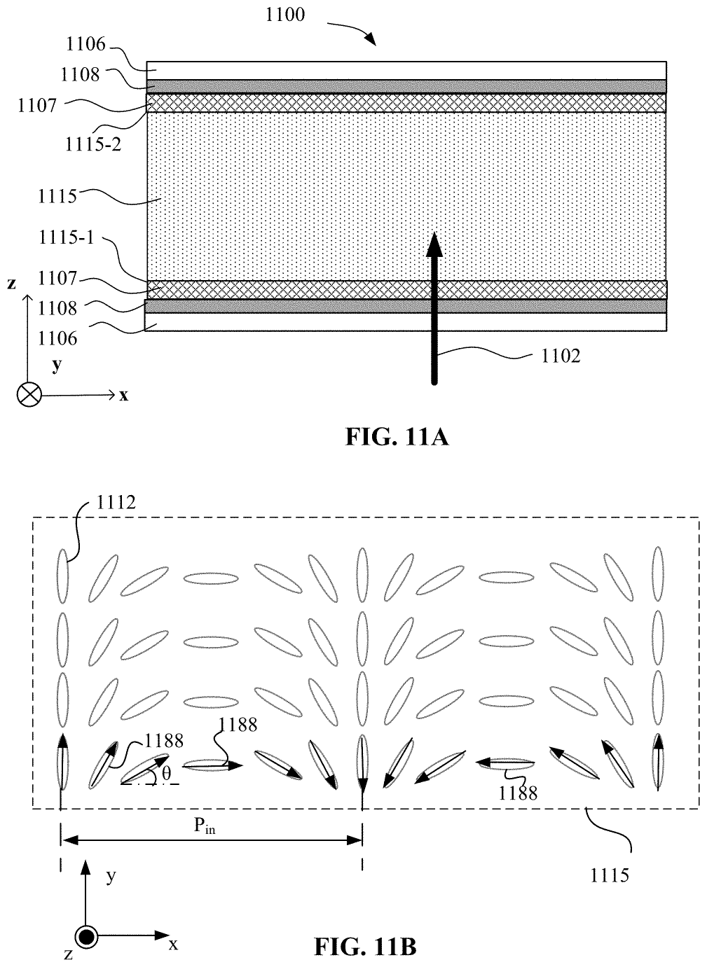

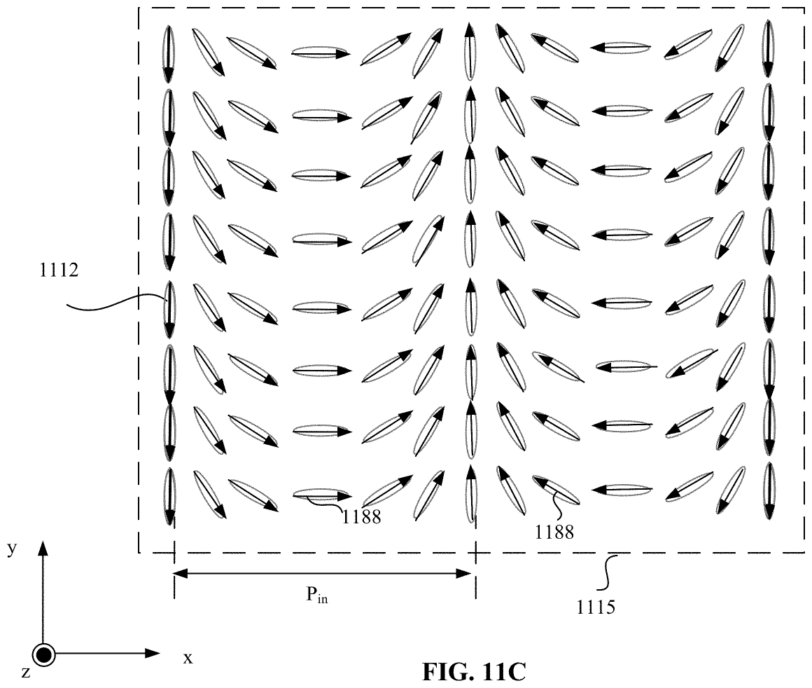

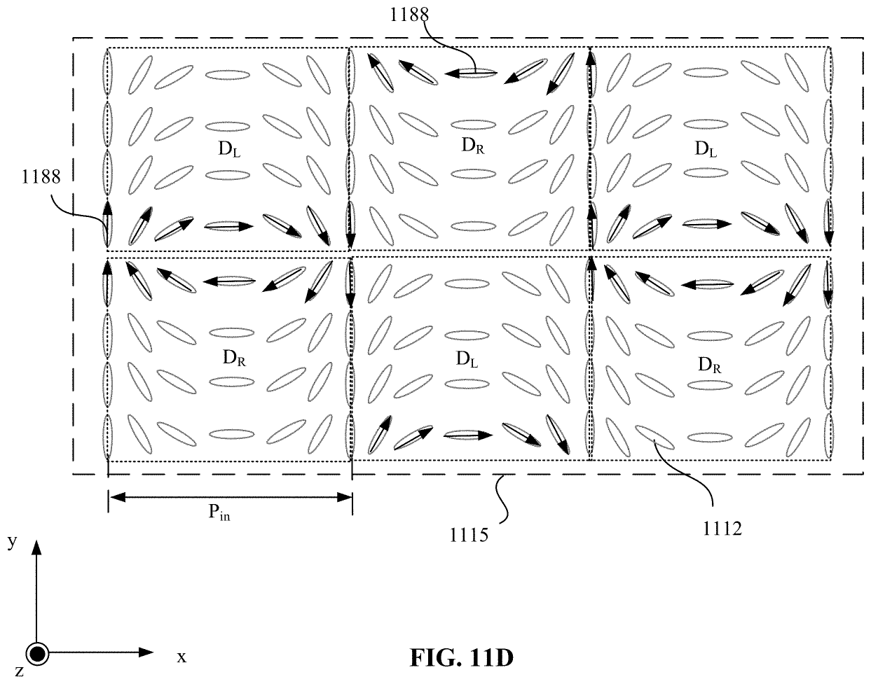

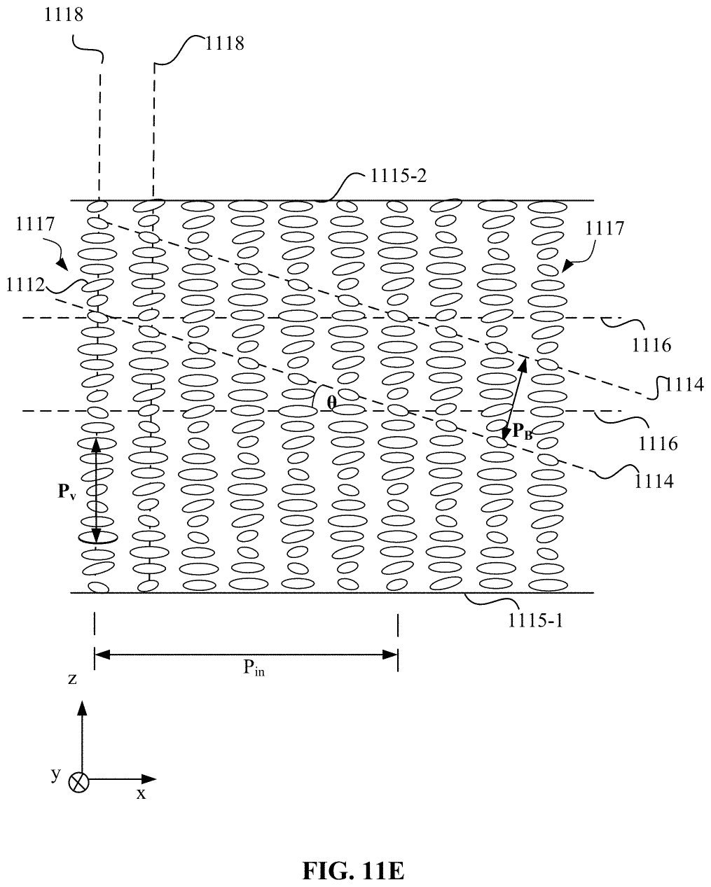

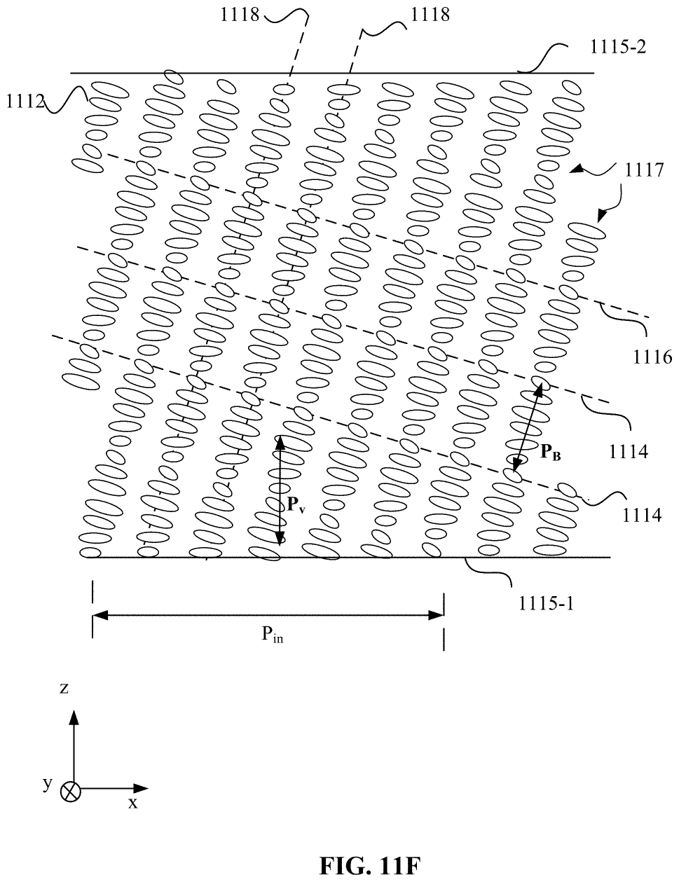

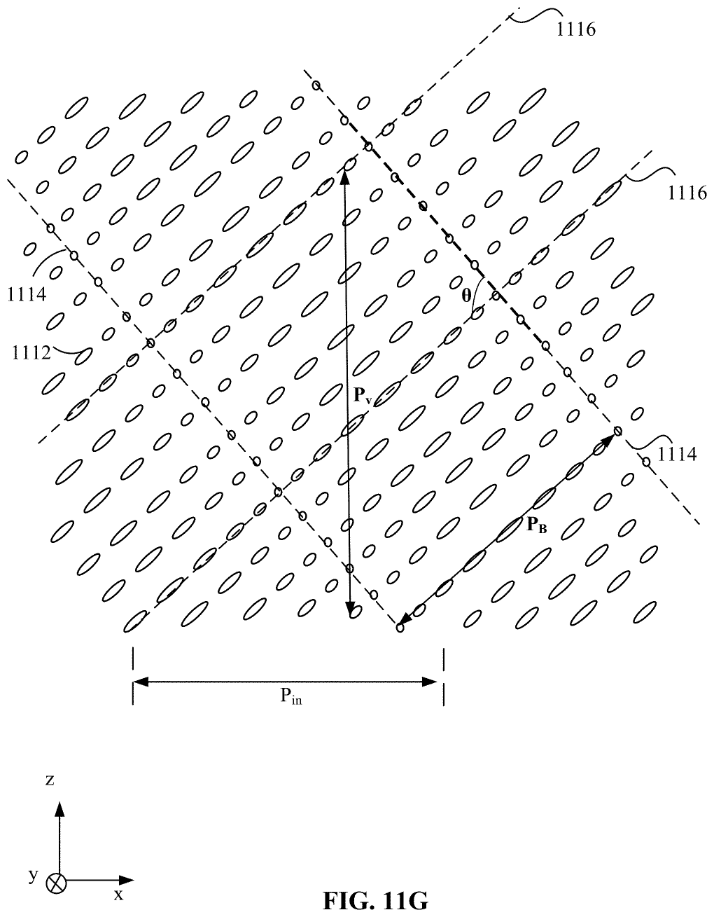

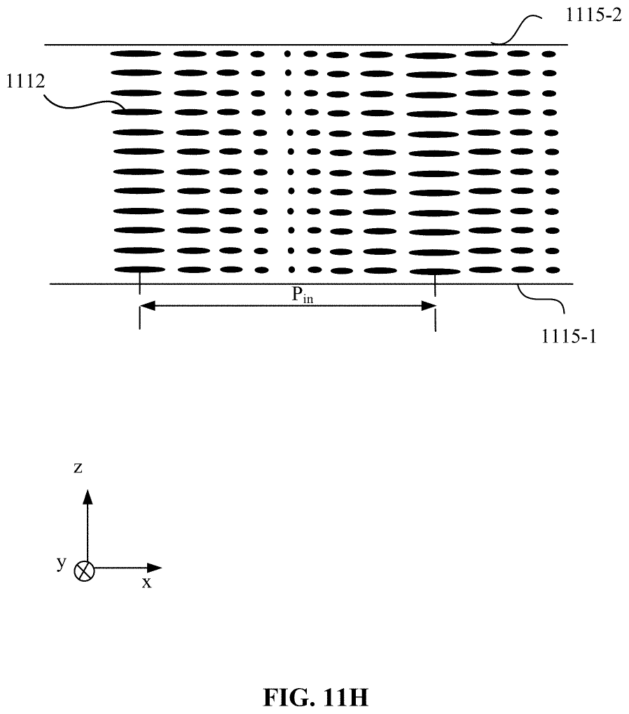

FIG. 11A illustrates an x-z sectional view of a liquid crystal polarization hologram (“LCPH”) element 1100 with a light 1102 incident onto the LCPH element 1100 along a −z-axis, according to an embodiment of the present disclosure. FIGS. 11B-11D schematically illustrate various views of a portion of the LCPH element 1100 shown in FIG. 11A, showing in-plane orientations of optically anisotropic molecules in the LCPH element 1100, according to various embodiments of the present disclosure. FIGS. 11E-11H schematically illustrate various views of a portion of the LCPH element 1100 shown in FIG. 11A, showing out-of-plane orientations of optically anisotropic molecules in the LCPH element 1100, according to various embodiments of the present disclosure. The LCPH element 1100 may be an active LCPH grating, such as the LCPH grating 1005 shown in FIGS. 10A and 10B, or the LCPH grating 1050 shown in FIGS. 10C and 10D.

As shown in FIG. 11A, although the LCPH element 1100 is shown as a rectangular plate shape for illustrative purposes, the LCPH element 1100 may have any suitable shape, such as a circular shape. In some embodiments, one or both surfaces along the light propagating path of the light 1102 may have curved shapes. The LCPH element 1100 may include two opposite substates 1106, and a thin layer (or film) 1115 of one or more birefringent materials disposed between the two substates 1106. The one or more birefringent materials may have an intrinsic or induced (e.g., photo-induced) optical anisotropy, such as liquid crystals, liquid crystal polymers, amorphous polymers. Such a thin layer 1115 may also be referred to as a birefringent medium layer (or film) 1115, or an LCPH layer (or film) 1115. In some embodiments, the birefringent medium layer 1115 may include active LCs, such as nematic LCs, twist-bend LCs, chiral nematic LCs, smectic LCs, or any combination thereof.

In some embodiments, at least one (e.g., each) of the two substates 1106 may be provided with an alignment structure 1107. The alignment structure 1107 may provide a suitable alignment pattern to optically anisotropic molecules in the birefringent medium layer 1115. The alignment pattern may correspond to a predetermined in-plane orientation pattern, such as an in-plane orientation pattern with periodic linear orientations. The alignment structure 1107 may include a suitable alignment structure, such as a photo-alignment material (“PAM”) layer, a mechanically rubbed alignment layer, an alignment layer with anisotropic nanoimprint, an anisotropic relief, or a ferroelectric or ferromagnetic material layer, etc.

In some embodiments, at least one (e.g., each) of the two substates 1106 may be provided with a transparent conductive electrode layer (e.g., ITO electrode) layer 1108. One or more power sources (not shown) may be electrically coupled with the LCPH element 1100. The one or more power sources may provide one or more electric fields to the LCPH element 1100 via the electrode layer 1108. In some embodiments, the LCPH element 1100 may include two electrode layers 1108, and a power source may provide an electric field to the LCPH element 1100 via the two electrode layers 1108. In some embodiments, the two electrode layers 1108 may be disposed at the two substrates 1106, respectively. In some embodiments, both of the two electrode layers 1108 may include planar continuous electrodes. In some embodiments, both of the two electrode layers 1108 may include patterned electrodes, e.g., slit electrodes. In some embodiments, one of the two electrode layers 1108 may include a planar continuous electrode, and the other one of the two electrode layers 1108 may include patterned electrodes, e.g., slit electrodes.

In some embodiments, each electrode layer 1108 may include two sub-electrode layers, and an electrically insulating layer disposed between the two sub-electrode layers. A respective power source may be electrically coupled with the two sub-electrode layers in each electrode layer 1108, thereby providing a respective electric field to the LCPH element 1100. In some embodiments, the two sub-electrode layers may include a planar continuous electrode and patterned electrodes.

The birefringent medium layer 1115 may have a first surface 1115-1 on one side and a second surface 1115-2 on an opposite side. The first surface 1115-1 and the second surface 1115-2 may be surfaces along the light propagating path of the incident light 1102. The birefringent medium layer 1115 may include optically anisotropic molecules (e.g., LC molecules) configured with a three-dimensional (“3D”) orientational pattern to provide a polarization selective optical response. In some embodiments, an optic axis of the LC material or birefringent medium layer 1115 may be configured with a spatially varying orientation in at least one in-plane direction. The in-plane direction may be an in-plane linear direction (e.g., an x-axis direction, a y-axis direction), an in-plane radial direction, an in-plane circumferential (e.g., azimuthal) direction, or a combination thereof. The LC molecules may be configured with an in-plane orientation pattern, in which the directors of the LC molecules may periodically or non-periodically vary in the at least one in-plane direction. In some embodiments, the optic axis of the LC material may also be configured with a spatially varying orientation in an out-of-plane direction. The directors of the LC molecules may also be configured with spatially varying orientations in an out-of-plane direction. For example, the optic axis of the LC material (or directors of the LC molecules) may twist in a helical fashion in the out-of-plane direction.

FIGS. 11B-11D schematically illustrate x-y sectional views of a portion of the LCPH element 1100 shown in FIG. 11A, showing in-plane orientations of the optically anisotropic molecules 1112 in the LCPH element 1100, according to various embodiments of the present disclosure. The in-plane orientations of the optically anisotropic molecules 1112 in the LCPH element 1100 shown in FIGS. 11B-11D are for illustrative purposes. In some embodiments, the optically anisotropic molecules 1112 in the LCPH element 1100 may have other in-plane orientation patterns. For discussion purposes, rod-like LC molecules 1112 are used as examples of the optically anisotropic molecules 1112. The rod-like LC molecule 1112 may have a longitudinal axis (or an axis in the length direction) and a lateral axis (or an axis in the width direction). The longitudinal axis of the LC molecule 1112 may be referred to as a director of the LC molecule 1112 or an LC director. An orientation of the LC director may determine a local optic axis orientation or an orientation of the optic axis at a local point of the birefringent medium layer 1115. The term “optic axis” may refer to a direction in a crystal. A light propagating in the optic axis direction may not experience birefringence (or double refraction). An optic axis may be a direction rather than a single line: lights that are parallel with that direction may experience no birefringence. The local optic axis may refer to an optic axis within a predetermined region of a crystal. For illustrative purposes, the LC directors of the LC molecules 1112 shown in FIGS. 11B-11D are presumed to be in the surface of the birefringent medium layer 1115 or in a plane parallel with the surface with substantially small tilt angles with respect to the surface.

FIG. 11B schematically illustrates an x-y sectional view of a portion of the LCPH element 1100, showing a periodic in-plane orientation pattern of the orientations of the LC directors (indicated by arrows 1188 in FIG. 11B) of the LC molecules 1112 located in a film plane of the birefringent medium layer 1115, e.g., a plane parallel with at least one of the first surface 1115-1 or the second surface 1115-2. The film plane may be perpendicular to the thickness direction of the birefringent medium layer 1115. The orientations of the LC directors located in the film plane of the birefringent medium layer 1115 may exhibit a periodic rotation in at least one in-plane direction. The at least one in-plane direction is shown as the x-axis direction in FIG. 11B. The periodically varying in-plane orientations of the LC directors form a pattern. The in-plane orientation pattern of the LC directors shown in FIG. 11B may also be referred to as an in-plane grating pattern. Accordingly, the LCPH element 1100 may function as a polarization selective grating, e.g., a PVH grating, or a PBP grating, etc.

As shown in FIG. 11B, the LC molecules 1112 located in the film plane of the birefringent medium layer 1115 may be configured with orientations of LC directors continuously changing (e.g., rotating) in a first predetermined in-plane direction in the film plane. The first predetermined in-plane direction is the shown as the x-axis in-plane direction. The continuous rotation exhibited in the orientations of the LC directors may follow a periodic rotation pattern with a uniform (e.g., same) in-plane pitch Pᵢₙ. It is noted that the first predetermined in-plane direction may be any other suitable direction in the film plane of the birefringent medium layer 1115, such as the y-axis direction, the radial direction, or the circumferential direction within the x-y plane. The pitch Pᵢₙ along the first predetermined (or x-axis) in-plane direction may be referred to as an in-plane pitch or a horizontal pitch. In some embodiments, the in-plane pitch or a horizontal pitch Pᵢₙ may be tunable through adjusting a voltage applied to the LCPH element 1100.

For simplicity of illustration and discussion, the LCPH element 1100 shown in FIG. 11B is presumed to be a 1D grating. Thus, the orientations in the y-axis direction are the same. In some embodiments, the LCPH element 1100 may be a 2D grating, and the orientations in the y-axis direction may also vary. The pattern with the uniform (or same) in-plane pitch Pᵢₙ may be referred to as a periodic LC director in-plane orientation pattern. The in-plane pitch Pᵢₙ may be defined as a distance along the first predetermined (or x-axis) in-plane direction over which the orientations of the LC directors exhibit a rotation by a predetermined value (e.g., 180°). In other words, in the film plane of the birefringent medium layer 1115, local optic axis orientations of the birefringent medium layer 1115 may vary periodically in the first predetermined (or x-axis) in-plane direction with a pattern having the uniform (or same) in-plane pitch Pᵢₙ.

In addition, in the film plane of the birefringent medium layer 1115, the orientations of the directors of the LC molecules 1112 may exhibit a rotation in a predetermined rotation direction, e.g., a clockwise direction or a counter-clockwise direction. Accordingly, the rotation exhibited in the orientations of the directors of the LC molecules 1112 in the film plane of the birefringent medium layer 1115 may exhibit a handedness, e.g., right handedness or left handedness. In the embodiment shown in FIG. 11B, in the film plane of the birefringent medium layer 1115, the orientations of the directors of the LC molecules 1112 may exhibit a rotation in a clockwise direction. Accordingly, the rotation of the orientations of the directors of the LC molecules 1112 in the film plane of the birefringent medium layer 1115 may exhibit a left handedness. In some embodiments, the LCPH element 1100 having the in-plane orientation pattern shown in FIG. 11B may be polarization selective.

In the embodiment shown in FIG. 11C, in the film plane of the birefringent medium layer 1115, the orientations of the directors of the LC molecules 1112 may exhibit a rotation in a counter-clockwise direction. Accordingly, the rotation exhibited in the orientations of the directors of the LC molecules 1112 the film plane of the birefringent medium layer 1115 may exhibit a right handedness. In some embodiments, the LCPH element 1100 having the in-plane orientation pattern shown in FIG. 11C may be polarization selective.

In the embodiment shown in FIG. 11D, in the film plane of the birefringent medium layer 1115, domains in which the orientations of the directors of the LC molecules 1112 exhibit a rotation in a clockwise direction (referred to as domains DL) and domains in which the orientations of the directors of the LC molecules 1112 exhibit a rotation in a counter-clockwise direction (referred to as domains DR) may be alternatingly arranged in at least one in-plane direction, e.g., a first (or x-axis) in-plane direction and/or a second (or y-axis) in-plane direction. In some embodiments, the LCPH element 1100 having the in-plane orientation pattern shown in FIG. 11D may be polarization non-selective.

FIGS. 11E-11H schematically illustrate y-z sectional views of a portion of the LCPH element 1100, showing out-of-plane orientations of the LC directors of the LC molecules 1112 in the LCPH element 1100, according to various embodiments of the present disclosure. The term “out-of-plane” means that a direction or orientation is not parallel with or within the film plane. Rather, the direction or orientation forms an angle with the film plane. In some embodiments, when the angle is 90°, the out-of-plane direction or orientation may be in the thickness direction of the LCPH element 1100. For discussion purposes, FIGS. 11E-11H schematically illustrate out-of-plane (e.g., along z-axis direction) orientations of the LC directors of the LC molecules 1112 when the in-plane orientation pattern is a periodic in-plane orientation pattern shown in FIG. 11B. As shown in FIG. 11E, within a volume of the birefringent medium layer 1115, the LC molecules 1112 may be arranged in a plurality of helical structures 1117 with a plurality of helical axes 1118 and a helical pitch Pₕ along the helical axes. The azimuthal angles of the LC molecules 1112 arranged along a single helical structure 1117 may continuously vary around a helical axis 1118 in a predetermined rotation direction, e.g., clockwise direction or counter-clockwise direction. In other words, the orientations of the LC directors of the LC molecules 1112 arranged along a single helical structure 1117 may exhibit a continuous rotation around the helical axis 1118 in a predetermined rotation direction. That is, the azimuthal angles associated of the LC directors may exhibit a continuous change around the helical axis in the predetermined rotation direction. Accordingly, the helical structure 1117 may exhibit a handedness, e.g., right handedness or left handedness. The helical pitch Pₕ may be defined as a distance along the helical axis 1118 over which the orientations of the LC directors exhibit a rotation around the helical axis 1118 by 360°, or the azimuthal angles of the LC molecules vary by 360°.

In the embodiment shown in FIG. 11E, the helical axes 1118 may be substantially perpendicular to the first surface 1115-1 and/or the second surface 1115-2 of the birefringent medium layer 1115. In other words, the helical axes 1118 of the helical structures 1117 may extend in a thickness direction (e.g., a z-axis direction) of the birefringent medium layer 1115. That is, the LC molecules 1112 may have substantially small tilt angles (including zero degree tilt angles), and the LC directors of the LC molecules 1112 may be substantially orthogonal to the helical axis 1118. The birefringent medium layer 1115 may have a vertical pitch Pᵥ, which may be defined as a distance along the thickness direction of the birefringent medium layer 1115 over which the orientations of the LC directors of the LC molecules 1112 exhibit a rotation around the helical axis 1118 by 180° (or the azimuthal angles of the LC directors vary by 180°). In the embodiment shown in FIG. 11E, the vertical pitch Pᵥ may be half of the helical pitch Pₕ.

As shown in FIG. 11E, the LC molecules 1112 from the plurality of helical structures 1117 having a first same orientation (e.g., same tilt angle and azimuthal angle) may form a first series of parallel refractive index planes 1114 periodically distributed within the volume of the birefringent medium layer 1115. Although not labeled, the LC molecules 1112 with a second same orientation (e.g., same tilt angle and azimuthal angle) different from the first same orientation may form a second series of parallel refractive index planes periodically distributed within the volume of the birefringent medium layer 1115. Different series of parallel refractive index planes may be formed by the LC molecules 1112 having different orientations. In the same series of parallel and periodically distributed refractive index planes 1114, the LC molecules 1112 may have the same orientation and the refractive index may be the same. Different series of refractive index planes 1114 may correspond to different refractive indices. When the number of the refractive index planes 1114 (or the thickness of the birefringent medium layer) increases to a sufficient value, Bragg diffraction may be established according to the principles of volume gratings. Thus, the periodically distributed refractive index planes 1114 may also be referred to as Bragg planes 1114. In some embodiments, as shown in FIG. 11E, the refractive index planes 1114 may be slanted with respect to the first surface 1115-1 or the second surface 1115-2. In some embodiments, the refractive index planes 1114 may be perpendicular to or parallel with the first surface 1115-1 or the second surface 1115-2. Within the birefringent medium layer 1115, there may exist different series of Bragg planes. A distance (or a period) between adjacent Bragg planes 1114 of the same series may be referred to as a Bragg period PB. The different series of Bragg planes formed within the volume of the birefringent medium layer 1115 may produce a varying refractive index profile that is periodically distributed in the volume of the birefringent medium layer 1115. The birefringent medium layer 1115 may diffract an input light satisfying a Bragg condition through Bragg diffraction.

As shown in FIG. 11E, the birefringent medium layer 1115 may also include a plurality of LC molecule director planes (or molecule director planes) 1116 arranged in parallel with one another within the volume of the birefringent medium layer 1115. An LC molecule director plane (or an LC director plane) 1116 may be a plane formed by or including the LC directors of the LC molecules 1112. In the example shown in FIG. 11E, the LC directors in the LC director plane 1116 have different orientations, i.e., the orientations of the LC directors vary in the x-axis direction. The Bragg plane 1114 may form an angle θ with respect to the LC molecule director plane 1116. In the embodiment shown in FIG. 11E, the angle θ may be an acute angle, e.g., 0°<θ<90°. The LCPH element 1100 including the birefringent medium layer 1115 shown in FIG. 11B may function as a transmissive PVH element, e.g., a transmissive PVH grating.

In the embodiment shown in FIG. 11F, the helical axes 1118 of helical structures 1117 may be tilted with respect to the first surface 1115-1 and/or the second surface 1115-2 of the birefringent medium layer 1115 (or with respect to the thickness direction of the birefringent medium layer 1115). For example, the helical axes 1118 of the helical structures 1117 may have an acute angle or obtuse angle with respect to the first surface 1115-1 and/or the second surface 1115-2 of the birefringent medium layer 1115. In some embodiments, the LC directors of the LC molecule 1112 may be substantially orthogonal to the helical axes 1118 (i.e., the tilt angle may be substantially zero degree). In some embodiments, the LC directors of the LC molecule 1112 may be tilted with respect to the helical axes 1118 at an acute angle. The birefringent medium layer 1115 may have a vertical periodicity (or pitch) Pᵥ. In the embodiment shown in FIG. 11F, an angle θ (not shown) between the LC director plane 1116 and the Bragg plane 1114 may be substantially 0° or 180°. That is, the LC director plane 1116 may be substantially parallel with the Bragg plane 1114. In the example shown in FIG. 11F, the orientations of the directors in the molecule director plane 1116 may be substantially the same. The LCPH element 1100 including the birefringent medium layer 1115 shown in FIG. 11F may function as a reflective PVH element, e.g., a reflective PVH grating.

In the embodiment shown in FIG. 11G, the birefringent medium layer 1115 may also include a plurality of LC director planes 1116 arranged in parallel within the volume of the birefringent medium layer 1115. In the embodiment shown in FIG. 11F, an angle θ between the LC director plane 1116 and the Bragg plane 1114 may be a substantially right angle, e.g., θ=90°. That is, the LC director plane 1116 may be substantially orthogonal to the Bragg plane 1114. In the example shown in FIG. 11F, the LC directors in the LC director plane 1116 may have different orientations. In some embodiments, the LCPH element 1100 including the birefringent medium layer 1115 shown in FIG. 11F may function as a transmissive PVH element, e.g., a transmissive PVH grating.

In the embodiment shown in FIG. 11H, in a volume of the birefringent medium layer 1115, along the thickness direction (e.g., the z-axis direction) of the birefringent medium layer 1115, the directors (or the azimuth angles) of the LC molecules 1112 may remain in the same orientation (or same angle value) from the first surface 1115-1 to the second surface 1115-2 of the birefringent medium layer 1115. In some embodiments, the thickness of the birefringent medium layer 1115 may be configured as d=λ/(2*Δn), where λ is a design wavelength, Δn is the birefringence of the LC material of the birefringent medium layer 1115, and Δn=nₑ−nₒ, where nₑ and nₒ are the extraordinary and ordinary refractive indices of the LC material, respectively. In some embodiments, the LCPH element 1100 including the birefringent medium layer 1115 shown in FIG. 11F may function as a PBP element, e.g., a PBP grating.

In some embodiments, the present disclosure provides a device. The device includes a light guide. The device includes an in-coupling element coupled with the light guide and configured to couple an input image light into the light guide. The device includes an out-coupling element coupled with the light guide and configured to couple the input image light out of the light guide as an output image light propagating toward an exit pupil. The device includes a controller configured to control at least one of the in-coupling element or the out-coupling element during a first time period and a second time period. The out-coupling element is configured to output a first output image light during the first time period to the exit pupil, and a second output image light during the second time period to the exit pupil. The first output image light is shifted from the second output image light for an angle.

In some embodiments, the present disclosure provides a method. The method includes generating an input image light. The method includes during a first time period, controlling, by a controller, at least one of an in-coupling element or an out-coupling element to couple the input image light into a light guide, and couple the input image light out of the light guide as a first output image light. The method includes during a second time period, controlling, by the controller, at least one of the in-coupling element or the out-coupling element to couple the input image light into the light guide, and couple the input image light out of the light guide as a second output image light. The first output image light and the second output image light propagate from the light guide toward a same exit pupil. The second output image light is rotated from the first output image light.

In some embodiments, the present disclosure provides a device, such as an optical device. The device includes a light guide. The device also includes an in-coupling element coupled with the light guide and configured to couple an input image light into the light guide. The device also includes an out-coupling element coupled with the light guide and configured to couple the input image light out of the light guide as an output image light. The device also includes a controller configured to control at least one of the in-coupling element or the out-coupling element during a first time period and a second time period. The out-coupling element is configured to output a first output image light having a first field of view (“FOV”) during the first time period, and a second output image light having a second FOV during the second time period. The first FOV substantially overlaps with the second FOV, and an axis of symmetry of the first FOV is rotated relative to an axis of symmetry of the second FOV.

In some embodiments, the input image light has an input FOV, and the first FOV and the second FOV have a same size as the input FOV. In some embodiments, an overlapping portion of the first FOV and the second FOV is within a range of from 80% to 95% of the first FOV. In some embodiments, a relative rotation between the axis of symmetry of the first FOV and the axis of symmetry of the second FOV is within a range of from 5% to 20% of the first FOV. In some embodiments, the in-coupling element includes an in-coupling grating, and the controller is configured to control the in-coupling grating to operate in a first diffraction state during the first time period and a second diffraction state during the second time period. In some embodiments, the in-coupling grating operating in the first diffraction state and the second diffraction state have different grating periods or different modulations of refractive index. In some embodiments, the out-coupling element includes an out-coupling grating, and the controller is configured to control the out-coupling grating to operate in a first diffraction state during the first time period and a second diffraction state during the second time period. In some embodiments, the out-coupling grating operating in the first diffraction state and the second diffraction state have different grating periods or different modulations of refractive index. In some embodiments, the in-coupling element includes a first in-coupling grating and a second in-coupling grating. The controller is configured to: control the first in-coupling grating to operate in a diffraction state and the second in-coupling grating to operate in a non-diffraction state during the first time period, and control the first in-coupling grating to operate in the non-diffraction state and the second in-coupling grating to operate in the diffraction state during the second time period. In some embodiments, the first in-coupling grating operating in the diffraction state and the second in-coupling grating operating in the diffraction state have different grating periods or different modulations of refractive index.

In some embodiments, the out-coupling element includes a first out-coupling grating and a second out-coupling grating. The controller is configured to: control the first out-coupling grating to operate in a diffraction state and the second out-coupling grating to operate in a non-diffraction state during the first time period, and control the first out-coupling grating to operate in the non-diffraction state and the second out-coupling grating to operate in the diffraction state during the second time period. In some embodiments, the first out-coupling grating operating in the diffraction state and the second out-coupling grating operating in the diffraction state have different grating periods or different modulations of refractive index.

In some embodiments, at least one of the in-coupling element or the out-coupling element includes one or more active gratings. In some embodiments, the one more active gratings include one or more holographic polymer-dispersed liquid crystal gratings, one or more surface relief gratings including active liquid crystals (“LCs”), one or more Pancharatnam-Berry phase gratings based on active LCs, or one or more polarization volume hologram gratings based on active LCs.

In some embodiments, the present disclosure provides a method. The method includes controlling, by a controller during a first time period, at least one of an in-coupling element or an out-coupling element to couple an input image light into a light guide, and couple the input image light out of the light guide as a first output image light having a first FOV. The method also includes controlling, by the controller during a second time period, at least one of the in-coupling element or the out-coupling element to couple the input image light into the light guide, and couple the input image light out of the light guide as a second output image light having a second FOV. The second FOV substantially overlaps with the first FOV. An axis of symmetry of the first FOV is rotated from an axis of symmetry of the second FOV. In some embodiments, the input image light has an input FOV, and the first FOV and the second FOV have a same size as the input FOV. In some embodiments, an overlapping portion of the first FOV and the second FOV is within a range of from 80% to 95% of the first FOV. In some embodiments, a relative rotation between the axis of symmetry of the first FOV and the axis of symmetry of the second FOV is within a range of from 5% to 20% of the first FOV. In some embodiments, a relative rotation between the axis of symmetry of the first FOV and the axis of symmetry of the second FOV is between 0.5°-10°. In some embodiments, the first output image light having the first FOV and the second output image light having the second FOV propagate toward a same eye pupil.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in light of the above disclosure.

Some portions of this description may describe the embodiments of the present disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a light guide;
an in-coupling element coupled with the light guide and configured to couple an input image light into the light guide;
an out-coupling element coupled with the light guide and configured to couple the input image light out of the light guide as an output image light; and
a controller configured to control at least one of the in-coupling element or the out-coupling element during a first time period and a second time period,
wherein the out-coupling element is configured to output a first output image light having a first field of view (“FOV”) during the first time period, and a second output image light having a second FOV during the second time period, and
wherein the first FOV substantially overlaps with the second FOV, and an axis of symmetry of the first FOV is rotated relative to an axis of symmetry of the second FOV.

2. The device of claim 1, wherein the input image light has an input FOV, and the first FOV and the second FOV have a same size as the input FOV.

3. The device of claim 2, wherein an overlapping portion of the first FOV and the second FOV is within a range of from 80% to 95% of the first FOV.

4. The device of claim 2, wherein a relative rotation between the axis of symmetry of the first FOV and the axis of symmetry of the second FOV is within a range of from 5% to 20% of the first FOV.

5. The device of claim 1, wherein the in-coupling element includes an in-coupling grating, and the controller is configured to control the in-coupling grating to operate in a first diffraction state during the first time period and a second diffraction state during the second time period.

6. The device of claim 5, wherein the in-coupling grating operating in the first diffraction state and the second diffraction state have different grating periods or different modulations of refractive index.

7. The device of claim 1, wherein the out-coupling element includes an out-coupling grating, and the controller is configured to control the out-coupling grating to operate in a first diffraction state during the first time period and a second diffraction state during the second time period.

8. The device of claim 7, wherein the out-coupling grating operating in the first diffraction state and the second diffraction state have different grating periods or different modulations of refractive index.

9. The device of claim 1,
wherein the in-coupling element includes a first in-coupling grating and a second in-coupling grating, and
wherein the controller is configured to:
control the first in-coupling grating to operate in a diffraction state and the second in-coupling grating to operate in a non-diffraction state during the first time period, and
control the first in-coupling grating to operate in the non-diffraction state and the second in-coupling grating to operate in the diffraction state during the second time period.

10. The device of claim 9, wherein the first in-coupling grating operating in the diffraction state and the second in-coupling grating operating in the diffraction state have different grating periods or different modulations of refractive index.

11. The device of claim 1,
wherein the out-coupling element includes a first out-coupling grating and a second out-coupling grating, and
wherein the controller is configured to:
control the first out-coupling grating to operate in a diffraction state and the second out-coupling grating to operate in a non-diffraction state during the first time period, and
control the first out-coupling grating to operate in the non-diffraction state and the second out-coupling grating to operate in the diffraction state during the second time period.

12. The device of claim 11, wherein the first out-coupling grating operating in the diffraction state and the second out-coupling grating operating in the diffraction state have different grating periods or different modulations of refractive index.

13. The device of claim 1, wherein at least one of the in-coupling element or the out-coupling element includes one or more active gratings.

14. The device of claim 9, wherein the one more active gratings include one or more holographic polymer-dispersed liquid crystal gratings, one or more surface relief gratings including active liquid crystals (“LCs”), one or more Pancharatnam-Berry phase gratings based on active LCs, or one or more polarization volume hologram gratings based on active LCs.

15. A method, comprising:
controlling, by a controller during a first time period, at least one of an in-coupling element or an out-coupling element to couple an input image light into a light guide, and couple the input image light out of the light guide as a first output image light having a first FOV; and
controlling, by the controller during a second time period, at least one of the in-coupling element or the out-coupling element to couple the input image light into the light guide, and couple the input image light out of the light guide as a second output image light having a second FOV,
wherein the second FOV substantially overlaps with the first FOV, and
wherein an axis of symmetry of the first FOV is rotated from an axis of symmetry of the second FOV.

16. The method of claim 15, wherein the input image light has an input FOV, and the first FOV and the second FOV have a same size as the input FOV.

17. The method of claim 16, wherein an overlapping portion of the first FOV and the second FOV is within a range of from 80% to 95% of the first FOV.

18. The method of claim 16, wherein a relative rotation between the axis of symmetry of the first FOV and the axis of symmetry of the second FOV is within a range of from 5% to 20% of the first FOV.

19. The method of claim 15, wherein a relative rotation between the axis of symmetry of the first FOV and the axis of symmetry of the second FOV is between 0.5°-10°.

20. The method of claim 15, wherein the first output image light having the first FOV and the second output image light having the second FOV propagate toward a same exit pupil.
